(19) United States
(12) Patent Application Publication
(10) Pub. No.: US 2012/0251807 A1
(43) Pub. Date: Oct. 4, 2012

(54) NANOPARTICULATE-ENHANCED COATINGS

(75) Inventors: Atul Tiwari, Honolulu, HI (US); Lloyd H. Hihara, Mililani, HI (US)

(73) Assignee: UNIVERSITY OF HAWAII, Honolulu, HI (US)

(21) Appl. No.: 13/434,965

(22) Filed: Mar. 30, 2012

Related U.S. Application Data
(60) Provisional application No. 61/470,106, filed on Mar. 31, 2011.

(51) Int. Cl. B32B 5/00; C08K 3/34; C09D 183/06; C09D 183/08; C08K 3/22; C09D 163/00; B82Y 30/00

(52) U.S. Cl. 428/220; 523/458; 523/466; 523/400; 524/588; 977/773

(57) ABSTRACT

Disclosed are coatings comprising a matrix material and nanoscale bodies disposed within the matrix material. Also provided are methods of forming such coatings.

### RELATED APPLICATIONS

The present application claims priority to U.S. application 61/470,106, “Increment in Mechanical Property of Polymers, Hybrid Polymers, Ceramics, and Quasi-Ceramic Materials By Using Nanoparticles,” filed on Mar. 31, 2011, the entirety of which application is incorporated herein by reference for any and all purposes.

### GOVERNMENT RIGHTS

This work was supported by grant N-00014-09-1-1056 from the Office of Naval Research. The government has rights in this invention.

### TECHNICAL FIELD

The present disclosure relates to the field of coatings and also to the field of nanoparticles.

### BACKGROUND

Users frequently demand high performance and also aesthetic appearance of goods and materials that are maybe subject to challenging environmental conditions. Such goods, however, may fail to deliver the desired performance and aesthetic appearance when subjected to normal use conditions. Accordingly, there is a need in the art for compositions and methods capable of enhancing the performance, the aesthetic performance, or both, of goods and materials.

### SUMMARY

In meeting the described challenges, the present disclosure provides coatings, the coatings comprising a polymeric matrix material, a population of nanoscale bodies dispersed within the matrix material, the nanoscale bodies being present in a range of from about 0.001 wt % to about 10 wt %.

The present disclosure also provides methods, the methods comprising dispersing a population of nanoscale bodies into a polymeric matrix material so as to give rise to a coating composition comprising the polymeric matrix material with the population of nanoscale bodies dispersed within at from about 0.001 wt % to about 10 wt %.

Also disclosed are methods, comprising preparing a polymer that comprises an epoxide group, an epoxy group, a silicone group, or any combination thereof; and dispersing a population of nanoscale bodies within the polymer to between about 0.001 wt % to about 10 wt % so as to form a coating composition.

### BRIEF DESCRIPTION OF THE DRAWINGS

The summary, as well as the following detailed description, is further understood when read in conjunction with the appended drawings. For the purpose of illustrating the disclosure, there are shown in the drawings exemplary embodiments of the disclosure; however, the disclosure is not limited to the specific methods, compositions, and devices disclosed. In addition, the drawings are not necessarily drawn to scale. In the drawings:

FIG. 1. Schematic of coating compositions formulated for in this study.

FIG. 2. Images of TiO₂ nanoparticles. (a) Optical image (b) SEM image (c) TEM image showing needle-like crystals.

FIG. 3. Images of TiO₂ nanoparticles generated from Ti(OH)4. (a) Optical image. (b) SEM image. (c) TEM image showing nano-spherical appearance.

FIG. 4. Images of polymer coated SiO2 nanoparticles, (a) Optical image (b) SEM image (c) TEM image showing nano-spherical appearance.

FIG. 5. Images of montmorillonite nanoparticles. (a) Optical image (b) SEM image (c) TEM image showing thin film morphology.

FIG. 6. Images of SiC nanowhiskers. (a) Optical image (b) SEM image (c) TEM image showing thin nano-whisker morphology.

FIG. 7. Nanoindenter XP from MTS instruments used to record the nanomechanical properties of the coatings and nanocoatings.

FIG. 8. Epoxy based polymer (PL) coating and nanocoatings. The PL nanocoatings were designated as #1-5 (shown in Table 1).

FIG. 9. HY coating and nanocoatings. The nanocoatings were designated as #6-10 (showing in Table 1).

FIG. 10. The CR coating and nanocoatings. The CR nanocoatings were designated as #16-20 (shown in Table 3.1).

FIG. 11. The QC and nanocoatings. The QC nanocoatings were designated as #11-15 (shown in Table 1).

FIG. 12. FTIR spectral analysis of different coatings

FIG. 13. FTIR spectral analysis of PL coating and nanocoatings. (a) Pristine polymeric coating. (b-f) Coatings containing nanoparticles.

FIG. 14. FTIR spectral analysis of HY coating and nanocoatings. (a) Pristine polymeric coating. (b-f) Coatings containing nanoparticles.

FIG. 15. FTIR spectral analysis of CR coating and nanocoatings. (a) Pristine polymeric coating. (b-f) Coatings containing nanoparticles.

FIG. 16. FTIR spectral analysis of QC coating and nanocoatings. (a) Pristine polymeric coating. (b-f) Coatings containing nanoparticles.

FIG. 17. Surface scan of PL coating showing compression in coating.

FIG. 18. Surface scan of HY coating showing elastic recovery after the scratch.

FIG. 19. Surface scan of CR coating showing clean brittle scratch.

FIG. 20. Surface scan of QC coating showing brittle scratch.

FIG. 21. Nanoindentation on pristine coatings. (a) H values as a function of displacement into the surface. (b) E values as a function of displacement into the surface.

FIG. 22. Nanoscratch analysis of pristine coatings. (a) Initiation, propagation and termination steps in PL coating.

FIG. 23. Nanoscratch analysis of pristine coatings. (a) Initiation, propagation and termination steps in HY coating.

FIG. 24. Nanoscratch analysis of pristine coatings. (a) Initiation, propagation and termination steps in CR coating.

FIG. 25. Nanoscratch analysis of pristine coatings. (a) Initiation, propagation and termination steps in QC coating.

FIG. 26. Nanoscratch analysis of pristine coatings. The Friction coefficient curve as a function of scratch distance.

FIG. 27. Nanoscratch analysis of pristine coatings. The cross profile curve as a function of scratch distance.

FIG. 28. Visco-elastic effect in pristine coatings. The E′ and E″ curves as a function of test frequency.

FIG. 29. Nanoindentation on coatings and nanocoatings. H values as a function of displacement into the surface.

FIG. 30. Nanoindentation on coatings and nanocoatings. E values as a function of displacement into the surface.

FIG. 31. Visco-elastic properties of pristine coatings and nanocoatings. The E′ and E″ curves as a function of test frequency.

FIG. 32. Nanoindentation on pristine coatings and nanocoatings. H values plotted for different coatings and nanocoatings.

FIG. 33. Nanoindentation on pristine coatings and nanocoatings. E values plotted for different coatings and nanocoatings.

FIG. 34. Visco-elastic properties of PL nanocoatings. E′ and E″ values from different nanocoating compositions are plotted as a function of test frequencies.

FIG. 35. Visco-elastic properties of HY nanocoatings. E′ and E″ values from different nanocoating compositions plotted as a function of test frequencies.

FIG. 36. Visco-elastic properties of CR nanocoatings. E′ and E″ values from different nanocoating compositions plotted as a function of test frequencies.

FIG. 37. Visco-elastic properties of QC nanocoatings. E′ and E″ values from different nanocoating compositions plotted as a function of test frequencies.

FIG. 38. FTIR spectral analysis of PL coating and nanocoatings containing nanoparticles.

FIG. 39. FTIR spectral analysis of HY coating and nanocoatings containing nanoparticles.

FIG. 40. FTIR spectral analysis of CR coating and nanocoatings containing nanoparticles.

FIG. 41. FTIR spectral analysis of QC coating and nanocoatings containing nanoparticles.

FIG. 42. Load on sample Vs displacement curves. (a) Pristine PL coating. (b) Pristine HY coating.

FIG. 43. Load on sample Vs displacement curves. (a) Pristine CR coating. (b) Pristine QC coating.

FIG. 44. Percentage improvement in H value in nanocoatings compared to pristine coatings.

FIG. 45. Percentage improvement in E value in nanocoatings compared to pristine coatings.

FIG. 46. Nanoscratch analysis of PL coating and nanocoatings. Penetration and roughness curves as a function of scratch distance.

FIG. 47. Nanoscratch analysis of PL coating and nanocoatings. Friction coefficient curves as a function of scratch distance.

FIG. 48. Nanoscratch analysis of PL coating and nanocoatings. Cross profile curve as a function of scratch distance.

FIG. 49. Nanoscratch analysis of HY coating and nanocoatings. Penetration and roughness curves as a function of scratch distance.

FIG. 50. Nanoscratch analysis of HY coating and nanocoatings. Friction coefficient curves as a function of scratch distance.

FIG. 51. Nanoscratch analysis of HY coating and nanocoatings. Cross profile curve as a function of scratch distance.

FIG. 52. Nanoscratch analysis of CR coating and nanocoatings. Penetration and roughness curves as a function of scratch distance.

FIG. 53. Nanoscratch analysis of CR coating and nanocoatings. Friction coefficient curves as a function of scratch distance.

FIG. 54. Nanoscratch analysis of CR coating and nanocoatings. Cross profile curve as a function of scratch distance.

FIG. 55. Nanoscratch analysis of QC coating and nanocoatings. Penetration and roughness curves as a function of scratch distance.

FIG. 56. Nanoscratch analysis of QC coating and nanocoatings. Friction coefficient curves as a function of scratch distance.

FIG. 57. Nanoscratch analysis of QC coating and nanocoatings. Cross profile curve as a function of scratch distance.

FIG. 58. E′ and E″ of PL coating and nanocoatings.

FIG. 59. E′ and E″ of HY coating and nanocoatings.

FIG. 60. E′ and E″ of CR coating and nanocoatings.

FIG. 61. E′ and E″ of QC coating and nanocoatings.

Table 1 Sample designations used for coatings and nanocoatings.

Table 2 Nanomechanical parameters derived from nanoscratch testing of PL coating.

Table 3 Nanomechanical parameters derived from nanoscratch testing of HY coating.

Table 4 Nanomechanical parameters derived from nanoscratch testing of CR coating.

Table 5 Nanomechanical parameters derived from nanoscratch testing of QC coating.

Table 6 Nanomechanical parameters derived from nanoscratch testing of PL nanocoatings.

Table 7 Nanomechanical parameters derived from nanoscratch testing of HY nanocoatings.

Table 8 Nanomechanical parameters derived from nanoscratch testing of CR nanocoatings.

Table 9 Nanomechanical parameters derived from nanoscratch testing of QC nanocoatings.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the claims. Also, as used in the specification including the appended claims, the singular forms “a,” “an,” and “the” include the plural, and reference to a particular numerical value includes at least that particular value, unless the context clearly dictates otherwise.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. Any and all documents cited herein are incorporated herein by reference in their entireties for any and all purposes.

In a first aspect, the present disclosure provides coatings. The disclosed coatings suitably include a polymeric matrix material. The polymeric matrix material may, as described elsewhere herein in additional detail, include one or more of an epoxide group, an epoxy group, a silicone group, or any combination thereof.

The foregoing matrix materials are exemplary only, as the disclosed technology may be applied to virtually any polymeric resin system that has includes one or more functional groups, such as carboxyl groups, epoxides, and the like. A partial listing of functional groups includes haloformyl, hydroxyl, alcohol, aldehyde, alkenes, alkyne, amide, amine, azo, carbonate, cyanate, ether, ester, peroxides, imines, cyanides, cyanates, ketones, nitriles, nitro groups, nitroso groups, phosphines, phosphodiesters, phosphates, sulfones, thiols, and the like. The functional group or groups of the polymer may, in some embodiments, suitably form a covalent, ionic, or other bond with the nanoscale bodies. As one example, a matrix material and a nanoscale body that present an amine and a carboxyl group to one another that form a bond are considered suitable. Other matrix materials, such as those that preset an epoxy or epoxide, are also considered especially suitable.

A variety of polymers may be used as matrix materials. These polymers include biopolymers (such as polylactic acid, poly-3-hydroxybutyrate, cellulose), conducting polymers (as, polypyrrole, polyindoles, polythiopehene, polycarbazole, polyanilines, poly(3,4-ethylenedioxythiopene), poly (p-phenylene sulfide)); copolymers (as Acrylonitrile butadiene styrene, styrene-butadiene rubber, Nitrile butadiene rubber, Styrene acrylonitrile resin, styrene-isoprene-styrene, ethylene-vinyl acetate); fluoropolymers (as polyvinylfluoride, polyvinylidene fluoride, perfluoroalkoxy polymer, perfluoropolyether); gutta-percha; polythiazyl, polygermanes, polyphosphazenes, polyborazylenes; phenol formaldehyde resins; polyanhydride; polyesters (e.g., polyvinylester polyglycolide, polylactic acid, polycaprolactone, polyethylene terephthalate); silicones, vinyl polymers (as polystyrene, polyvinyl chloride, polybutadiene, polyvinyl acetate, polyvinyl alcohol, polyacrylonitrile), and combinations thereof.

The coating also suitably includes a population of nanoscale bodies dispersed within the matrix material, with the nanoscale bodies suitably being present in a range of from about 0.001 wt % to about 10 wt %. The nanoscale bodies may be present in the range of from about 0.01 wt % to about 5 wt %, or from 0.1 wt % to about 1 wt %.

Coatings according to the present disclosure may have a thickness in the range of from about 0.1 micrometer to about 100,000 micrometers, or from about 1 micrometer to about 50,000 micrometers, or from about 10 micrometers to about 10,000 micrometers, or from 50 micrometers to about 1000 micrometers. Coatings having a thickness in the range of from about 3 micrometers to about 10 micrometers are considered especially suitable; coatings have a thickness in the range of from about 0.1 micrometer to about 1 mm are also suitable.

A variety of materials are suitable for use as polymeric matrix materials. Materials that include an epoxy group, an epoxide group, or any combination thereof are considered especially suitable. Also suitable are matrix materials that include a silicone group.

One exemplary materials includes an epoxy resin that is cured with an amide. A silicone composition that is coupled with an epoxy polymer is also suitable, as are compositions made from silicone epoxy groups. Matrix materials made with pure silicone without an epoxy polymer or linkage are also suitable. A hydrocarbon may be added to the silicone.

By nanoscale body is meant a body having at least one cross-sectional dimension in the range of from about 0.1 nm to about 100 nm, or even from about 1 nm to about 50 nm. The population of nanoscale bodies in the disclosed coatings may suitably include at least one body having a cross-sectional dimension in the range of from about 5 nm to about 20 nm.

A nanoscale body may comprise carbon, a metal, and the like. Nanoscale bodies that include a titanium compound (e.g., titanium dioxide), clay, silicon carbide, carbonaceous material, and the like, are consider especially suitable. Carbon nanotubes (single- or multi-wall), graphene, graphite, graphite oxide, and the like are all considered suitable carbonaceous materials for use in the disclosed coatings. The coatings may, of course, include nanoscale bodies that differ from one another in terms of material composition, cross-sectional dimension, or both.

A nanoscale body may suitably be spherical in shape, but a spherical shape is not a requirement. Instead, nanoscale bodies may be characterized as being spherical, platelet-shaped, needle-shaped, rod-shaped, sheet-shaped, or any combination thereof. A nanoscale body may be irregular in shape.

The polymeric matrix may, of course, further comprise a thermoplastic, a thermoset, or any combination thereof. The matrix may also comprise a copolymer. Such copolymers may be an alternating copolymer, a periodic copolymer, a statistical copolymer, a block copolymer, a graft copolymer, or any combination thereof. Exemplary polymers are set forth elsewhere herein.

Suitable thermoplastics include acrylonitrile butadiene styrene, acrylic, celluloid, cellulose acetate, a cyclic olefin polymer, ethylene-vinyl acetate, ethylene vinyl alcohol, a fluoropolymer, an ionomer, a liquid crystal polymer, polyoxymethylene, a polyacrylonitrile, a polyamide, a polyamide-imide, a polyaryletherketone, a polybutadiene, a polybutylene, a polybutylene terephthalate, polycaprolactone, polyethylene terephthalate, polycarbonate, polyhydroxyalkanoate, polyketone, polyester, polyethylene, polyetheretherketone, polyetherketoneketone, polyetherimide, polysulfone, polyimide, polylactic acid, polymethylpentene, polyphenylene oxide, polyphenylene sulfide, polypropylene, polystyrene, polysulfone, polyurethane, polyvinyl acetate, polyvinyl chloride, polyvinylidene chloride, styrene-acrylonitrile, or any combination thereof. Thermosets may include a melamine formaldehyde, phenol-formaldehyde, polyester, polyimide, or any combination thereof.

The disclosed coatings suitably exhibit an increase in at least one of hardness, Young's modulus, critical load, storage modulus (E′), loss modulus (E″), or any combination thereof, as compared with a corresponding polymeric matrix material. The coating may suitably exhibit an increase in hardness of at least about 5% or even about 10% as compared to a corresponding polymeric matrix material. The coating may also exhibit an increase in hardness of at least about 20% as compared to a corresponding polymeric matrix material. In some embodiments, the coating may exhibit an increase in Young's modulus of at least about 5% as compared to a corresponding polymeric matrix material.

The nanoscale bodies are suitably present within the coating in a range of from about 0.01 wt % to about 0.5 wt %, or even from about 0.1 wt % to about 0.3 wt %.

Also disclosed are methods. These methods suitably include dispersing a population of nanoscale bodies into a polymeric matrix material so as to give rise to a coating composition comprising the polymeric matrix material (as described elsewhere herein) with the population of nanoscale bodies dispersed within at from about 0.001 wt % to about 5 wt %. or even up to about 10 wt %. The user may apply the coating composition to a substrate, and may further cure the coating composition. Various dispersion techniques known to those of skill in the art (e.g., ultrasonic treatment, homogenization, and other mixing techniques) may be used.

A user may also prepare a polymer matrix that comprises an epoxide group, an epoxy group, a silicone group, or any combination thereof, and disperse a population of nanoscale bodies within the polymer to between about 0.001 wt % to about 5 wt % so as to form a coating composition. The use may also dispose the coating composition onto a substrate.

### EXEMPLARY EMBODIMENTS

The following disclosure presents illustrative embodiments of the present disclosure. These illustrative embodiments should not be understood to limit the scope of the present disclosure in any way, as these embodiments are exemplary only.

Materials and Testing Methodology

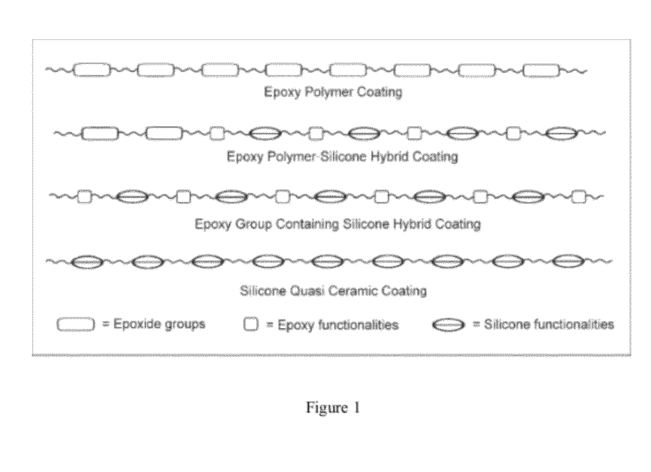

In this disclosure, the mechanical properties of the disclosed materials are investigated based on the length and properties of the molecular segments. FIG. 1 shows a schematic of illustrative polymer and monomer entities utilized in this research. The first polymer coating formulation (referred to as “PL”) was prepared with cured epoxy resin using a commercial amide. In the second coating formulation (referred to as “HY”), a silicone composition was coupled with an epoxy polymer.

The third coating formulation (referred to as “CR”) was a silicone epoxy group. The fourth exemplary coating formulation (referred to as “QC”) was made of pure silicone without an epoxy polymer or linkage. Coating formulations were developed with increasing silicone content or decreasing epoxy content. Various concentrations of nanoparticles were incorporated into each coating composition to analyze the effect on the nano-mechanical properties of the cured coatings.

Epoxy and Silicone Based Coating Technologies

The adhesive strength of the coating may, in some embodiments, be affected by the amount of functionalities present in the material. High functional material may form a densely crosslinked network that often cracks. The exemplary epoxy polymer coating included of high functionalities that allow the material to form strong adhesive bonds. However, some hydrocarbon based epoxy coatings are porous in nature and allow the in-diffusion of electrolytes to the metal coating interface. The in-diffused electrolyte hydrolyzes the bonds of the adhesive and leads to the delamination of the coating.

Silicones, on the other hand, possess the unique characteristic of repelling water and acting as a coupling agent for other materials. They also tend to form thin coatings with their substrates via a covalent bond. Unfortunately, silicone coatings also crack due to their high crosslink density in the hardened material. Adding hydrocarbon to the coating formulation solves the cracking problem. In some embodiments, compounds containing methyl groups or other hydrocarbon-based groups may be introduced into the formulation so to impart increased resistance to water.

Nanoparticles in Coating Technology

Silicone coatings used for corrosion protection may be thin and may, in some cases, be scratchable. Such a defect serves as a point of initiation on the coating, which can be protected from such scratches by adding abrasive resistant inorganic fillers. The size and shape of the fillers depends on the thickness of the coating and field of application. The nanoparticles are generally used in formulation of new generation coatings because these impart the necessary abrasive resistance and hardness.

Materials Used

Described below are the chemicals and experimental methods used in the investigation of the disclosed coatings and nanocoatings.

Monomers and Polymers

The following chemicals were procured for the synthesis of the polymer, hybrid, ceramer and quasi-ceramic coatings: methyltriacetoxysilane (purity 95%); methyltrimethoxysilane (purity 98%); tetramethoxysilane (purity 97%); y-glycidoxypropyltrimetoxysilane; tetraethoxysilane; 3-aminopropyltrimethoxysilane, purchased from Gelest; titanium ethoxide (purity 99%); dibutyltindilaurate catalyst (purity 95%), purchased from Alfa-Aesar; 1, 6-hexanediamine; dibutyltindilurate; isopropanol; diethylether, purchased from Sigma Aldrich, USA; 90% denaturated ethanol containing 5% methanol and 5% isopropanol, purchased from Alfa Aesar, USA; and sodium bicarbonate, purchased from Merck. All of the chemicals were analytical grade as quoted by the manufacturer. Ultrapure water of 18 M ohm·cm resistivity was used in this study.

The polymer utilized in coating formulation was DER 331® epoxy from Dow Chemicals, hardened with Ancamide® 2353 purchased from Air Products. It should be understood that the foregoing materials are exemplary only and do not limit the scope of the present disclosure, as other epoxies and hardening agents may be used according to the present disclosure.

Nanoparticles

The nanoparticles or ingredients used for the in-situ generation of nanoparticles were purchased in their purest form and used without further purification. The following exemplary nanoparticles were used:

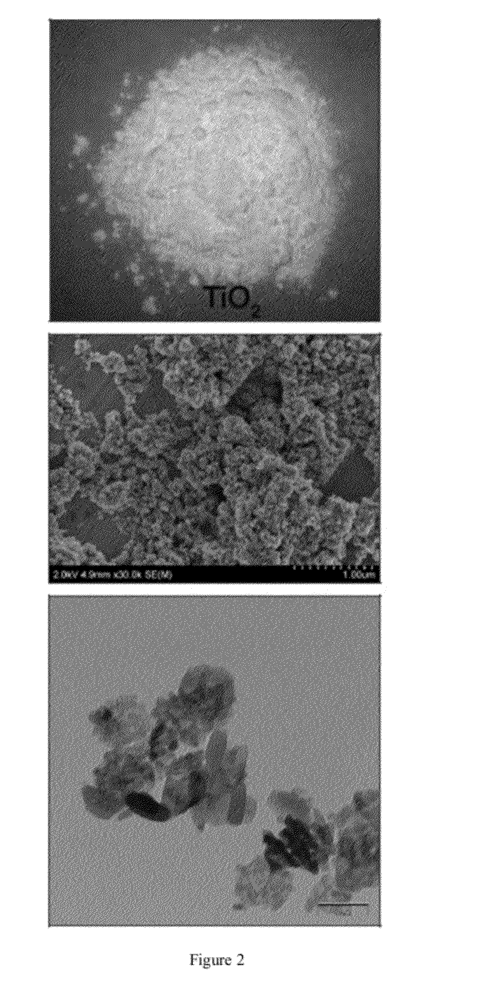

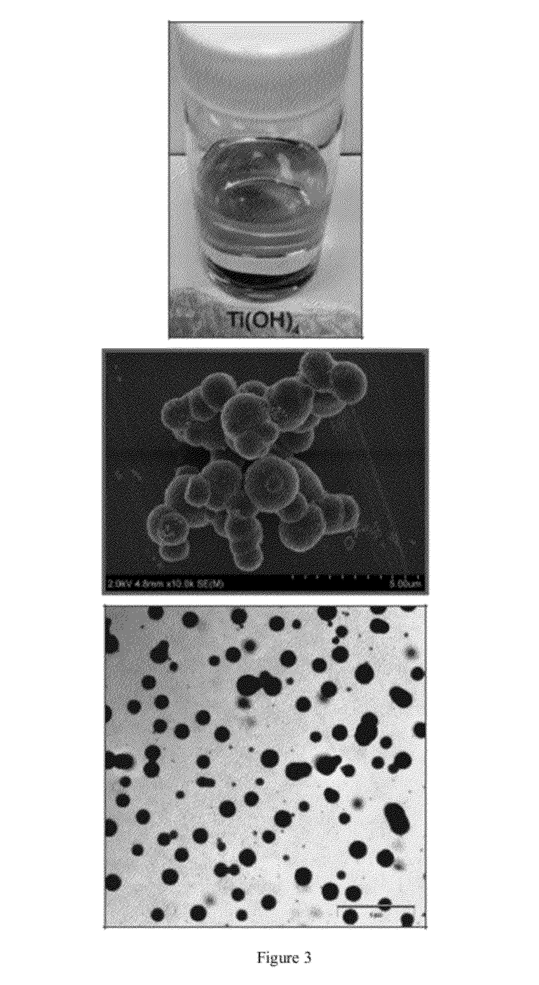

(a). Titanium dioxide (TiO2) anatase, purchased from Alfa Aesar. The material was a solid white powder as shown in FIG. 2. With SEM and transmission electron microscopy (TEM), the particles appeared needle-like in shape, with an average thickness of 10 nm.

(b). Titanium dioxide (in-situ generated) using titanium ethoxide (Ti(OH)), was purchased from Alfa Aesar. The material was yellow liquid as shown in FIG. 3. With SEM and TEM, the generated nanoparticles appeared to be nano-spherical in shape with an average thickness of 80 nm.

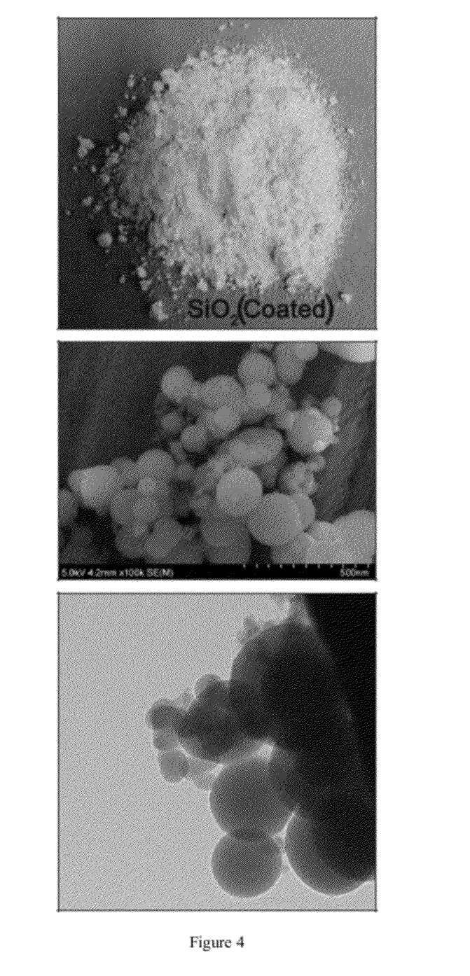

(c). Silicon dioxide (SiO2) nanoparticles coated with a proprietary polymer and purchased from Energy Strategy Associates under the name Nan-O-Sil®. The material was solid white colored powder as shown in FIG. 4. With SEM and TEM, the particles appeared as nano-spheres, with an average thickness of 90 nm.

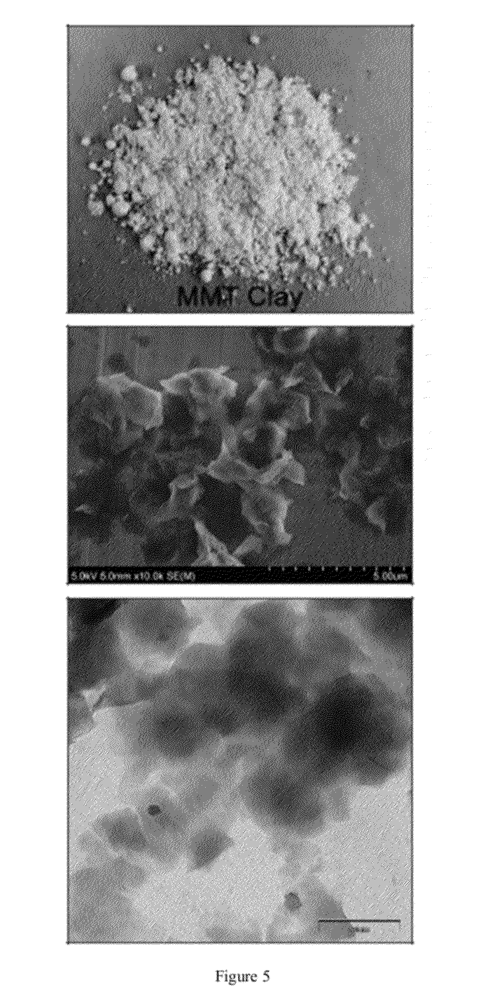

(d). Montmorillonite nanoclay (MMT), purchased from Across. The material was solid pale yellow colored powder as shown in FIG. 5. With SEM and TEM, the particles appeared like nano-sheets with an average thickness of 20 nm.

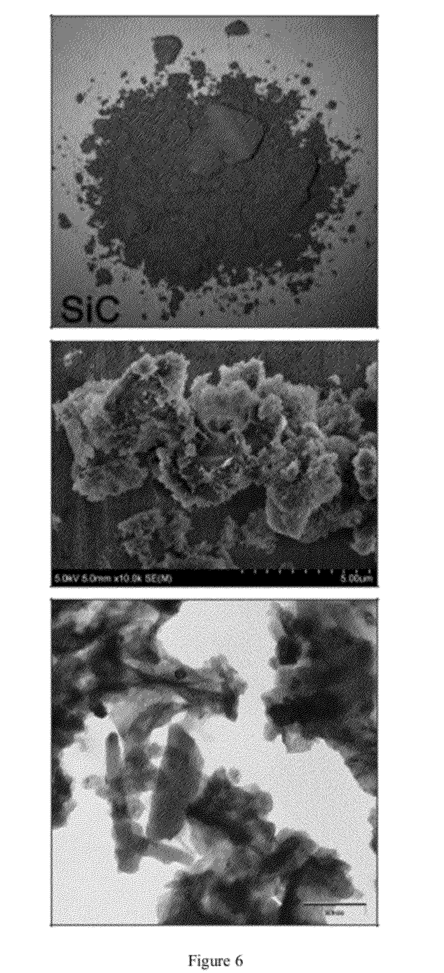

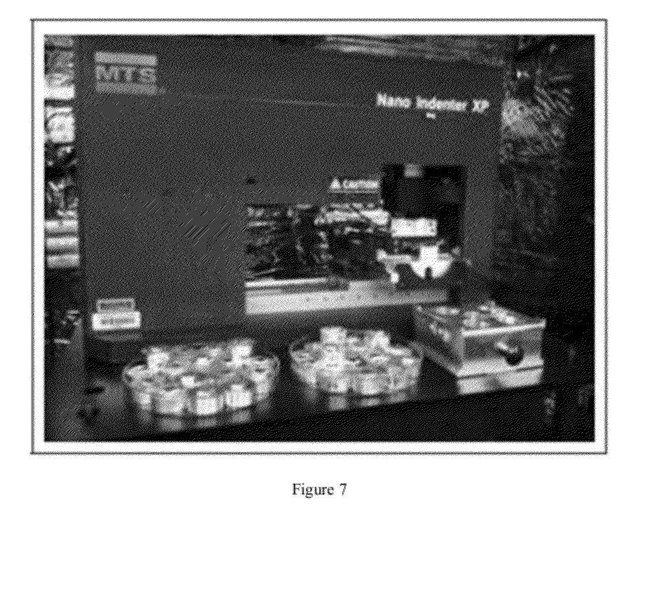

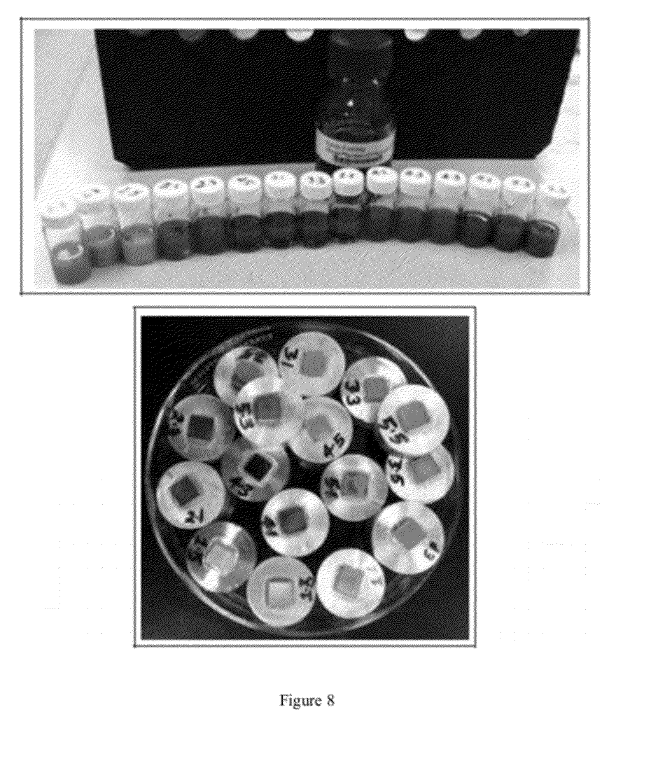

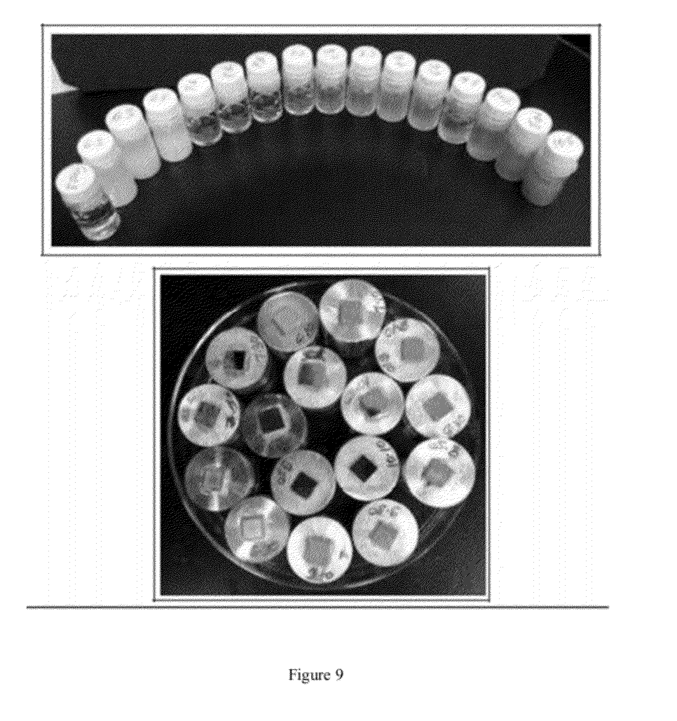

(e). Silicon carbide (SiC) whiskers were purchased from Advanced Composite Materials. The material was dark grey powder as shown in FIG. 6. With SEM and TEM, the particles appeared like nano-sheets with an average thickness of 50 nm.

Characterization Methods

Herein, the analytical techniques used to characterize materials in the formulation of coating are described.

FTIR Spectroscopic Investigations

The FTIR spectroscopy on solid coatings applied over aluminium metal was conducted using a Thermo Electron Nicolet Nexus 760 instrument integrated with a Continuum microscope. The spectra were recorded in reflectance mode and analysed using Thermo Electron's Omnic and Series software. A blank background spectrum was collected prior to collecting a spectrum of the sample. A minimum of 60 scans of the specimen were employed for each spectrum.

Microscopic Investigations

Coating morphology and scratched surface were analysed with a Hitachi S-3400N, Scanning Electron Microscopy (SEM). The LEO 912 Energy-Filtering Transmission Electron Microscope was used to study the appearance of nanoparticles. The samples were coated to prevent charging during the analyses. The atomic force microscopic (AFM) technique was therefore used to study the surface morphology of the coatings hardened over a polished aluminum surface. The Veeco Multimode-II and Innova SPM equipments were used in contact mode to capture the surface topography. The 3D images were created using TrueMap software from TureGage Surface Metrology.

Nano-Mechanical Analysis

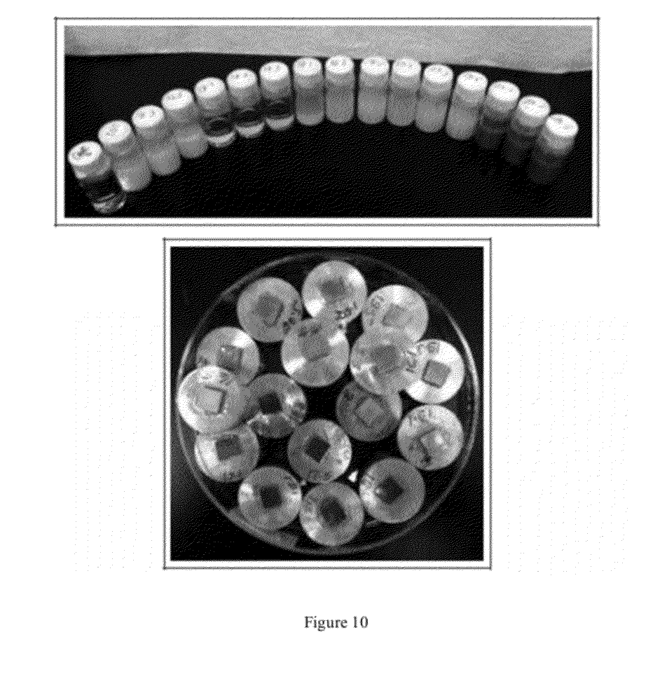

Nano-mechanical analysis was conducted on MTS Nanoindenter XP (FIG. 7) with a Berkovich diamond tip. Test samples were mounted with a thermoplastic polymer resin onto an aluminium stub. Their hardness was measured using the continuous stiffness measurement option. Fused silica was used as a standard calibration sample. During the scratch tests, the platform holding the specimen was moved to create the scratch, while the indentation head controlled the load applied to the indenter. All the tests were performed in ambient conditions with temperature approximately 25° C.

The nanoindentation, nanoscratch and dynamic mechanical properties were acquired with the help of TestWork 4 software from MTS instruments. The TestWork software exported the raw data files to the MS Excel software. The Excel data sheets were then imported on Analyst software from the MTS instrument for the data reduction. The Analyst-Excel files were finally used to plot the curves using Origin 7.5 software.

Nanoindentation Experimental Procedure

Coating specimens of 1×1 cm² were bonded to circular aluminum stubs using a thermoplastic resin. The stubs were then mounted on the Nanoindenter XP nanopositioning tray and tested using an “XP basic hardness, modulus and tip calibration” test method. A Berkovich tip was used to perform 6 to 12 tests on each sample in different regions to achieve a good representation of nano-mechanical properties of the coating. The exemplary Poisson's ratio used for the epoxy rich coating (i.e., PL) was 0.350, while for the silicone rich coatings (i.e., HY, CR, and QC) it was 0.175.

In this test method, the CSM oscillation frequency and amplitude are set to Harmonic Frequency Target and Harmonic Displacement Target. The phase shift between the excitation oscillation and the displacement oscillation is zeroed. The indenter tip begins approaching the surface from a distance above the surface of the equivalent of the Surface Approach Distance. The approach velocity is determined by the Surface Approach Velocity. When the indenter determines that it has contacted the test surface, according to the criteria determined by the Surface Approach Sensitivity, the indenter penetrates the surface at a rate determined by the Strain Rate Target. When the surface penetration reaches the Depth Limit, the load on the indenter is held constant for ten seconds. The indenter is then partially withdrawn from the sample at a rate equal to the maximum loading rate. When the load on the sample reaches 10% of the maximum load on the sample, the load on the sample is held constant for 100 seconds. The indenter is then completely withdrawn from the sample and the sample is moved into position for the next test.

Nanoscratch Experimental Procedure

The nanoscratch tests were conducted using an MTS Nanoindenter® XP with a Berkovich diamond tip. Test samples of 1×1 cm2 were mounted with a thermoplastic resin on an aluminum stub. During the scratch tests, the platform holding the specimen was moved to create the scratch, and the indentation head controlled the load applied to the indenter. Experimental parameters were chosen as follows: scratch speed, 10 μm/s; scratch length, 1000-3000 μm; maximum lateral force, 250 mN (all orientations); maximum lateral force resolution, 2 μN; maximum normal force, 500 mN; noise level, 300 μN (without contact); lateral force scratch orientation and Berkovich face forward. At least five tests were performed at each test site using continuous stiffness option.

During the test, the indenter tip begins approaching the surface from a distance above the surface the equivalent of the Surface Approach Distance. The approach velocity is determined by the Surface Approach Velocity. When the indenter determines that it has contacted the test surface, according to the criteria Surface Approach Sensitivity, the test begins. A test consists of several line scans or “profiles” along the scratch vector before and after the main “scratch.” Velocity during all table movements is set by Scratch Velocity for the scratch segment and Profile Velocity during the profiling. The length and direction of the scratch are set by the Scratch Length and Scratch Angle, respectively. After the surface has been scratched, another short scan is performed that is 0.2·Scratch Length. If the input Perform Cross Profile is set to 1, then a profile across the width of the scratch is also performed. The cross profile is performed at the location on the scratch where Load Applied on Sample reached the Cross Profile Location.

Visco-Elastic Experimental Procedure

Visco-elastic tests were conducted using an MTS Nanoindenter® XP with a Berkovich diamond tip. Test samples of size 1×1 cm2 were mounted with a thermoplastic resin on an aluminum stub. At least six tests were performed using the single frequency test method at each test site for each frequency and the average values of storage and loss modulus were recorded.

In a typical nanoindentation based, visco-elastic experiment, the system senses the contact of the indenter tip to the sample surface and pushes the indenter farther into the test material to a depth determined by Pre-test Compression. The dimensions specified by the Pre-test Compression are larger than the sum of displacement required for full contact and the oscillation amplitude of the material. The instrument then provides minimum (1 Hz) and maximum (45 Hz) vibration frequencies to the indenter. The number of frequencies varies as per the requirement. A Poisson's ratio is provided for the calculation of complex modulus.

Illustrative Development of Coatings and Nanocoatings

In this section the steps involved in the development of various coatings and nanocoating compositions are described.

Development of Epoxy Based Polymeric (PL) Coating and Nanocoatings

For the PL coating, a calculated quantity of epoxy polymer DER 331 (100 gm) was mixed with Ancamide® hardener (60 gm) in 100 ml of methyl ethyl ketone. The entire content was mixed for 30 min in ultrasonic bath before using as a PL coating precursor.

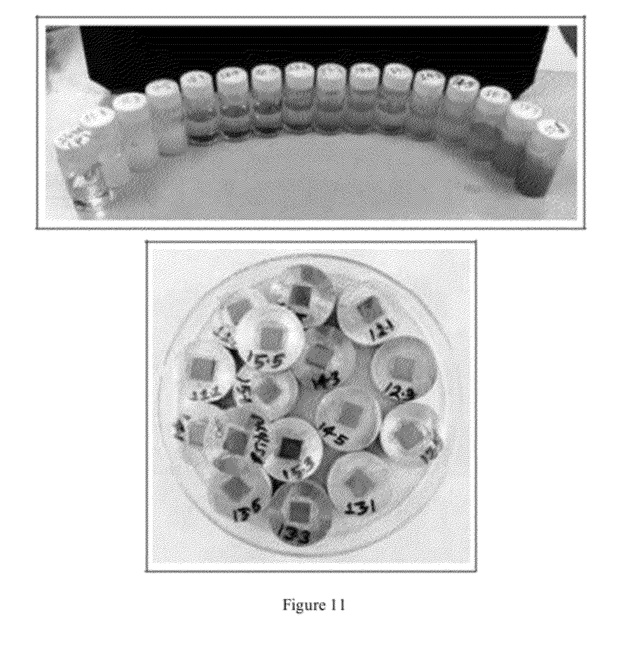

To prepare nanocoatings, the calculated quantities (i.e., 0.1, 0.3, 0.5 wt % of solid content) of five nanoparticles described in section 3.2.2 were sonicated in 1 ml isopropanol for 24 h. A 10 ml of PL coating precursor solution was added to the suspension of each nanoparticle and sonicated for 5 h. These nanoparticle coating suspensions were applied on polished aluminum specimens (FIG. 8).

Development of Polymer-Ceramer Hybrid (HY) Coating and Nanocoatings

The HY coating was developed following the procedure given as follows. To prepare silicone composition a calculated quantity of—glycidoxypropyltrimetoxysilane (44.20 ml) was reacted with tetraethoxysilane (11.0 ml) in isopropanol (60 ml). In a second reactor, a calculated quantity of 3-aminopropyltrimethoxysilane (8.6 ml) were treated with 1, 6-hexanediamine (1.2 gm) in isopropanol (40 ml). The two components obtained above were reacted together in a third reactor and charged with dibutyltindilaurate catalyst and traces of water (1.0 ml). In a fourth reactor epoxy DER 331 (3.5 gm) was mixed with Ancamide® (3.0 gm) in 20 ml isopropanol. The epoxy-Ancamide mixture was then added to the silicone composition obtained in the third reactor and sonicated for 30 min. The epoxy-Ancamide® mixture was 10 wt % of the solid content in silicone composition obtained in the third reactor. The entire content of the fourth reactor was left in an ambient condition for 30 min before using it as a HY coating precursor.

In order to prepare nanocoatings, the calculated quantities (i.e., 0.1, 0.3, 0.5 wt % of solid content) of five nanoparticles described herein were sonicated in 1 ml isopropanol for 24 h. A 10 ml of HY coating precursor solution was added to the suspension of each nanoparticle and sonicated for 5 h. These nanoparticle coating suspensions were applied on the polished aluminum specimens (FIG. 9).

Development of Ceramer (CR) Coating and Nanocoatings

The CR coating was developed as follows. To prepare silicone composition a calculated quantity of y-glycidoxypropyltrimetoxysilane (44.20 ml) was reacted with tetraethoxysilane (11.0 ml) in isopropanol (60 ml). In second reactor, a calculated quantity of 3-aminopropyltrimethoxysilane (8.6 ml) were treated with 1, 6-hexanediamine (1.2 gm) in isopropanol (40 ml). The two components obtained above were reacted together in the third reactor and charged with dibutyltindilaurate catalyst and traces of water (1.0 ml) that resulted in a ceramer coating precursor. The entire solution was left for 30 min in ambient conditions before using it as a CR coating precursor.

In order to prepare nanocoatings, the calculated quantities (i.e., 0.1, 0.3, 0.5 wt % of solid content) of five nanoparticles described in section 3.2.2 were sonicated in 1 ml isopropanol for 24 h. A 10 ml of CR coating precursor solution was added to the suspension of each nanoparticle and sonicated for 5 h. These nanoparticle coating suspensions were applied on polished aluminum specimens (FIG. 10).

Development of Quasi-Ceramic (QC) Coating and Nanocoatings

The QC coating was prepared as follows: A mixture of silianes was prepared by reacting calculated quantities of methyltriacetoxysilane, methyltrimethoxysilane and tetramethoxysilane to a reactor vessel followed by sonication and an addition of isopropanol. In a second reactor, a calculated quantity of sodium bicarbonate was dissolved in a known volume of water. The water was constantly stirred while sodium salt was added and then stirred again every 2 h. The content of second reactor was added to the content of reactor one and then sonicated for 30 min. In the third reactor, a calculated quantity of titaniumethoxide was added to a known amount of isopropanol and sonicated for 15 min. The content from reactor three was added to the content obtained after mixing the solutions from reactor one and reactor two. A known quantity of isopropanol, diethylether and dibutyltindilaurate were mixed separately in a reaction vessel and added to the solution obtained in the above steps. The entire solution was left for 30 min in ambient conditions before using it as QC coating precursor.

In order to prepare nanocoatings, the calculated quantities (i.e., 0.1, 0.3, 0.5 wt % of solid content) of five nanoparticles described in section 3.2.2 were sonicated in 1 ml isopropanol for 24 h. A 10 ml of QC coating precursor solution was added to the suspension of each nanoparticle and sonicated for 5 h. These nanoparticles coating suspensions were applied on polished aluminum specimens (FIG. 11).

Specimen Preparation and Coating Application

The A16061-T6 specimens were cut into 1×1 cm2 samples and adhered to circular aluminum stubs using thermoplastic polymer. The specimens were then polished using 0.01 μm aluminum oxide agglomerate solution and dried until required during coating process. The sonicated solutions of coatings were applied on the polished aluminum specimens and dried in ambient conditions (˜25 deg. C.) for 48 hr followed by heating at 37 deg. C. for 48 hr. Samples were left in ambient condition for 30 days before testing their nano-mechanical properties.

Characterization

In this section the characterization of the coating and nanocoating are described based on their molecular chain length and nanoparticles in the final coating structure.

Characterization of Nanocoatings Using FTIR Spectroscopy

FTIR spectroscopy is a useful tool in determining the presence of organic and inorganic constituents in a material. The mode and mechanism of reaction can be estimated using this technique. The FTIR instrument can be operated in several modes such as transmission, reflection, absorbance or total attenuated reflection mode.

Effect of Molecular Chain Lengths

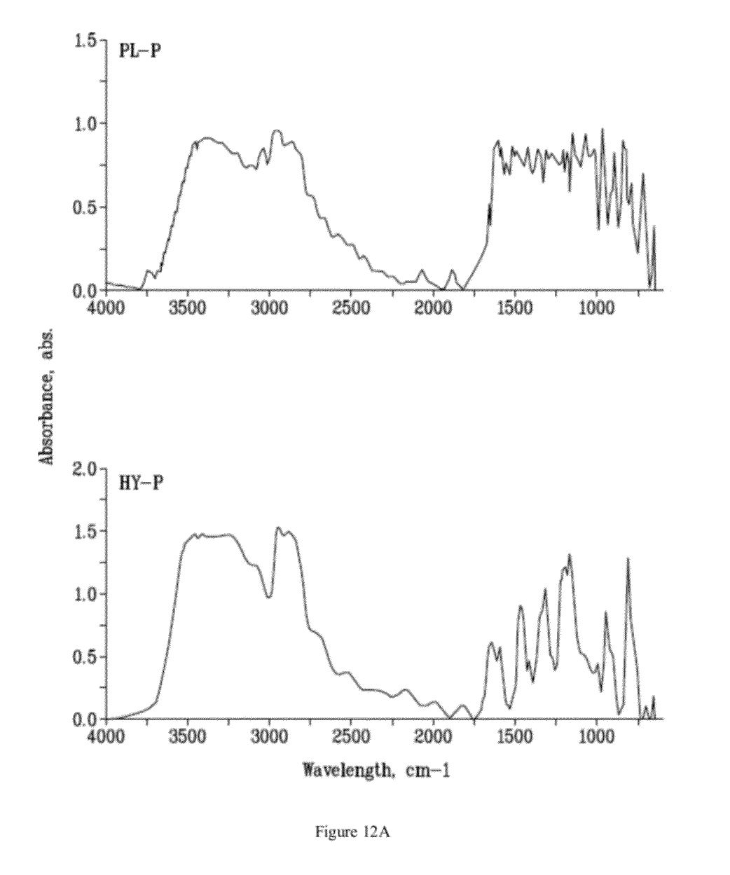

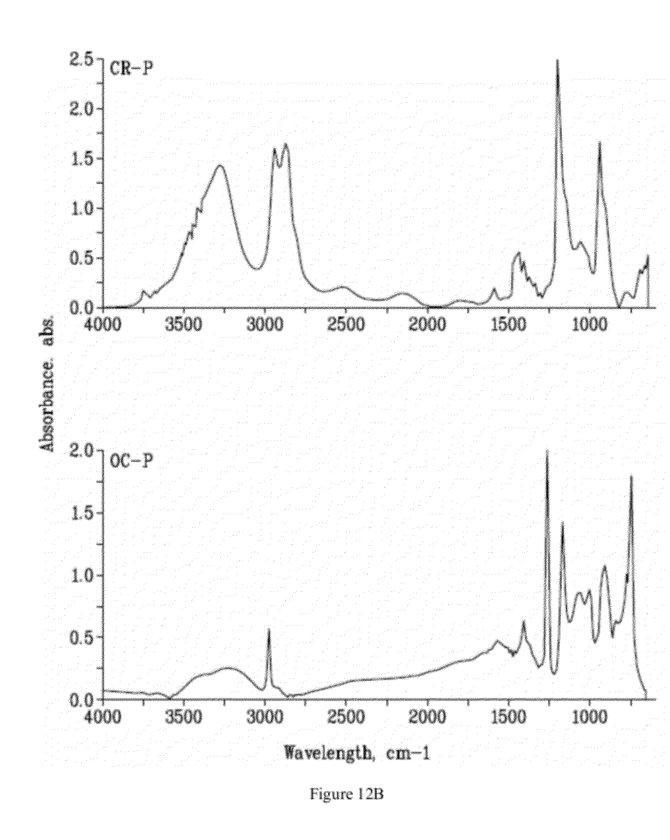

FIG. 12a shows the FTIR spectrum of a pristine PL coating. The spectrum is typical for epoxy polymer materials. The peaks appearing between 600-800 cm-1 are due to bands from amide in Ancamide® hardener. Similarly, amide bands appear between 1300-1520 cm-1, 1600-1900 cm-1 and at approximately 3100 cm-1. The hydrocarbon peaks from epoxy resin can be seen between 900-1000 cm-1 and 2875-3000 cm-1, while an aromatic C=C band occurs at 1600 cm-1 [41]. A broad hump between 3100-3700 cm-1 is due to the contribution from amide and hydrogen-bonded hydroxyl stretching.

FIG. 12b shows FTIR spectrum of a pristine HY coating. This coating composition consists of 10 wt % (of solid content) epoxy resin and diamine as the hardener. The remaining 90 wt % solid content is silicone. The peaks appearing between 600-820 cm-1 are due to hydrocarbons in the coating structure. A sharp peak at 945 cm-1 is due to a Si—OH group, while a shoulder at 915 cm-1 and sharp peak at 995 cm-1 are due to epoxy linkages. Sharp peaks between 1000-1200 cm-1 are due to the contributions from Si—O—Si linkages and hydrocarbons in the epoxy resin [42]. The amine peak can be seen at 1592 cm-1 and C═C appears at 1643 cm-1. The symmetric and asymmetric hydrocarbon (—CH3) can be seen between 2800-3000 cm-1. The broad hump between 3000-3600 cm-1 is due to the contributions from amine and hydrogen-bonded hydroxyl stretching.

FIG. 12c shows the FTIR spectrum of a pristine CR coating. The peak appearing between 600-725 cm-1 are due to stretching of hydrocarbon (—CH) portion in the silicone. A shoulder appearing at approximately 920 cm-1 is due to epoxy linkage in the coating, while the sharp peak at 946 cm-1 is due to a Si—OH group from unreacted silanols. The two sharp peaks appearing between 1000-1250 cm⁻¹ are due to Si—O—Si backbone stretching. Another peak appearing at 1442 cm-1 is due to hydrocarbon, while a peak appearing at 1593 cm⁻¹ is due to amine linkages [43]. The symmetric and asymmetric —CH stretching can be seen at 2873 and 2940 cm⁻¹. A hump concentrating at 3278 cm-1 is due to hydrogen-bonded reactive groups.

FIG. 12d shows the FTIR spectrum of pristine QC coating. The two sharp peaks appearing at 725 cm-1 and 921 cm⁻¹ are due to a Si—OH group from unreacted silanols. Another set of peaks between 1010-1070 cm⁻¹ are due to SiOSi vibrations from the backbone. The four peaks appearing between 1170-1600 cm⁻¹ are due to the hydrocarbon portion in the coating composition [44]. A sharp peak at 2969 cm⁻¹ is due to symmetric—53 CH₃ stretching, while a weak hump between 3000-3500 cm⁻¹ is due to hydrogen-bonded hydroxyl groups.

Effect of Nanoparticle Incorporation

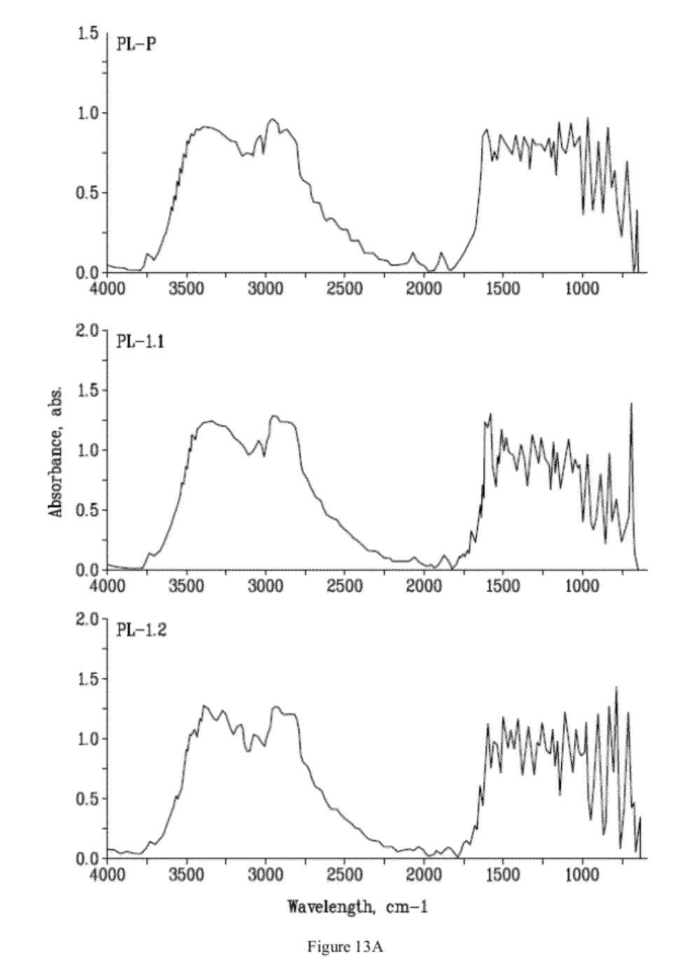

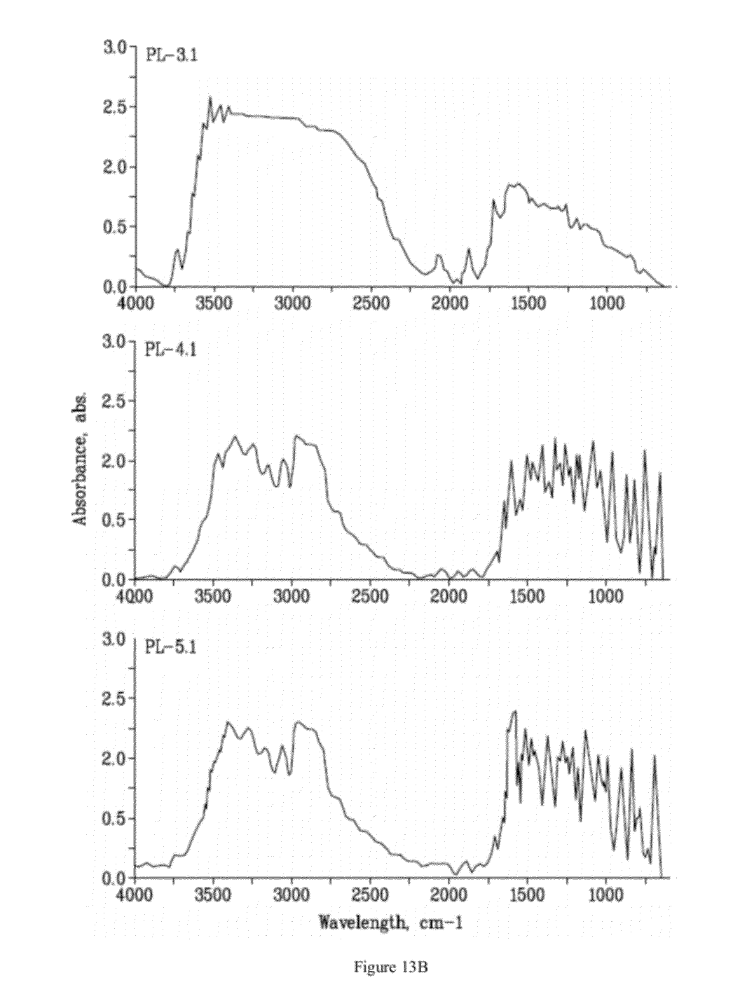

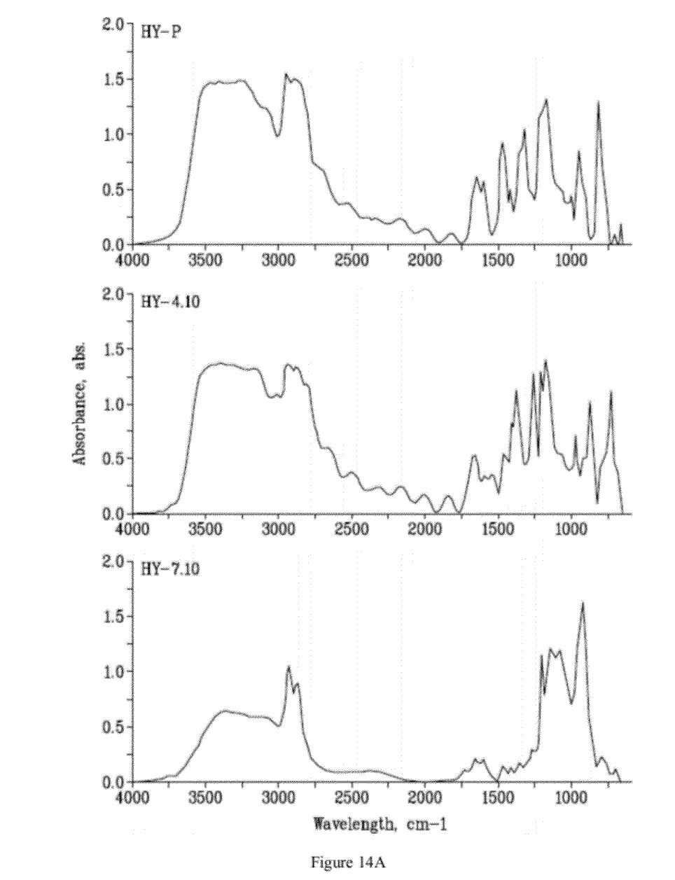

FIG. 13 shows a FTIR spectral analysis of PL coating and five different nanocoatings. The spectral assignment of PL-1.1 was similar to the pristine coating except the positions of the peaks were probably shifted as a result of a change in the refractive index due to the presence of TiO₂ nanoparticles. There was an increase in the absorbance intensity at approximately 3200 cm⁻¹ due to presence of hydrogen-bonded TiO2 particles. In the case of PL-2.1, when Ti(OH)4 was used to generate TiO₂ type nanoparticles the band appearing at 921 cm⁻¹ clearly indicate the presence of TiOSi bond, while a band appearing at 3278 cm⁻¹ indicates hydrogen bonding involving TiOH and SiOH groups [45].

The spectrum of PL-3.1 containing nanosilica has a spectrum with less resolved peak intensities. The silica particle appears to diffuse the IR radiation, thereby reducing the intensity of the IR beam reaching back to the detector.

The spectrum of PL-4.1 containing MMT nanosilica is similar to that of the pristine coating. However, there is a shift in the peak position in PL-1.1 compared to the peaks in the spectra of the pristine composition. The shift is due to the interaction between epoxy amide functionality and silica based nanoclay. The presence of MMT can be seen from a weak peak at 697 cm-1 and a strong vibration at approximately 1040 cm⁻¹[46].

In the case of PL-5.1 nanocomposites, the peaks appearing between 1000-1200 cm⁻¹ gain intensity and broaden due to the presence of SiC in the matrix network [47]. Another sharp peak appearing at approximately 3405 and 3274 cm-1 is due to the hydrogen-bonded silicon group.

Apart from distinct features appearing in the FTIR spectrum of nanocomposites, hydrocarbon, and hydroxyl group stretching are similar to the pristine epoxy-amide coating.

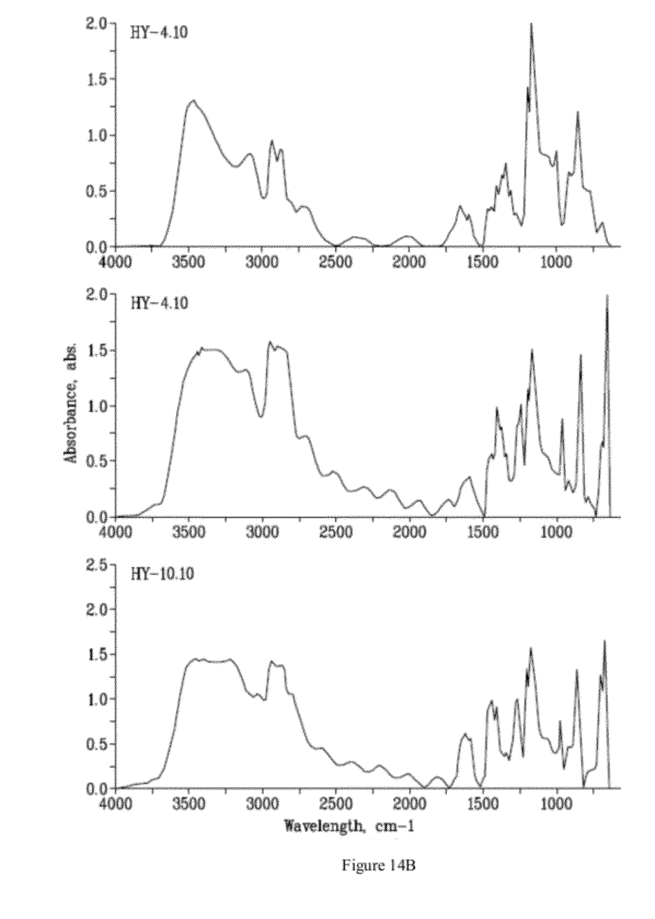

The FIG. 14 shows FTIR spectra of pristine HY coating and nanocoatings. This coating composition consists of 10 wt % epoxy resin made of primarily hydrocarbon. The FTIR spectrum is therefore saturated with hydrocarbon peaks that overshadow peaks appearing from other groups in a similar regime. The peak assignment for HY-P coating is discussed in section 4.1.1.

In the case of the nanocoating composition of HY-6.1, peak positions are similar to pristine HY-P coating except an additional peak appears at 972 cm⁻¹, possibly due to the interaction of TiO₂ nanoparticles with the silicone and epoxy network. The additional peak at approximately 3200 cm-1 is probably due to hydrogen-bonded TiO₂ nanoparticles.

In the case of HY-7.1 nanocoating containing Ti(OH)₄, the sharp strong peak that appears at 918 cm⁻¹ is due to a SiOTi linkage, while a weak peak appearing at 786 cm⁻¹ is possibly due to TiOTi bonding [48].

In the case of HY-8.1 nanocoating containing functionalized nanosilica, the peak positions were similar to those of the pristine HY-P coating except the peak at approximately 1100 cm⁻¹ seems super saturated due to an excess of silicon in the coating [49]. Similarly, a peak at 3085 cm⁻¹ suggests the presence of functionalized SiO2 in the coating network [50].

In the case of HY-9.1 nanocoating containing MMT nanoclay, no new peaks could be identified to verify the presence of nanoparticles in the nanocoating network. However, the shift in peak positions suggests the presence of nanoclay in the hybrid coating structure.

In the case of HY-10.1 nanocoating containing SiC whiskers, the peak position were shifted compared to that of the pristine coating, suggesting the presence of nanoparticles in the coating. Moreover, an additional sharp peak at 867 cm⁻¹ indicates the presence of SiC in the coating.

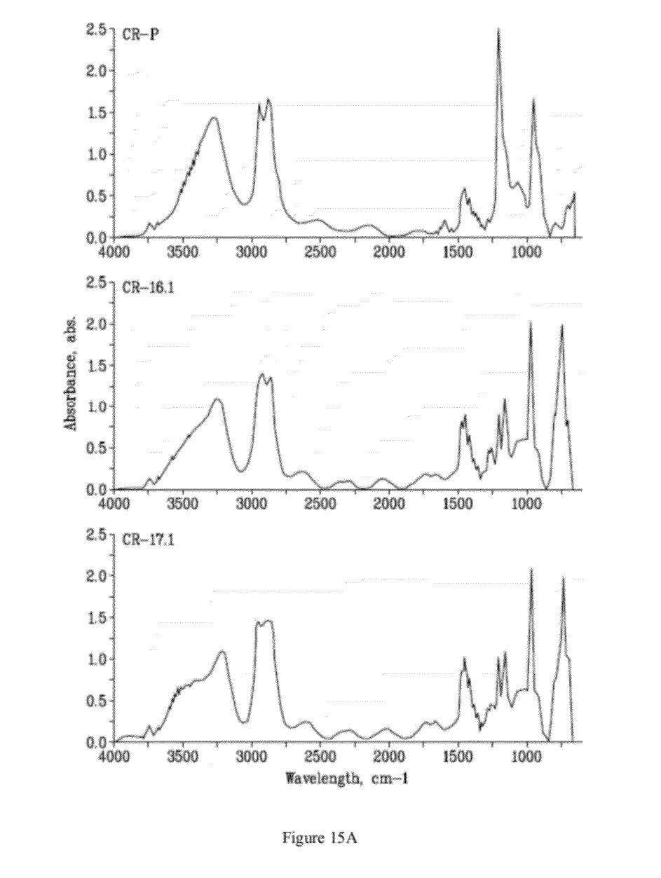

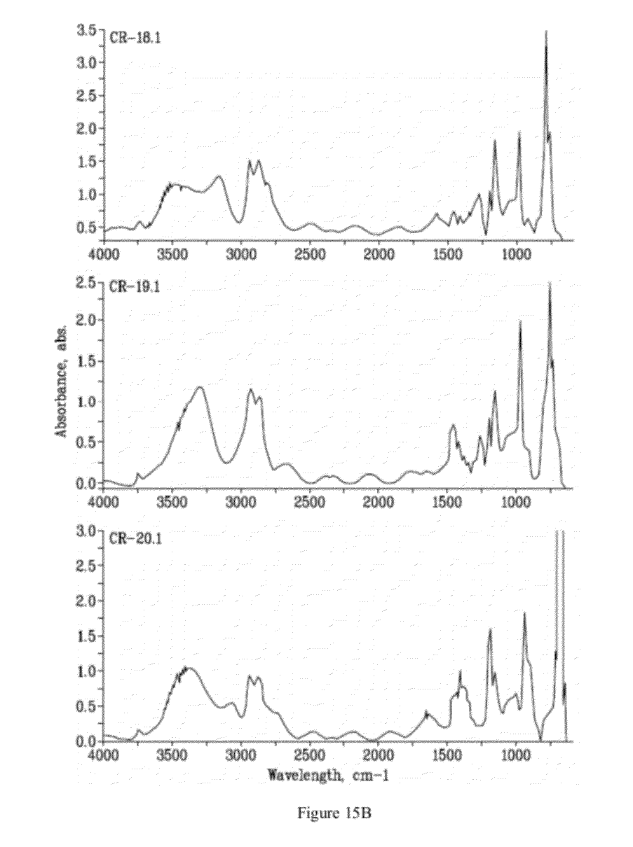

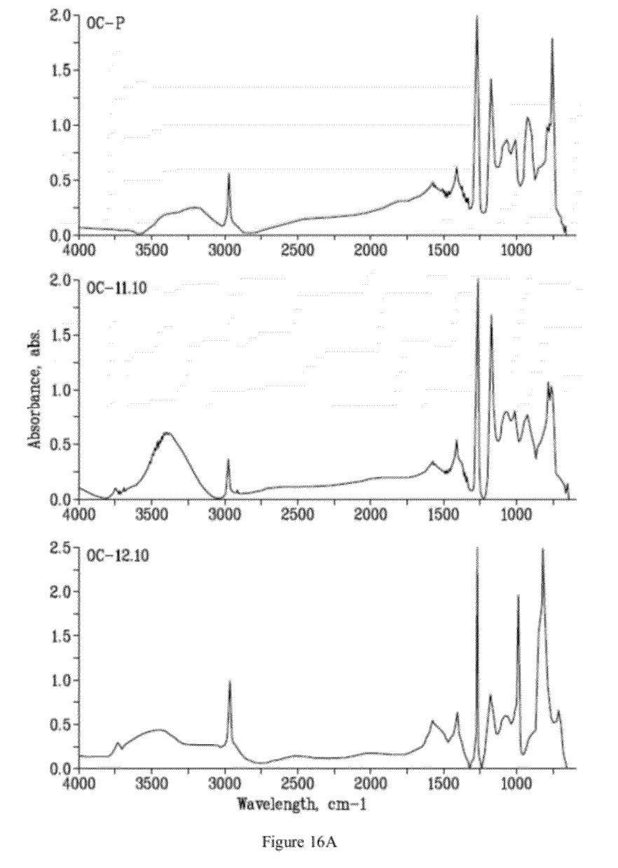

FIG. 15 shows the FTIR spectra from CR coatings and nanocoatings. In the case of CR-16.1 nanocoating containing TiO₂ nanoparticles, the vibrations were similar to those in pristine CR-P coatings. Moreover, the peak shoulder appearing at 920 cm⁻¹ corresponds to the presence of TiO₂ in the coating.

In the case of CR-17.1 nanocoating containing Ti(OH)₄ the display spectrum is similar to that in pristine coating with an additional shoulder peak at approximately 920 cm⁻¹, confirming the presence of SiOTi linkage in the coating network [51].

In the case of CR-18.1 nanocoating containing nanosilica, the peak positions are similar to those of the pristine CR coating except an additional peak appearing at approximately 2800 cm-1. This peak may be due to the polymer coating on silica nanoparticles. Another peak appearing at 3164 cm⁻¹ is probably due to the hydrogenbonded hydroxyl groups.

In the case of CR-19.1 nanocoating containing MMT nanoclay, no major peaks were found that could differentiate nanocoating from pristine coating. A peak at approximately 660 cm⁻¹ is in the spectrum that could be attributed to the presence of MMT in the structure.

In the case of CR-20.1 nanocoating containing SiC nanowhiskers, weak peaks exist in the region close to 2800 cm-1 possibly due to carbon in SiC, while a peak at 3072 cm⁻¹ is due to the hydrogen bonding in the material.

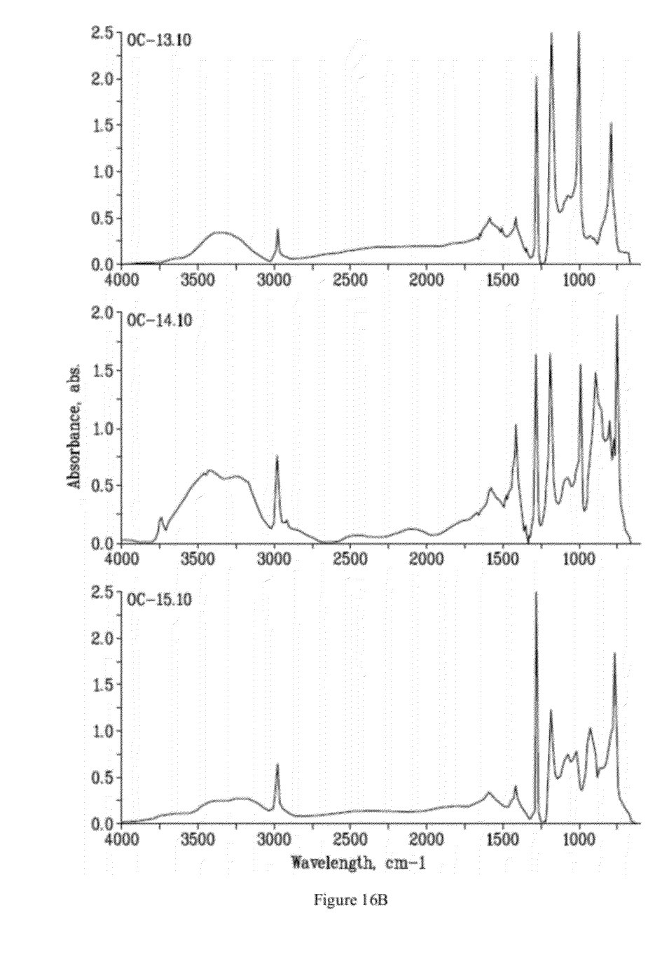

FIG. 16 shows FTIR spectra of QC coating and nanocoatings. Because the amount of hydrocarbon is less compared to that of other coating compositions, the incorporation of foreign ingredients could be easily identified. In the case of QC-11.1 nanocoating containing TiO2 nanoparticles, most of the peak positions are similar to those of the pristine QC coating except two peaks appearing at 929 cm⁻¹ and 1014 cm⁻¹, suggesting the presence of TIO₂ nanoparticles in the coating network.

In the case of QC-12.1 nanocoating containing Ti(OH)₄, the peak position at 921 cm⁻¹ clearly suggests the presence of SiOTi bonding. Another peak at 1010 cm⁻¹ could be due to a TiOTi network in the coating. A hump at approximately 3100 cm⁻¹ is due to the hydrogen bonding associated with hydroxyl group in the coating structure.

In the case of QC-13.1 nanocoating containing functionalized SiO2 nanoparticles, no new peaks could be identified due to similar bonding within materials. The —CH stretching at 2971 cm-1 decreased in intensity compared to pristine QC-P coating, suggesting the increase in silicon content in the coating structure.

In the case of QC-14.1 nanocoating containing MMT nanoclay, two new peaks were identified at 881 cm⁻¹ and 983 cm⁻¹ that were not present in pristine coating composition, suggesting the presence of silicon-based nanoclay in the coating network. Moreover, an additional hump appearing at approximately 3200 cm⁻¹ suggests the presence of hydrogen-bonded clay nanoparticles.

In case of QC-15.1 nanocoating containing SiC nanowhiskers, an additional peak was identified at approximately 920 cm⁻¹ and 1010 cm⁻¹ indicating the presence of SiC in the coating network. Additional hump was found at approximately 3200 cm⁻¹ is probably due to the hydrogen-bonded SiC nanoparticles.

Effect of Nanoparticle Concentrations

FTIR analysis was performed on nanocoatings with variable concentrations of nanoparticles to monitor the change in bonding mechanism in nanocoatings with increased concentrations of nanoparticles. Also, weak peaks that appear due to low nanoparticles content may increase when the content of nanoparticles is increased. Such an analysis may help in identifying the reaction pattern in the material.

The FTIR spectra of nanocoatings PL-, 1,2,3,4,5 that have three variable concentrations of five different nanoparticles are shown in Appendix-A1. The hump at 3200 cm⁻¹ has increased with the increase in TiO₂ concentration. Moreover, the peak position shifted to a higher wavelength with the increase in TiO₂ content in the nanocoatings. Similarly, when the quantity of Ti(OH)₄ was increased, peak positions shifted to a higher wavelength. For SiO₂-containing nanocoatings, the FTIR spectral appearance is unclear and is similar for each composition. Without being bound to any single theory, the coating may not have been transparent enough or the quantity of nanoparticles did not allow the IR beam to reach the detector.

In the case of MMT nanoclay containing nanocoatings, the peak at 667 cm⁻¹ representing nanoclay shows a shift toward the lower wavelength, while the peak at approximately 3200 cm⁻¹ shifted to a higher wavelength, probably due to the increased interaction between the polymer and nanoclay. In the case of SiC nanowhiskers containing nanocoatings, there was no major peak shift except a peak at 1581 cm⁻¹ shifted to 1612 cm⁻¹ with the increase in SiC content, probably due to increased electronic interactions between the different forms of carbon moieties.

The FTIR spectra of nanocoatings HY-1,2,3,4,5, which have three variable concentrations of five different nanoparticles are shown in Appendix-A2. There were no major changes in the spectra except a sharp peak at 732 cm-1 shift to 794 cm-1 and a peak at 3031 cm-1 disappeared with the increase in TiO₂ concentration. The shifting could be attributed to the increased interaction with the nanoparticles and polymer chains, while the disappearance of peak at 3031 cm-1 could be due to the merging of the entire regime involved in creating hydrogen bonding. In the case of SiO₂ containing nanocoatings, a peak at 694 cm⁻¹ that corresponded to silica, enhanced with increased silica content. In the case of MMT nanoclay containing nanocoatings, a peak at approximately 690 cm-1 and 844 cm⁻¹ diminished in intensity with an increase in MMT concentration. In the case of HY nanocoating containing SiC nanoparticles, a peak appearing at 674 cm⁻¹ shifted to a lower wavelength and finally disappeared with the increase in SiC concentration. This could be due to the increased inorganic content that shows spectral assignment at lower wavelengths. However, a sharp peak at 1511 cm⁻¹ with the disappearance of peak at 674 cm⁻¹ suggests that the contribution from inorganic counterpart increases with the enhanced concentration.

The FTIR spectra of nanocoatings CR-1,2,3,4,5 that have three variable concentrations of five different nanoparticles are shown in Appendix-A3. In this case peak positions shifted with an increase in nanoparticles, either because of the enhanced interactions between nanoparticles and silicone or because of the changed refractive index of the material. A clear change appeared in the regime between 3000-3500 cm⁻¹ in each case, suggesting that there is a change in bonding pattern in the nanocoating structures. The FTIR spectra of nanocoatings QC-1,2,3,4,5 that have three variable concentrations of five different nanoparticles are shown in Appendix-A4. The hydrocarbon portion was lower in this coating formulation, giving inorganic moieties fewer opportunities to form permanent bonds. However, with the increased nanoparticles concentration, there was a shift in peak positions in each case of nanocoating either because of the enhanced interactions between nanoparticles and silicone or because the changed refractive index of the material as discussed before. There were no major changes in the peak positions, suggesting that the coating was saturated with nanoparticles and the bonding pattern remained unaffected from the nanoparticles concentration.

Morphological Analysis of Nanocoatings

The durability of coatings or nanocoatings depends on the strength of chemical bonds inherited within the materials as well as the final surface morphology. A coated surface filled with defects such as pinholes, holidays and cavities may not be available for robust applications. The coating compositions containing a high volume of hydrocarbon may contain micropores, cavities or non-uniform surfaces.

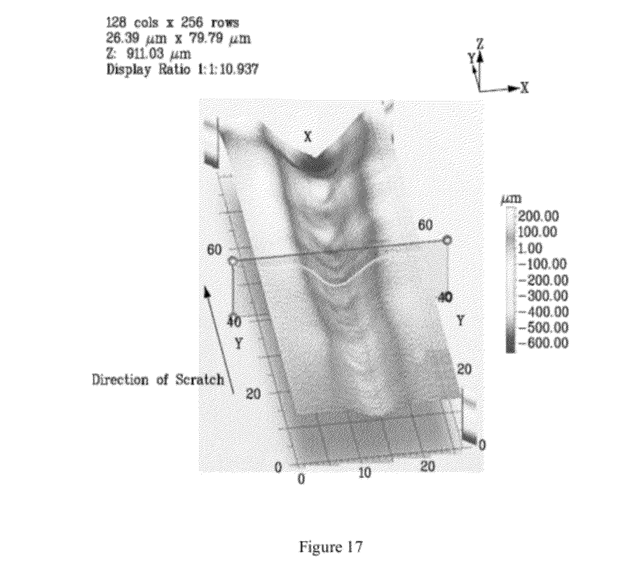

Silicone coatings are transparent and difficult to analyze using conventional microscopic techniques. The atomic force microscopic (AFM) technique was therefore adopted to investigate the surface morphology of the coatings hardened over a polished aluminum surface. The PL coating consisting primarily of epoxy resin was analyzed using the AFM technique and compared with other hybrid silicone coatings. Moreover, an area close to a scratched region was chosen for the scan so that undamaged morphology could be compared with the scratched region. FIG. 17 shows an AFM image of pristine PL coating. The scratched region and another undamaged region were similar due to the plastic nature of the coating. The indenter head compressed rather than scratched or fractured the coating due to the material's plasticity. Few to no coating defects were seen in the images obtained from AFM.

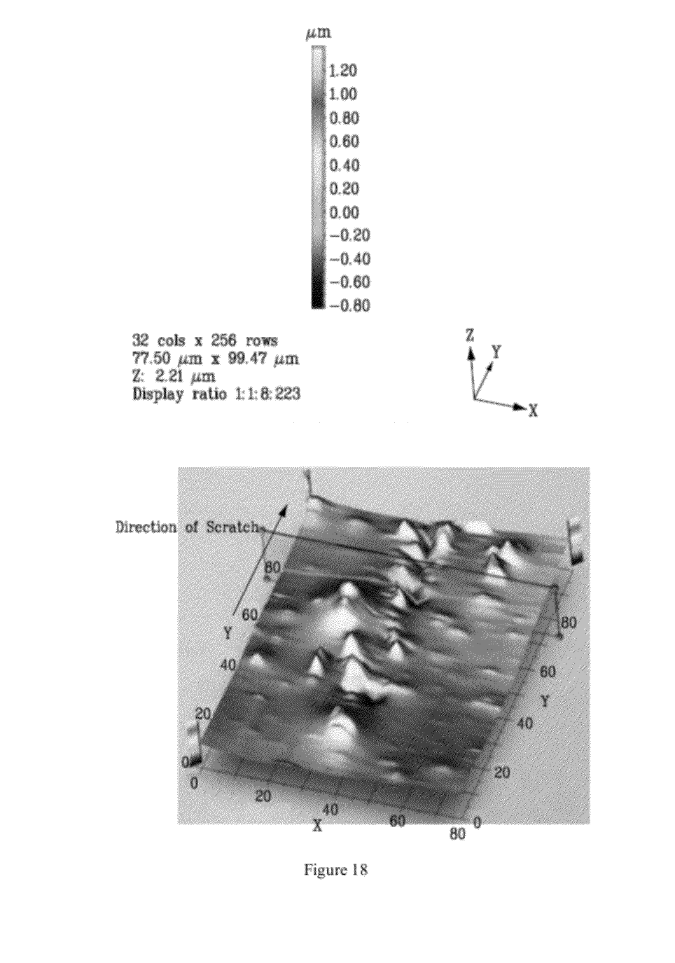

In the case of a HY coating (FIG. 18) that contained 10 wt % epoxy resin and 90 wt. % silicone displayed a brittle failure. The scratched region at least partially recovered when the epoxy resin was introduced. The surface of this coating was rougher than that of a PL coating, possibly because of the roughness associated with the surface of metals. The estimated coating thickness of HY was approximately 5-10 μm, while the estimated thickness of PL coating was approximately 15 μm.

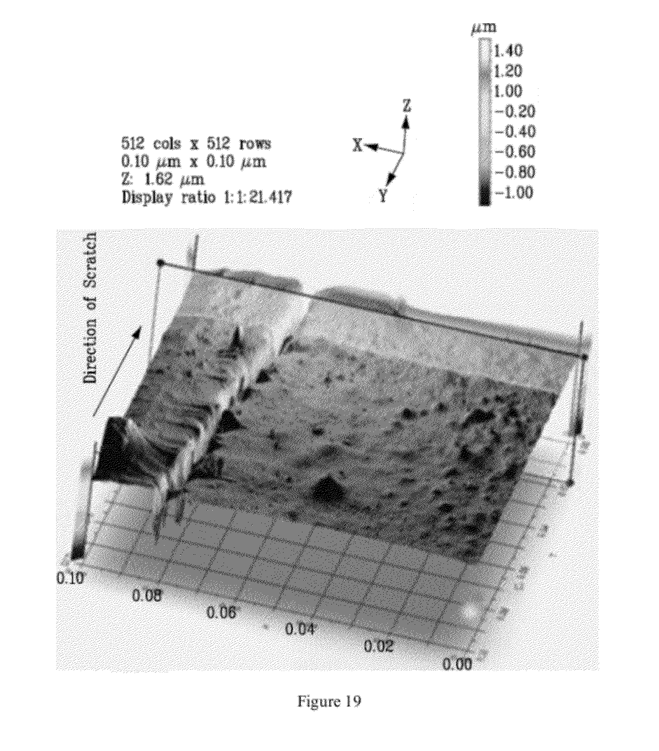

In the case of CR coating (FIG. 19), the hydrocarbon portion was low compared to that of the PL and HY coatings. The estimated thickness of the coating was approximately 5 μm, therefore AFM image of this coating surface displays the roughness associated with the metal surface. Moreover, the scratch region was clean and brittle with little to no plastic recovery. There were no surface defects such as pinholes or cavities in the region of the scan.

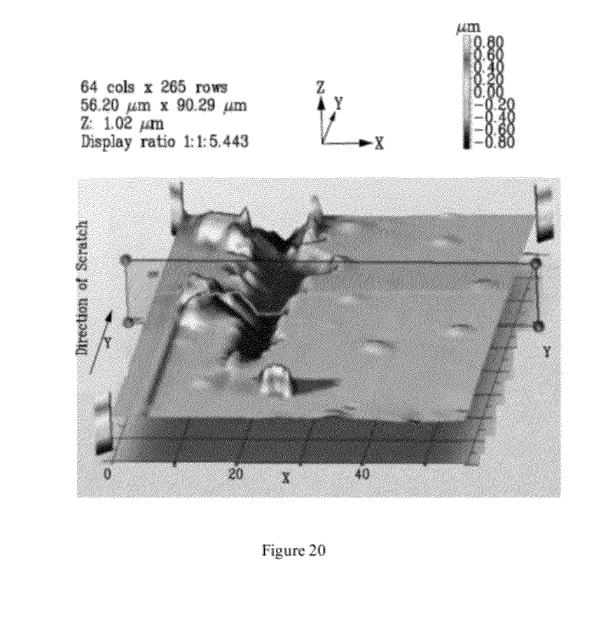

In the case of QC coating (FIG. 20), the hydrocarbon portion was smaller than that of other coating compositions discussed above. The high silicone content leads to a quasi-ceramic network with high strength but some brittle nature. The estimated thickness of the coating was approximately 3 μm, therefore, the AFM image of this coating surface displays the roughness associated with the metal surface as mentioned above. Without being bound to any single theory, the scratched region may suggest a brittle coating and that there was no plastic recovery; however, the coating surface was smooth and defect free.

Nanomechanical Analysis

A material's strength is determined by its chemical bonds. The first appearance of a material's failure occurs after the final dissociation of such bonds. Mechanical properties of materials can be enhanced by increasing the number of chemical bonds which can be achieved by either using a higher number of functional groups or by incorporating nanoparticles. The effectiveness of incorporating nanoparticles in a material to enhance its overall mechanical properties is well documented. Nanoparticles' high surface area provides additional linkages, giving additional strength to the material's network. The question is whether adding nanoparticles affects a material's localized properties. The following section details the variation in nano-mechanical properties of coatings and corresponding nanocoatings.

Effect of Molecular Segment Length

As shorter bonds are stronger than the longer bonds, macromolecular segment length plays some role in strengthening a material. Flexible molecules are able to absorb higher impact energy than are rigid molecules; however, rigid molecules may have better bond stability. It is therefore important to investigate the change in localized mechanical properties in a material upon altering the molecular chain length and chemical bonds [52, 53].

Hardness and Young's Modulus Investigations

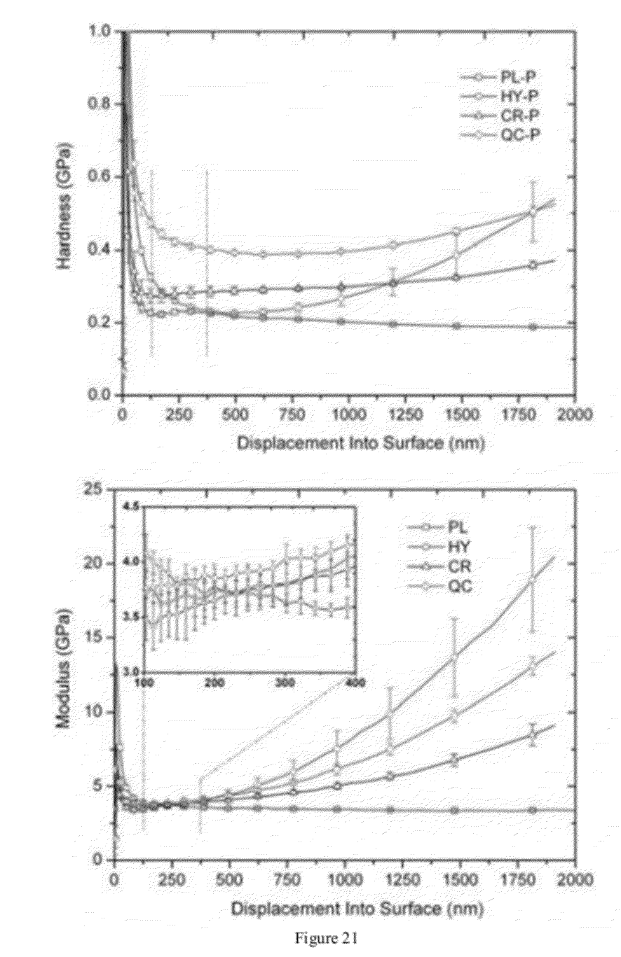

The hardness (H) and modulus (E) values of pristine coatings are shown in FIG. 21a, b, where it can be seen that the H values for PL, CR and QC coatings were not affected by the substrate but the influence of substrate was prominent for HY coating. However, the reported values were calculated from the thickness of coating before the substrate effect dominated.

In the case of PL coating, the H value was 0.226 GPa and the E value was 3.682 GPa. These values are comparable to those reported in the literature for epoxy based coatings [10, 54]. In the case of hybrid HY coating, the H value (0.309 GPa) was approximately 37% higher than that of epoxy (PL) coating, but the E value (3.781 GPa) was closer to that of PL coating. Similarly, the H value (0.273 GPa) for CR coating was approximately 21% higher, but the E value (3.492 GPa) decreased slightly compared to that of PL coating. Note that CR and HY coatings have similar compositions except that the HY coating contains 10 wt % epoxy resin. The H value was however 16% higher than that of the CR coating, although the E value was approximately the same. These differences suggest that hybrid materials have better nano-mechanical properties compared to those of neat polymer or neat ceramer coatings.

On the other hand, QC displayed an H value of 0.461 GPa and an E value of 3.841 GPa [39]. The H value in QC coating was approximately 104% higher and the E value was marginally (4%) higher compared to that of PL coating. Similarly, the H value for QC was approximately 67% higher than that of HY coating, but the E value was 33% less than that of HY coating and approximately 17% less than that of CR coating. These values were calculated considering PL coating values as a baseline.

These results suggest that QC coatings consist of a densely packed/crosslinked network as compared to that of pristine polymeric coating.

Scratch Testing of Pristine Coatings

When a coating is subjected to a scratch test, the indenter can pass through three major regimes in the material: elastic, plastic and fracture. The fracture is immediately followed by the delamination or chipping of the coated surface. The estimation and application of the correct load required to study the above mentioned deformations is very important. The high load can fracture the coating upon contact, eliminating the appearance of the other two regimes. Several different loads were applied to study the deformation on the developed coatings and finally a fixed (500 mN) ramp load was applied to investigate and compare the scratch properties from different coatings.

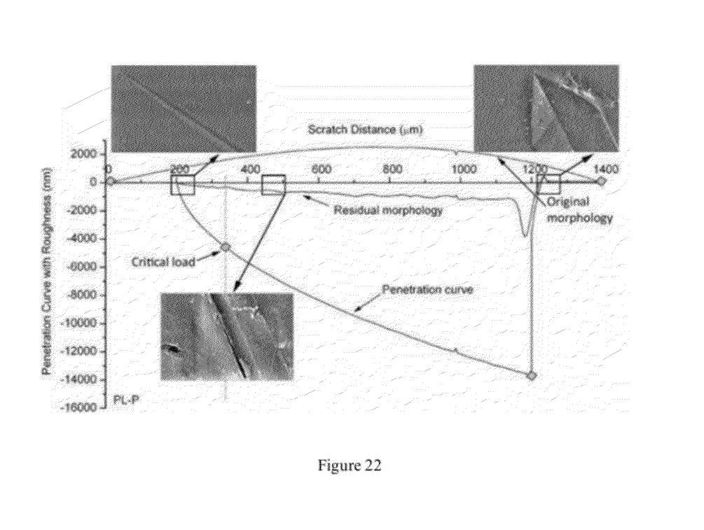

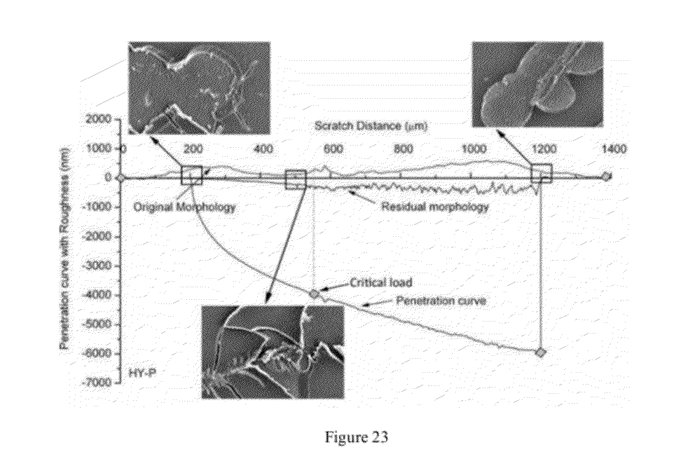

FIG. 22 shows the penetration curve along with residual surface morphology as a function of scratch distance for PL coating [55]. The corresponding nanomechanical parameters derived from scratch tests are shown in Table 2. The curve of the original morphology of the coating was smooth. The penetration curves as well as the SEM images suggest that the coating was compressed with the increase in load and the propagation of the nanoindenter tip. At the critical load of approximately 61 mN, the tip penetrated the coating to a depth of approximately 4.3 μm, while the estimated thickness of the coating was 15 μm. The average scratch width was approximately 25 μm. No clear fracture was seen in this case, however, little cracking was observed that helped in estimating the critical load. The end of the scratch test shows the impression from the indenter tip, indicating that the coating was not fractured but that plastically deformed as a result of the indentation load.

FIG. 4 shows the penetration curve along with the residual surface morphology as a function of the scratch distance for HY coating. The corresponding nanomechanical parameters derived from scratch tests are shown in Table 3. The original morphology of the coating was rough in this case. It appears from the penetration curve that the indenter tip moved smoothly on the coated surface to approximately 550 μm before creating a fracture at a critical load of 170 mN. The average penetration depth at the critical load was approximately 4.0 μm. The estimated thickness of the coating was approximately 8 μm, suggesting that the indenter tip compressed the coating before creating a crack that was followed by a fracture. The SEM images indicate that the coating was brittle because a fracture occurred when the indenter head penetrated the coating. The coating was cracked on the surface with the progressive motion of the indenter, and a complete coating delamination was observed at the end of the scratch test. Some coating delamination was observed around the scratch, suggesting the presence of residual stresses.

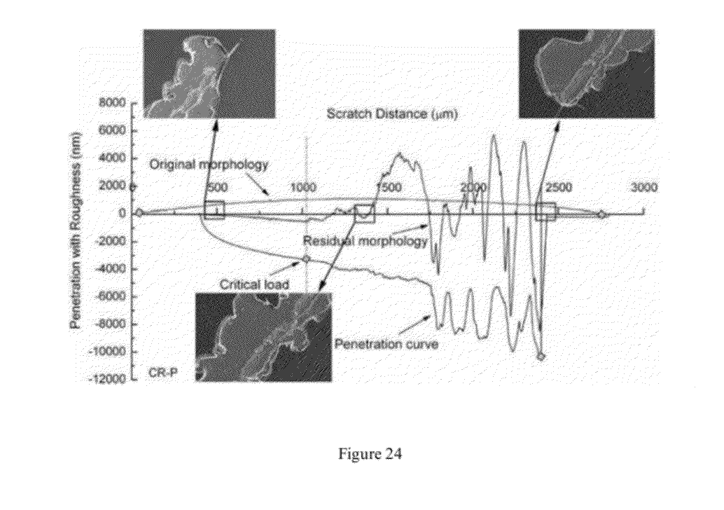

FIG. 24 shows the penetration curve along with residual surface morphology as a function of the scratch distance for CR coating [56]. The corresponding nano-mechanical parameters derived from scratch tests are shown in Table 4. The original morphology of the coating was smooth with a curvature. The indenter head propagated and fractured the coating at a critical load of approximately 160 mN and after the scratch distance of 1.0 μm. The estimated thickness of the coating was approximately 6 μm, and the depth of penetration at critical load was approximately 3.0 μm, suggesting that the coating cracked before the fracture and was followed by delamination. The SEM images from the initiation, propagation and termination sites in the scratch suggest that the coating failed because of a brittle fracture mechanism.

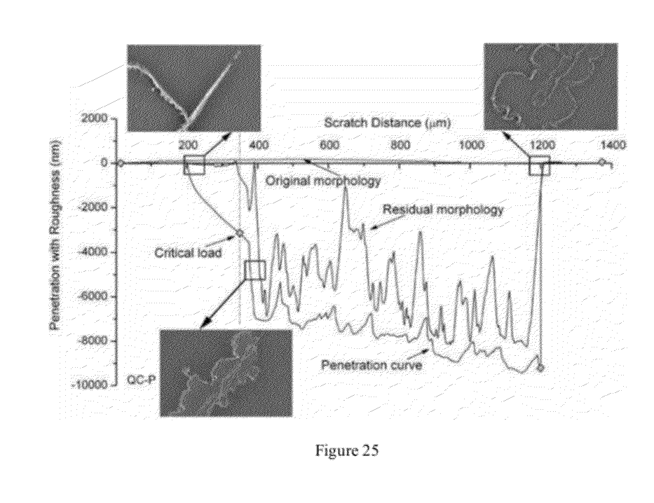

FIG. 25 shows the penetration curve along with residual surface morphology as a function of the scratch distance for QC coating. The corresponding nano-mechanical parameters derived from scratch tests are shown in Table 5. The original morphology of the coating was smooth in this case, with a roughness in the nanometer regime. It appears from the penetration curve that the progressing load bearing the indenter tip pushed the coating and fractured at a critical load of approximately 84 mN after travelling a scratch distance of 350 μm. The estimated thickness of the coating was approximately 5 μm and the depth at critical load was approximately 4.3 μm, suggesting that it cracked and fractured simultaneously. The SEM images of the initiation, propagation and termination steps during the scratch suggest that the indenter scratched the surface after which the surface cracked. The coating and substrate chipped off at the termination point of the scratch test.

On comparing the results from scratch tests conducted on four pristine coatings, it appears that HY showed maximum fracture strength followed by CR coating. The presence of a hydrocarbon portion in these coating compositions may provide a better resilience capability in the coating that would enhance its fracture toughness. On the other hand, a low critical load in the case of PL coating could be an underestimation due to the absence of a clear fracture in the coating. The low critical load value in the case of QC coating could be due to the increased brittleness in the coating structure.

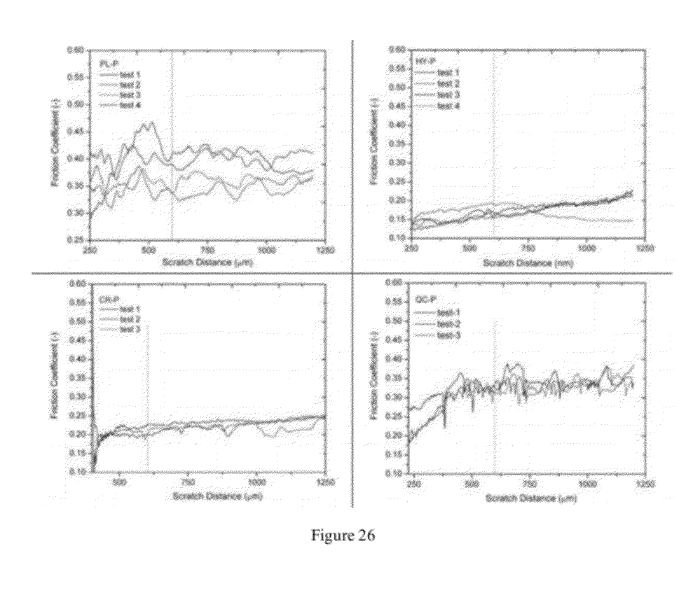

The coefficient of friction (COF) curves as a function of scratch distance are shown in FIG. 26. The curves from at least four tests are shown for better clarity. In the case of PL coating, the COF value after a 600 μm scratch distance was between 0.35 and 0.40, while for HY coating, this value was between 0.15 and 0.19. The lower value in the case of HY compared to polymer coating could be due to the presence of silicone. In the case of CR coating, the COF value was between 0.20 and 0.22. This value was lower than that of pristine polymer coating but closer to that of HY. The COF value for QC coating was between 0.30 and 0.35, a value closer to that of PL coating.

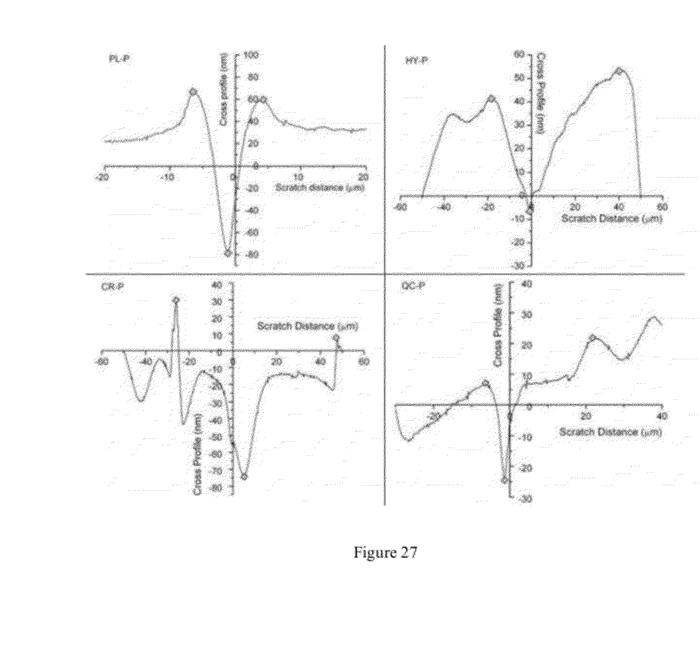

The cross profile topography (CPT) of PL, HY, CR and QC coatings as a function of scratch distance is shown in FIG. 27. The CPT was acquired at the end of the scratch test when the load was 10 mN for each coating. The positive values on the X-axis show the right side of the groove, while the negative values on the X-axis show the left side of the groove. Similarly, the positive values on the Y-axis show the pile-up after the scratch, while the negative values on the Y-axis show penetration in the coating. The CPT curve shown here is one of the five curves recorded on the same coating. The CPT curves were a different in each test. A representative curve is shown here for each coating.

In the case of PL coating, the penetration depth was approximately 80 nm, while the pile-up height was approximately 60 nm. For HY coating, the pile-up height was similar to that of PL coating but the depth of penetration was approximately 8 nm. In the case of CR coating, the penetration depth was approximately 80 nm, while the pile-up height was 30 nm. These figures suggest that HY has better scratch resistance than do pristine polymer and ceramer coating. Similarly, for QC coating, the pile-up height was approximately 20 nm, while the depth of penetration was approximately 25 nm. The lowest pile-up height and moderate depth of penetration achieved in the case of QC coating suggests that the material was hard and elastic in nature.

Dynamic Mechanical Response of Pristine Coatings

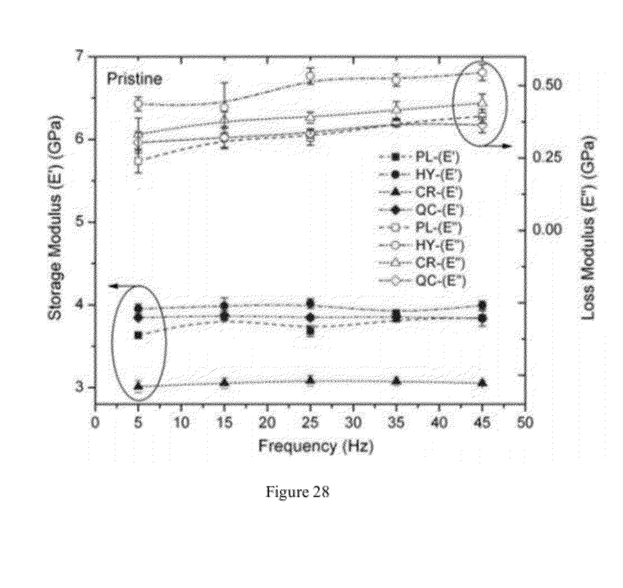

The effect of molecular chain length on visco-elastic properties of the pristine coatings are investigated in this section. FIG. 28 shows storage modulus (E′) and loss modulus (E″) of pristine coatings as a function of frequency. At least six tests were performed at each frequency; results are shown with the error bars. It can be seen that the test shows good repeatability. The E′ values of pristine coatings were independent of frequency, while the E″ value increased slightly with the frequency. The CR coating showed the lowest E′ (3.013 GPa) value, while the HY coating displayed the highest (3.952 GPa). Interestingly, the E′ value for QC coating (3.847 GPa) was in between those of HY and PL coatings.

The E″ value (0.437 GPa) for HY coating was higher compared to that of other coatings, possibly due to the relaxation phenomenon associated with polymer, creamer and hybrid domains in the material. The E″ values of PL, CR and QC coatings were close and independent of test frequency. These findings suggest that the macromolecular network in the coatings is similar in a 3-dimensional domain.

Effect of Nanoparticles in Nanocoatings

The change in nano-mechanical properties of coatings and nanocoatings with the addition of nanoparticles is discussed in this section.

Hardness and Young's Modulus Investigations

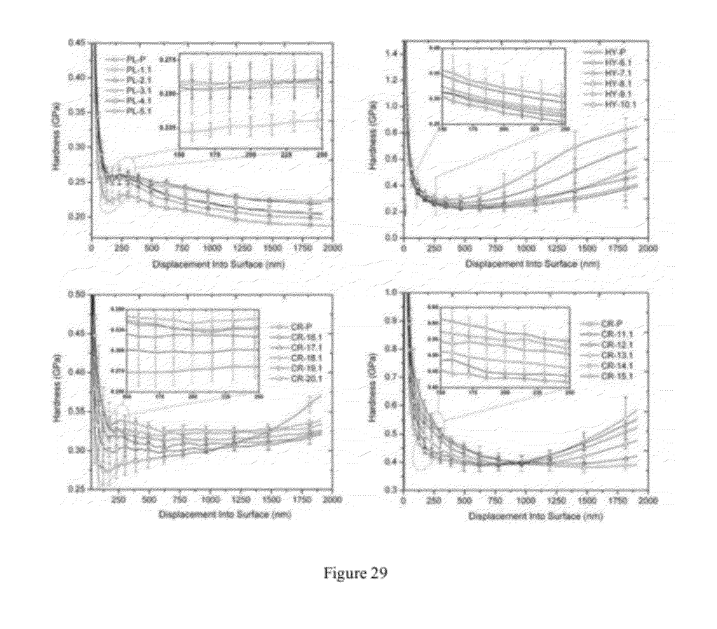

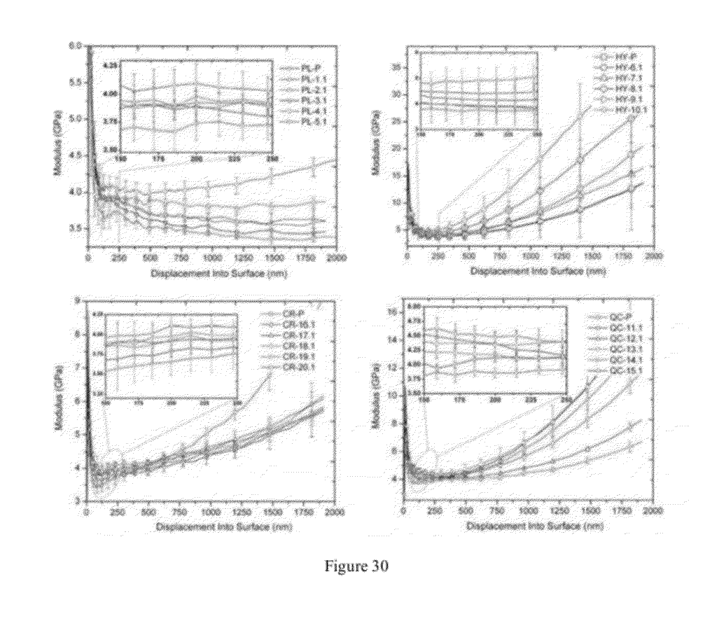

FIGS. 29 and 30 show the H and E values of coatings and nanocoatings as a function of displacement into a surface. FIGS. 29 and 30 shows that H and E values were least affected in the case of PL and CR coatings and nanocoatings, probably due to the sufficient coating thickness on the substrate. The H values were affected beyond a 500 nm depth in the case of HY coatings and nanocoatings and beyond a 1000 nm depth in the case of CR coatings and nanocoatings.

FIG. 30 shows E values of coatings and nanocoatings as a function of displacement into the surface. E values remained unaffected up to a 500 nm depth of penetration in each case except with HY coatings and nanocoatings where this value remained unaffected up to a 300 nm penetration depth.

The effect of nanoparticles incorporation in coatings can also be seen in FIGS. 29 and 30 where the pristine coatings are compared to nanocoating compositions containing 0.1 wt % nanoparticles. There was an increase in H as well as E values with the addition of nanoparticles. In the case of PL nanocoatings, the maximum H value was achieved for nanocoating containing Ti(OH)₄ mediated nanoparticles [58], while the E value was highest for nanosilica containing nanocoatings.

In the case of HY nanocoatings, high H and E values were seen for nanosilica and SiC nanowhisker containing nanocoatings. An increase in the H value between 15% and 18% was observed when nanosilica and nanowhiskers were added to the coatings. The E values in these nanocoatings were as much as 21% higher compared to those of the pristine coating.

In the case of CR nanocoatings, the maximum H and E values were seen for the nanocoatings containing SiC nanowhiskers. The H value was 27% improved, while the E value improved approximately 14% compared to that of the pristine CR coating.

For QC coating, H and E values were highest for nanocoating containing Ti(OH)₄ mediated nanoparticles. The maximum H value in such a case was approximately 36% higher that of QC, while the E value was approximately 19% higher compared to that of pristine QC coating.

The increment in the H value for PL nanocoating containing Ti(OH)₄ may be explained by the reactive ethoxy functional groups that form permanent covalent bonds with reactive epoxy functionalities, a reaction that enhances hardness. On the other hand, the H value increase in HY nanocoatings containing nanosilica and nanowhiskers may be due to the enhanced interaction between inorganic nanofillers and an inorganic silicone network. The organic portion in this composition may act as a binder that keeps inorganic fillers intact in the nanocoating structure.

In CR nanocoatings, the increment in the H value due to the presence of nanowhiskers could be attributed to the inorganic-filler interaction effect. The shape of SiC nanowhiskers is similar to a thin film or membrane that might interact with the electron cloud of silicone. Such an interaction provides additional strength to the coating network.

The composition of QC coating consists of little to no hydrocarbon. However, the reactive functionalities present in the coating form stable bonds with the additional functional groups originating from titanium ethoxide. These additional bonds provide added strength to the nanocoating structure.

Effect of Nanoparticles on Nanoscratch Testing of Nanocoatings

One analysis of scratch tests conducted on nanocoatings can be found elsewhere herein. Corresponding nano-mechanical parameters are appended in Tables 6-9, which shows the enhancement in the critical load in nanocoatings compared to that of pristine coatings (Table 2-5). The comparison is made between pristine coating and nanocoatings containing 0.1 wt % nanoparticles.

In the case of PL nanocoating, the enhancement in the critical load was between 20% and 182% once nanoparticles were added. A particular improvement was noted for nanosilica-containing nanocoating.

In the case of HY nanocoating, the critical load enhancement was between 24% and 80% once nanoparticles were added. A particular maximum improvement was recorded for nanocoating containing SiC nanowhiskers.

In the case of CR nanocoating, the critical load increment up to 38% was achieved for nanocoating containing nanosilica.

Dynamic Mechanical Response of Nanocoatings

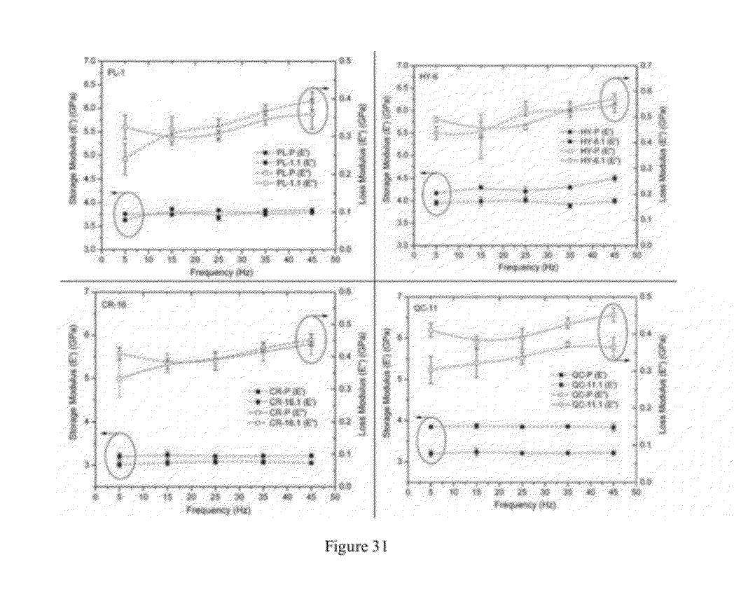

In this section, the change in visco-elastic properties of four different coatings containing the same nanoparticles and their concentration are compared. This design reveals whether adding nanoparticles changes visco-elastic properties of a coating. The E′ and E″ values for pristine coating and nanocoating containing 0.1 wt % TiO₂ nanoparticles as a function of frequency are shown in FIG. 31.

It appears from FIG. 31 that the E′ value remained unaffected by test frequency. However, the E″ value changed with the frequency for each nanocoating. E″ values were higher at lower frequencies for each nanocoating, indicating that the relaxation process associated with the regime containing nanoparticles. It is worth mentioning that molecular motions are associated with polymer materials are more prominent at lower frequencies. On the other hand, such transitions are not visible at higher frequencies because molecules may not get enough time to undergo rapid molecular transformations. In other words, at lower frequencies, molecules have a longer time to react and the viscous term dominates, while at a higher frequency molecules may not have sufficient time to relax and the response is mainly due to elasticity with limited viscous nature. The quasi-linear increment in E″ could be due to the high frequency that results in a higher loading rate effect.

The E′ values were similar for PL coatings and nanocoatings but the E″ value was higher for nanocoating compared to that of pristine coating at lowest frequency. However, the E′ value for HY nanocoating was higher compared to that of pristine coating, suggesting HY coating has a tendency to store energy. On the other hand, the E″ values were similar for HY coating and nanocoating. In the case of CR, E′ value was slightly higher for nanocoating than for that of pristine coating, but the E″ values were similar in both the cases.

A distinctly different behavior was observed in QC coating and nanocoating. The E′ value decreased significantly when nanoparticles were added, indicating that this material may have a reduced ability to absorb energy. However, the E″ value increased with the addition of nanoparticles, indicating the likely presence of nanodomains in the material responsible for the localized molecular motions.

The complete investigation curves for visco-elastic properties of coatings and corresponding nanocoatings as a function of frequency is shown in Appendix D1-D4. In the case of PL coatings and nanocoatings, E′ values were not affected by the presence of nanoparticles. However, E″ values were higher at 5 Hz frequency in all of the nanocoatings, suggesting the presence of molecular motions in the nanocoating structure.

In the case of HY coating and nanocoating, both E′ and E″ values varied with the addition of nanoparticles. Interestingly, both E′ and E″ values varied with frequency. In all of the nanocoatings, the E′ value increased when nanoparticles were added, suggesting the damping characteristic in the material. Similarly, E″ values changed as the frequency changed; however, the values were close to that in the pristine coating.

In the case of CR coating and nanocoatings, the E′ value increased when nanoparticles were added and remained constant at different frequencies. These results suggest that nanocoatings may have a tendency to resist cyclic loading and unloading. Similar to above cases, the E″ value was higher at lower frequencies and similar to the E″ of pristine coating at higher frequencies.

In the case of QC coating and nanocoating, the E′ and E″ values increased when nanoparticles were added except when Ti(OH)₄ was included. The E′ value remained unaffected by frequency, while the E″ value changed with frequency. These results suggest that the incorporation of nanoparticles in the coating formulation creates free volume in the resultant nanocoating structure and that domains modified by nanoparticles were distributed in the coating network.

Effect of Nanoparticles Concentration in Nanocoatings

Present here is an investigation of how nano-mechanical properties are affected when the concentration of nanoparticles in the nanocoating structure are modified.

Hardness and Young's Modulus Investigations

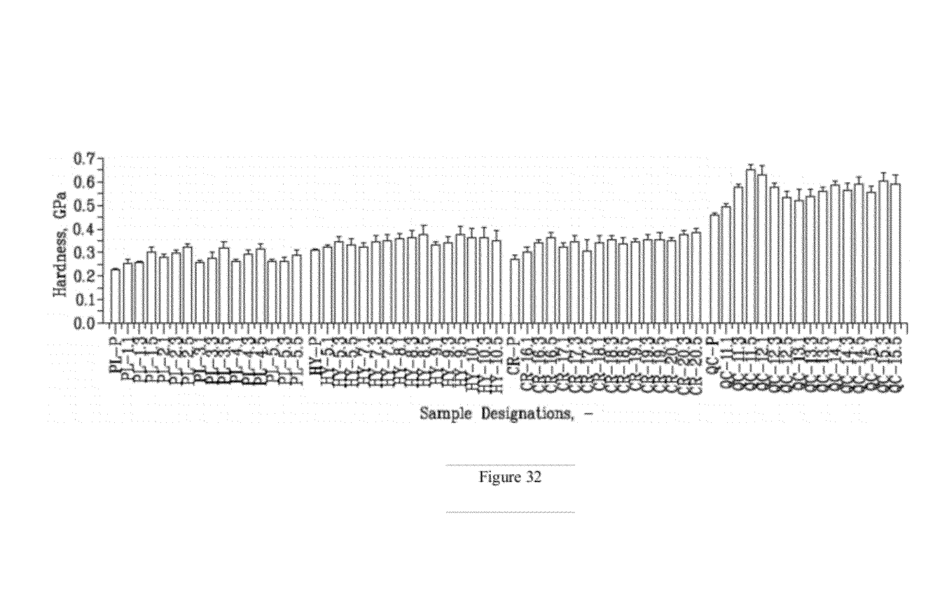

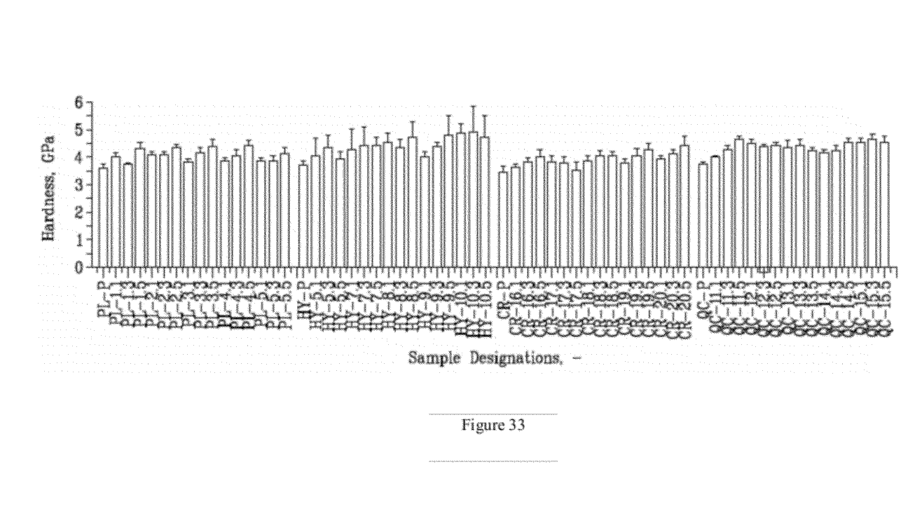

FIGS. 32 and 33 show changes in H and E values as a function of nanoparticles concentration in nanocoatings. Interestingly, in PL nanocoatings, the H value increased as the concentration of nanoparticles increased. The maximum improvement in H value was 42% for 0.5 wt % nanosilica containing nanocoating.

In the case of HY nanocoatings, the H value increased with the nanoparticles concentration except for the nanocoating containing SiC nanowhiskers where the H value decreased slightly with the increase in nanoparticles concentration, probably due to the agglomeration of SiC nanowhiskers. The largest H value increment was approximately 21% for nanosilica containing nanocoating.

In the case of CR nanocoating, the H value increased with the nanoparticles concentration except for the composition containing Ti(OH)₄, in which case the H value increment was 25% for 0.3 wt % nanoparticles concentration. The largest H value increment was approximately 41% for 0.5 wt. % SiC nanowhiskers concentration. In the case of nanosilica containing nanocoating, the H value remained unaffected by changes in nanoparticles concentration.

In the case of QC nanocoating, the H value increment was random. Upon adding nanoparticles, the H value was higher than it was in pristine coating. However, the H value increment was not linear as in the cases mentioned above. The increment in the H value decreased with the increase in Ti(OH)₄ mediated nanoparticles. The H value increment remained unaffected by the concentration of nanoclay and nanowhiskers, while the value increased with the concentration of TiO₂ and nanosilica containing nanocoating. The maximum increment was approximately 41% for 0.5 wt. % TiO₂ nanoparticles containing nanocoating. This H value was approximately 188% higher compared to that of PL based coating.

Effect of Nanoparticles Concentration on Scratch Testing of Nanocoatings

The nanomechanical parameters derived from nanoscratch testing of nanocoatings are shown in Tables 6-9.

The critical load was highest for the 0.5 wt. % TiO₂ nanoparticles containing nanocoating. The first sign of a crack or fracture appeared at a depth of 8.5 μm, indicating that the coating was securely adhered to the metal surface. Delamination was assessed on the basis of final surface morphology. A slight improvement was observed for nanowhiskers containing nano-coating that showed a high value for the total height of the groove, suggesting that the nanocoating was severely damaged during the scratch.

In the case of HY nanocoatings, the maximum value of the critical load was observed for the nanocoating containing 0.3 wt % nanowhiskers. The penetration depth at critical load was 6.9 μm, while the coating thickness was within 8 μm, suggesting (without being bound to any particular theory) that a crack or fracture may have occurred well before the nanocoating delamination. The total height of the groove and pile-up height of the nanocoating was moderate, suggesting that the nanocoating was toughened due to the presence of epoxy polymer in the coating formulation. The critical load value decreased when a higher amount of TiO₂ nanoparticles were added, perhaps due to agglomeration of nanoparticles in the final coated structure.

In the case of CR nanocoatings, the critical load value showed linear enhancement when more nanoparticles were added. The maximum critical load took place when 0.5 wt % TiO2 nanoparticles were added. The estimated thickness of the coating was within 6 μm, while the depth of penetration at critical load was 4.8 μm, suggesting that fracturing and delamination occurred simultaneously. The minimum increment in the critical load was observed 0.1 and 0.3 wt % Ti(OH)₄ nanoparticles containing nanocoatings. The scratch width and pile-up height were highest in the case of the nanowhiskers containing nanocoating, suggesting that the coating was brittle.

In the case of QC nanocoating, the maximum enhancement in the critical load value was achieved for 0.5 wt % TiO2 nanoparticle containing nanocoating. The estimated thickness of this nanocoating was approximately 5 μm, while the penetration depth at the critical load was approximately 5.3 μm, suggesting that fracture may have occurred with chipping-off the coating metal surface. The critical load value decreased in the case of Ti(OH)4 and SiC containing nanocoating. Residual scratch depth and pile-up height were low in all of the QC anocoatings, clearly indicating that the coating was elastic and that the failure occurred through brittle failure followed by chipping off the coated surface.

Concentration Effects on Dynamic Mechanical Properties of Nanocoatings

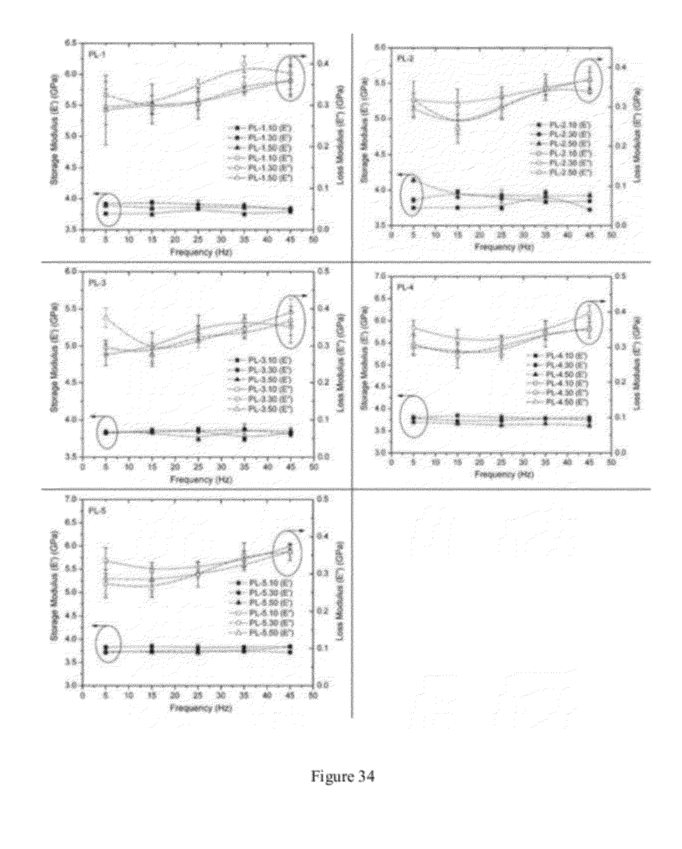

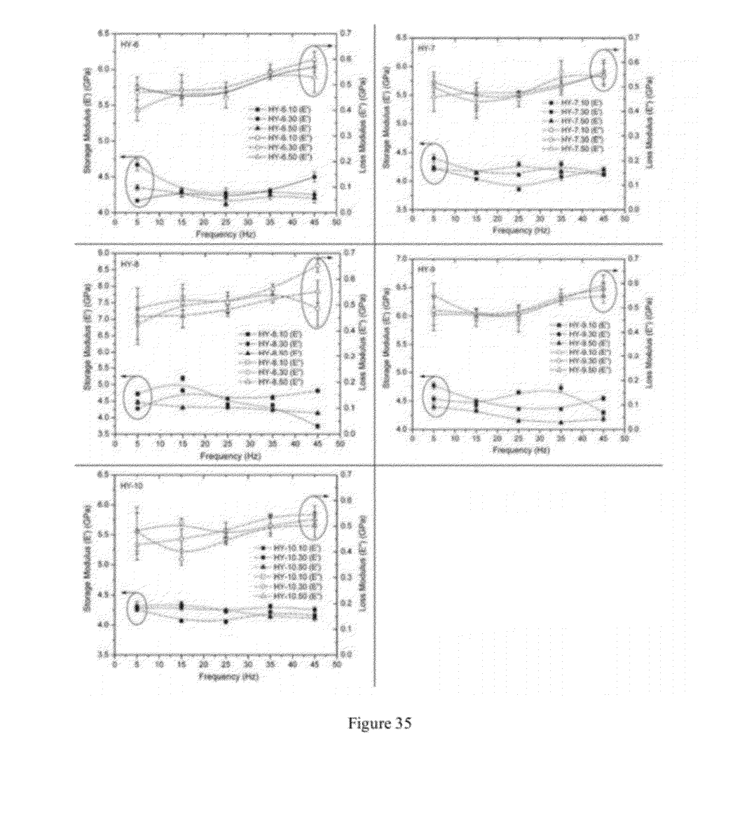

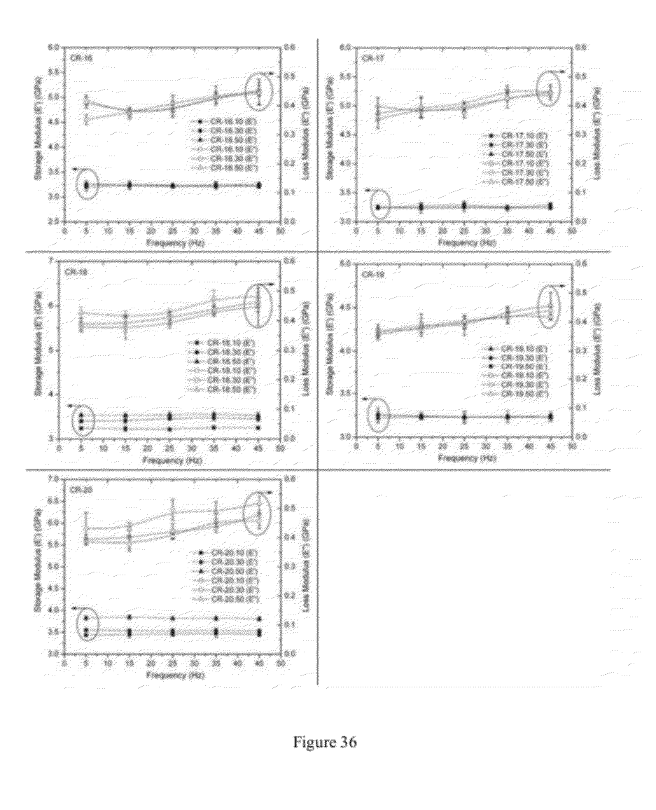

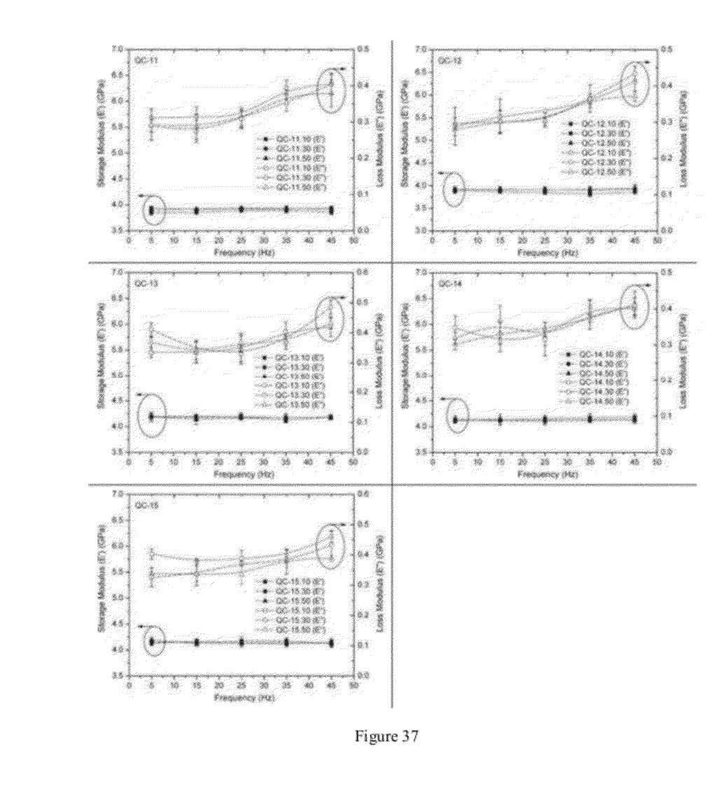

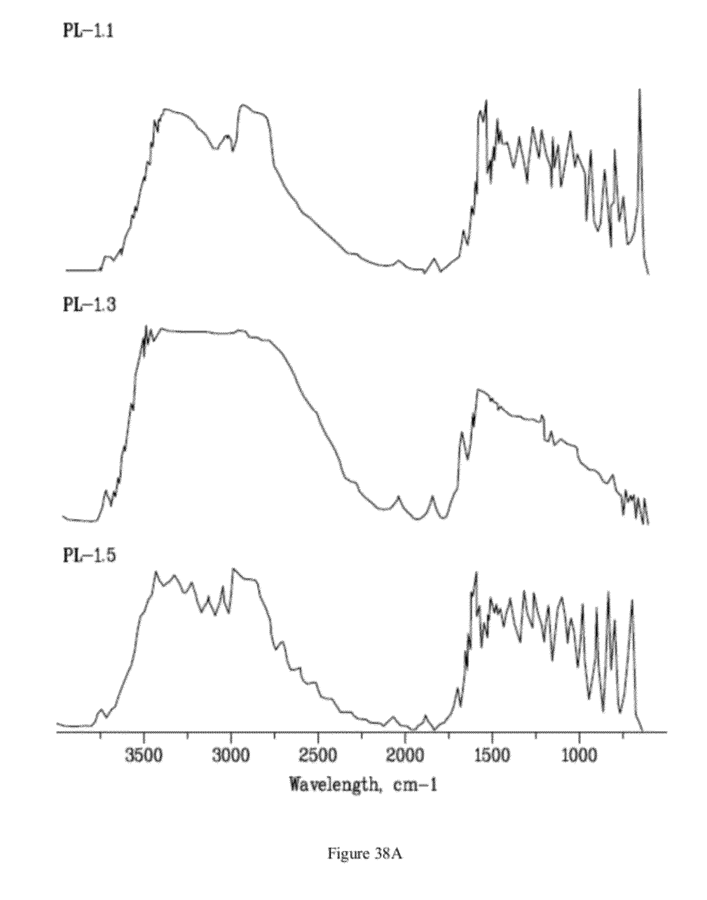

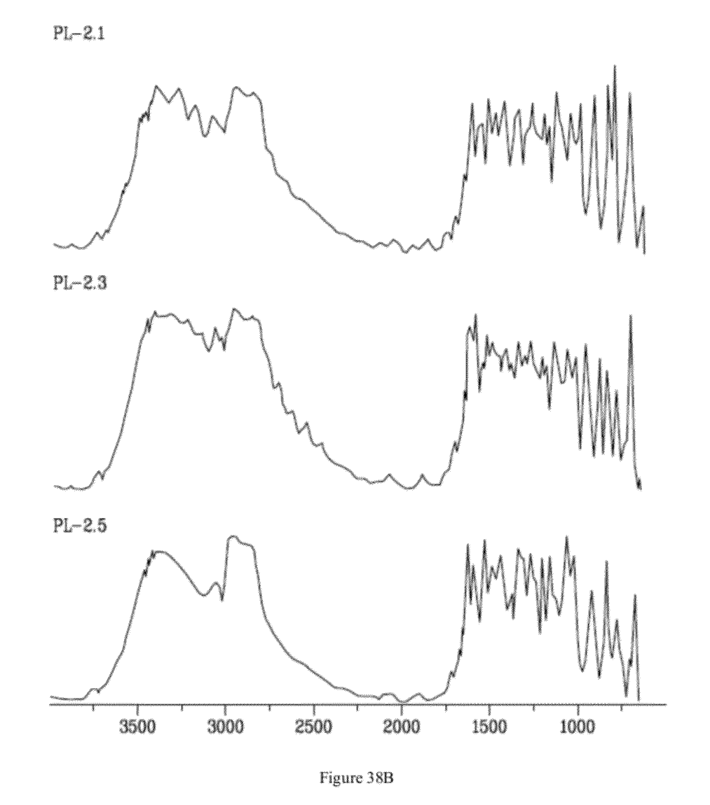

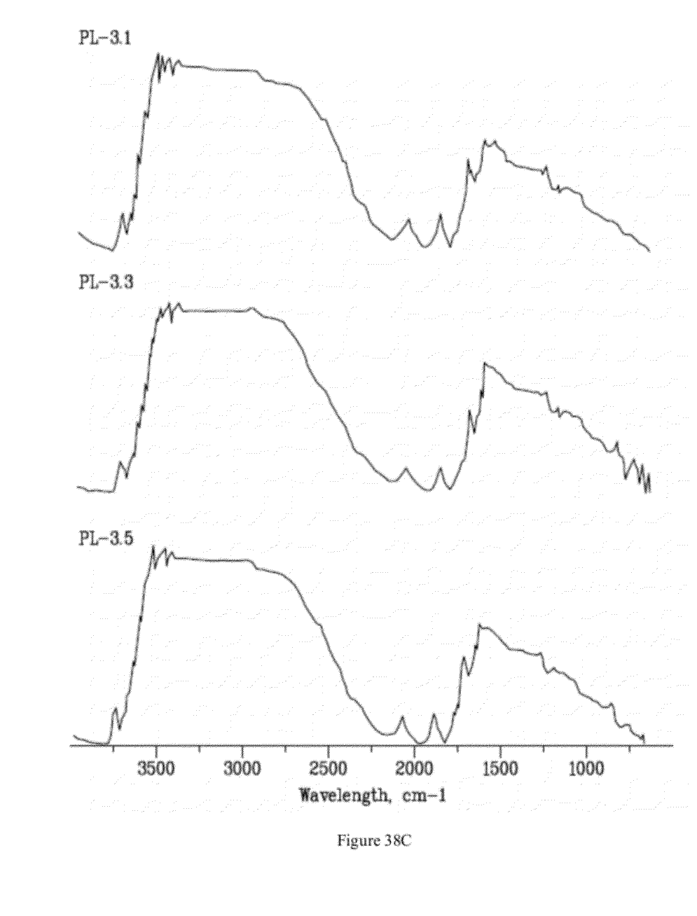

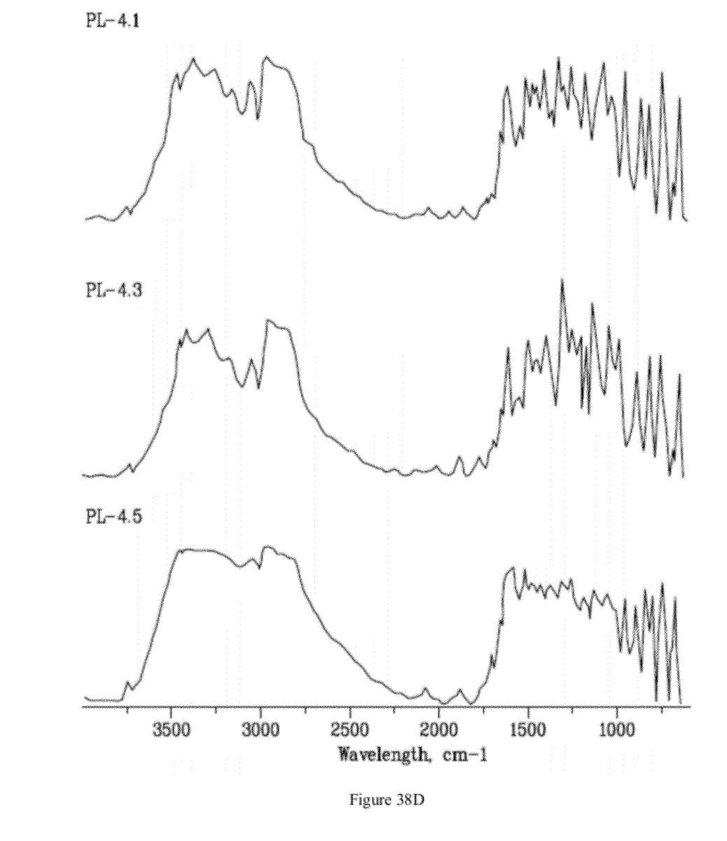

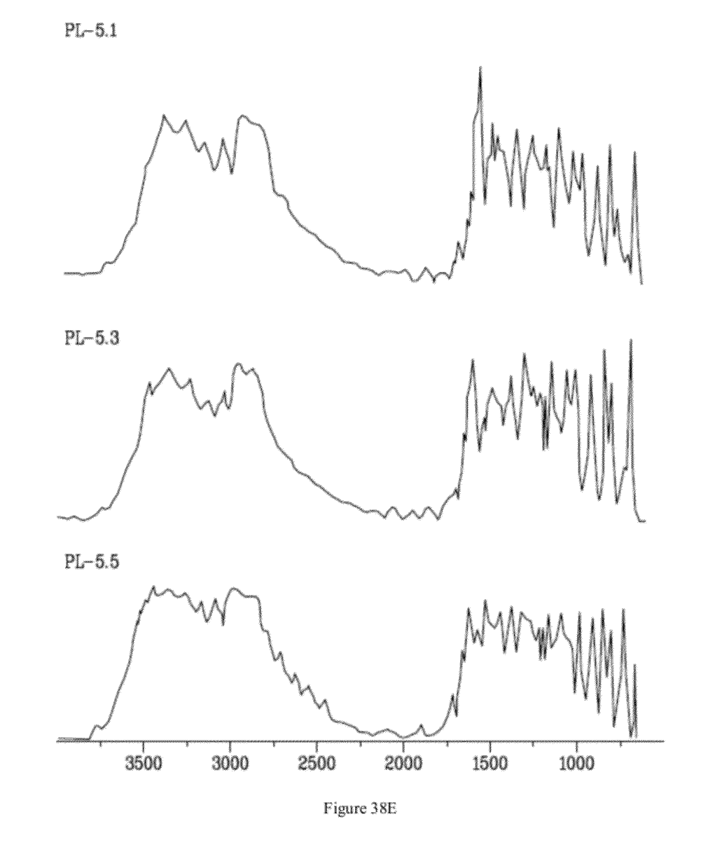

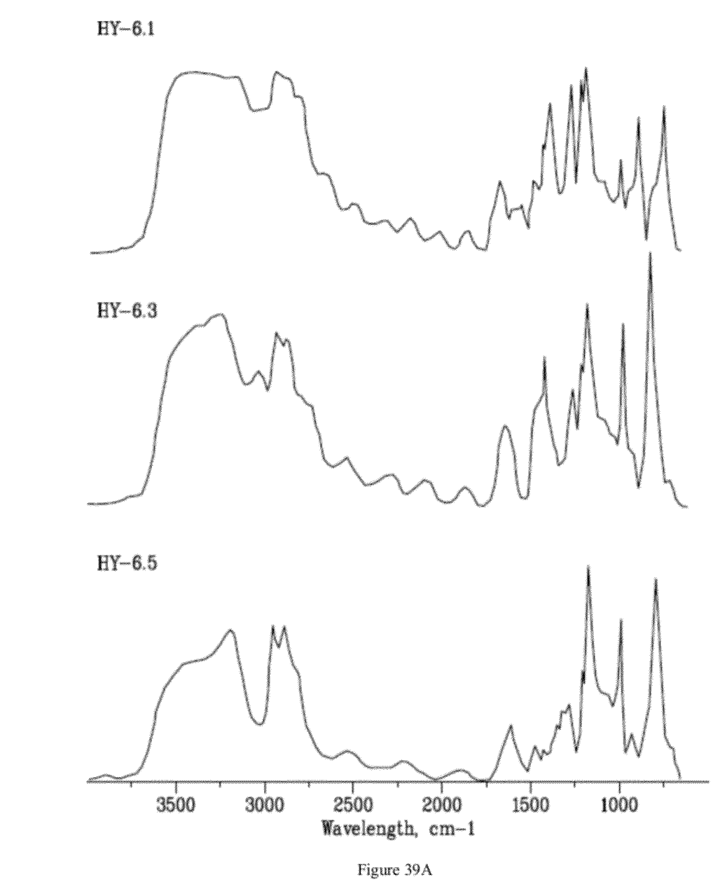

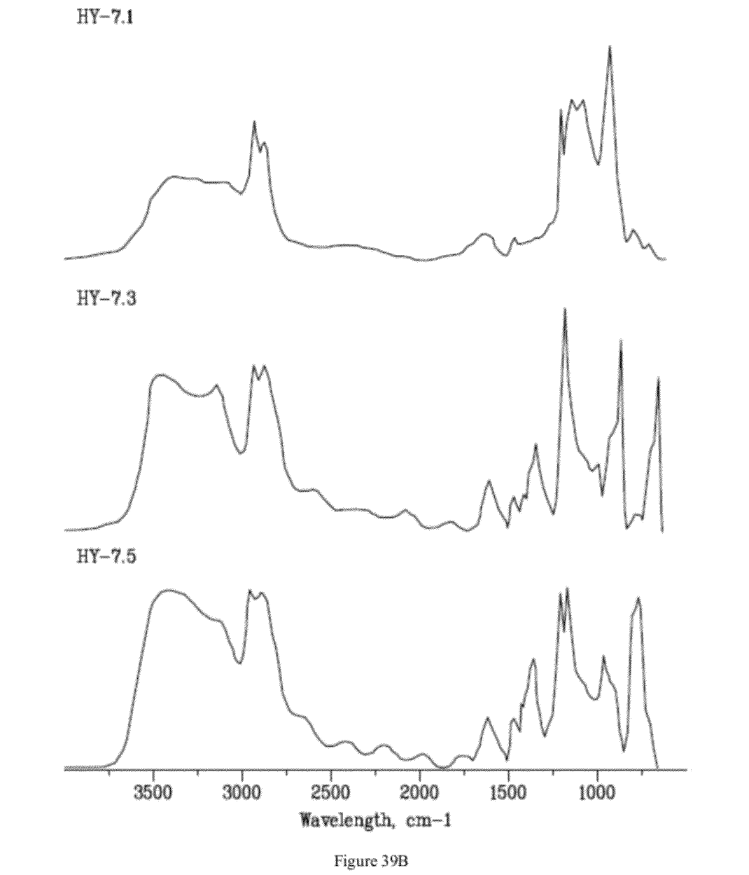

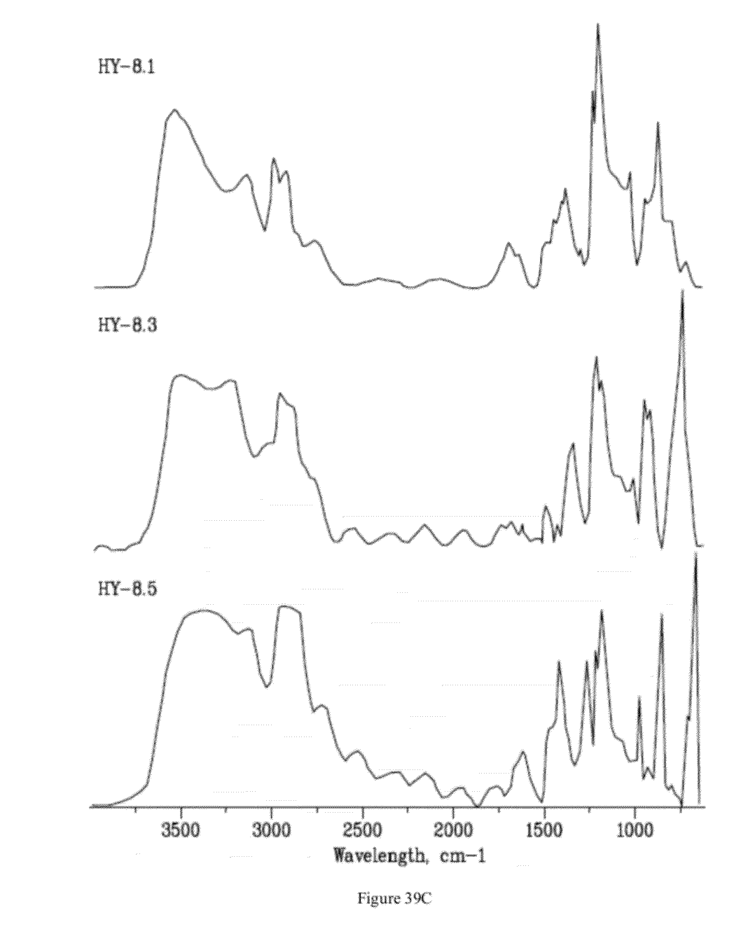

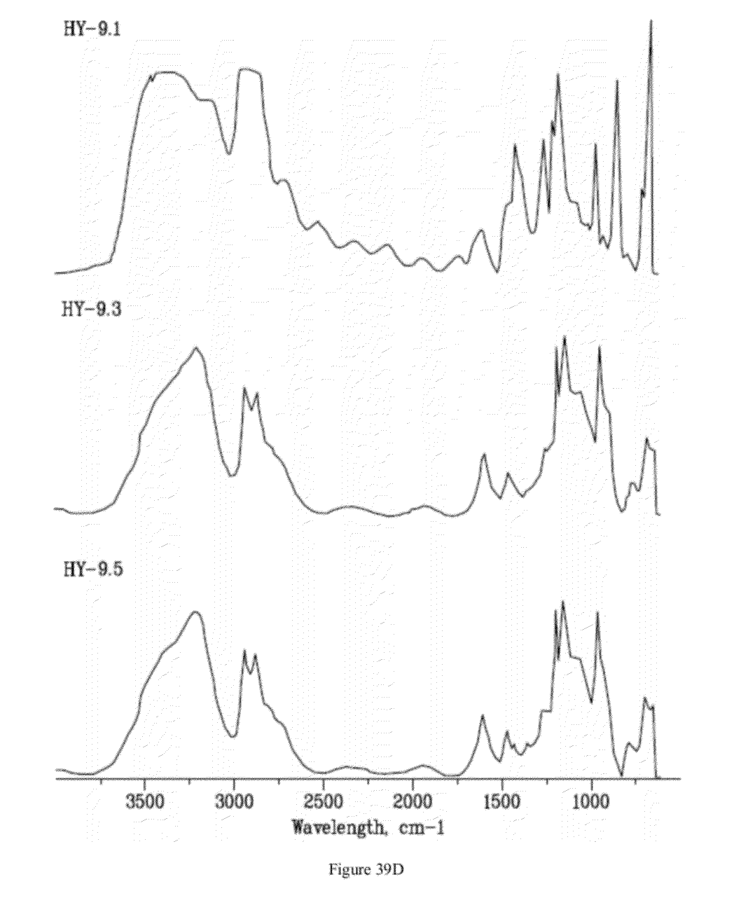

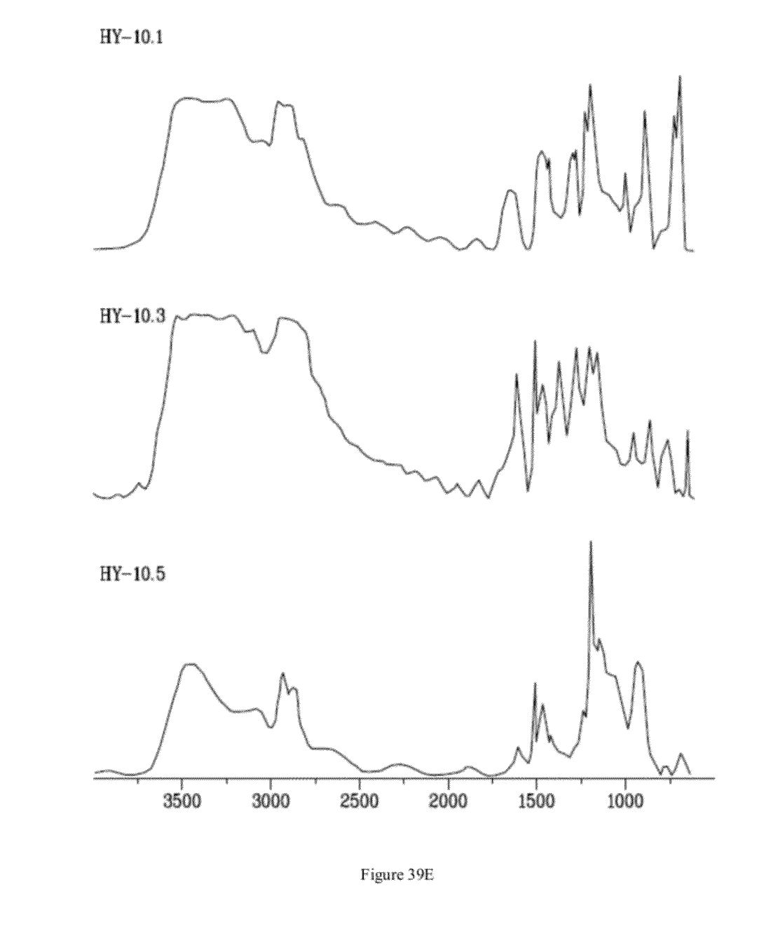

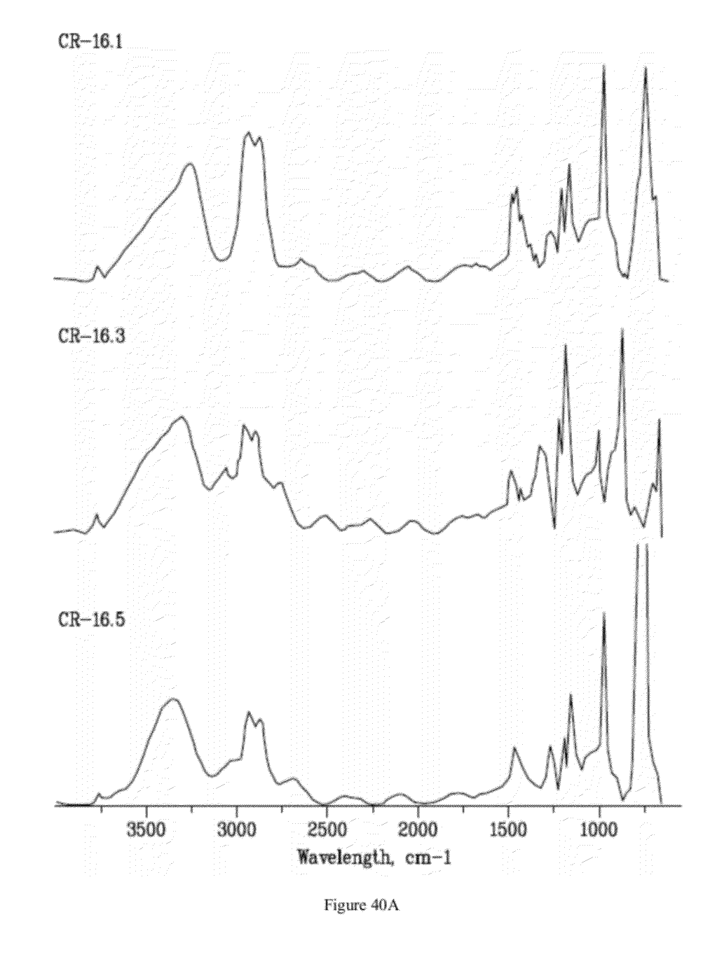

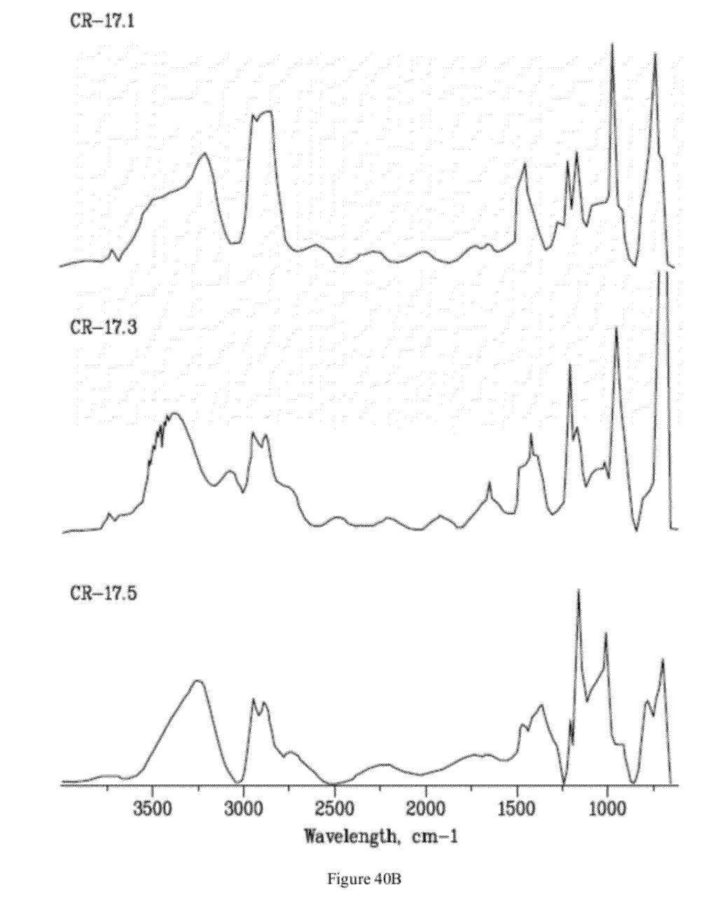

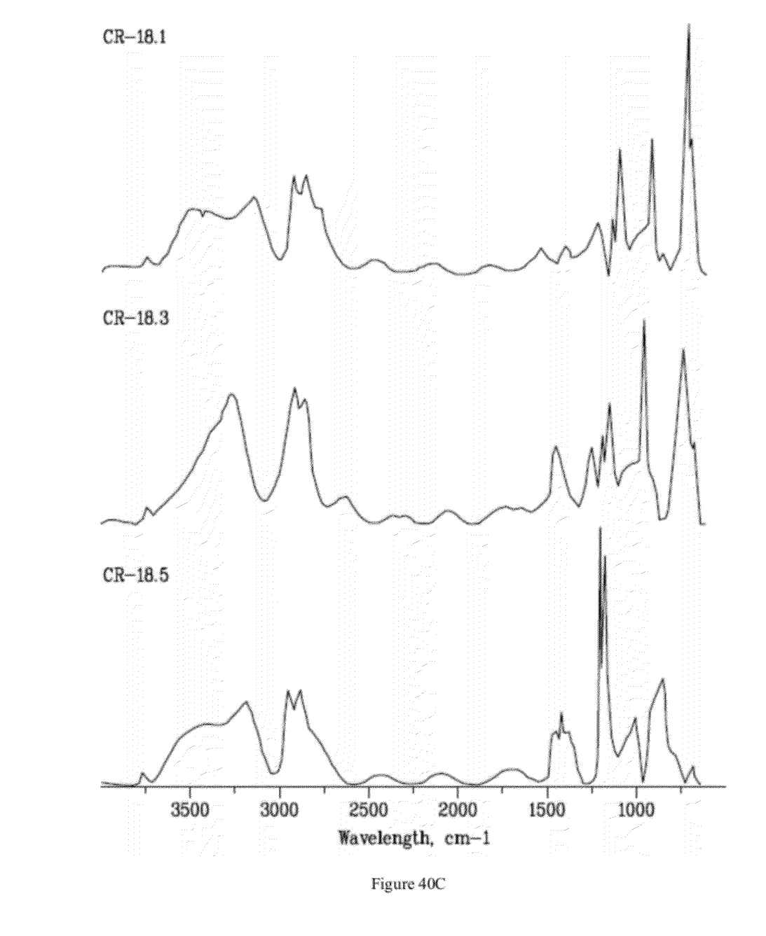

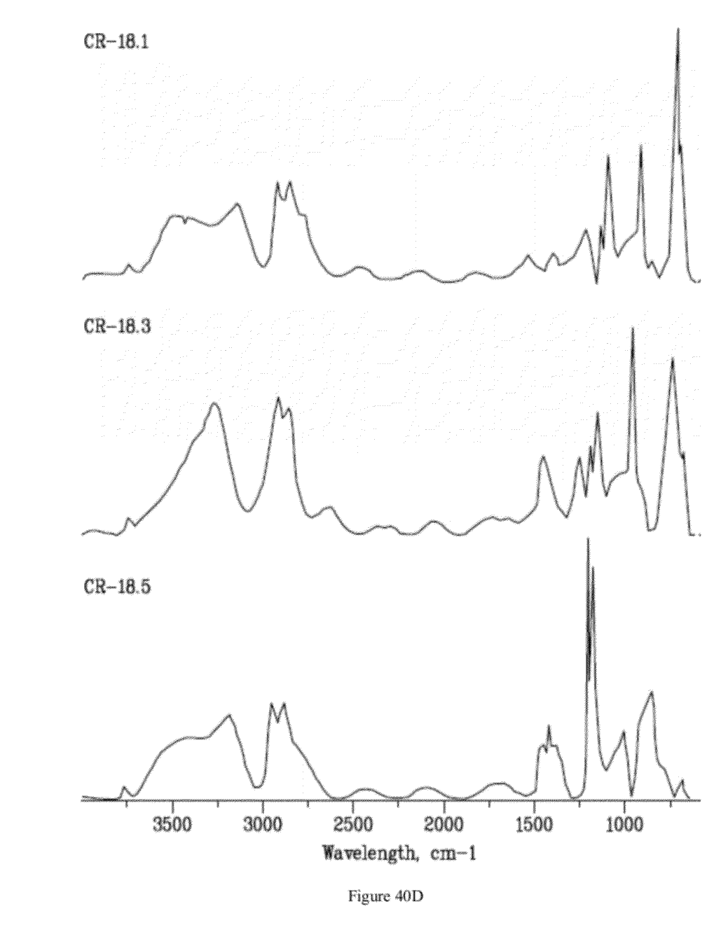

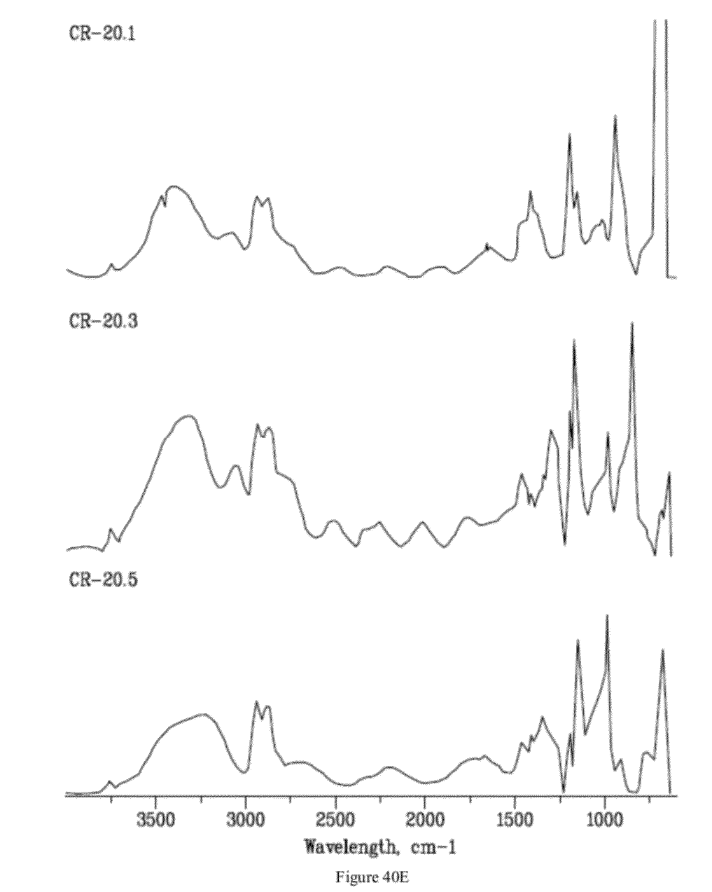

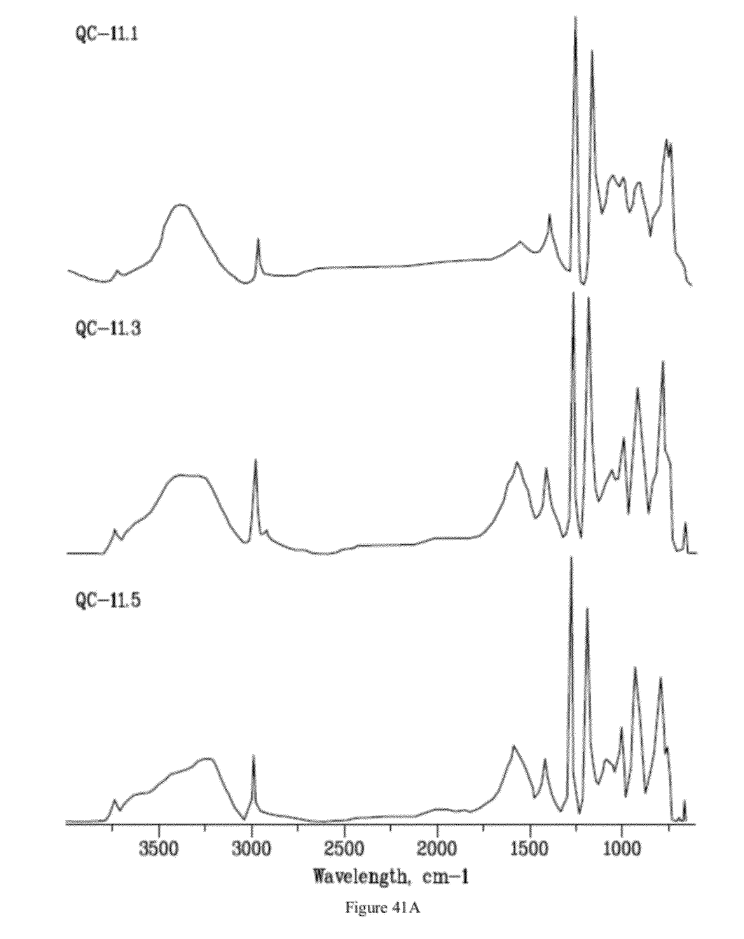

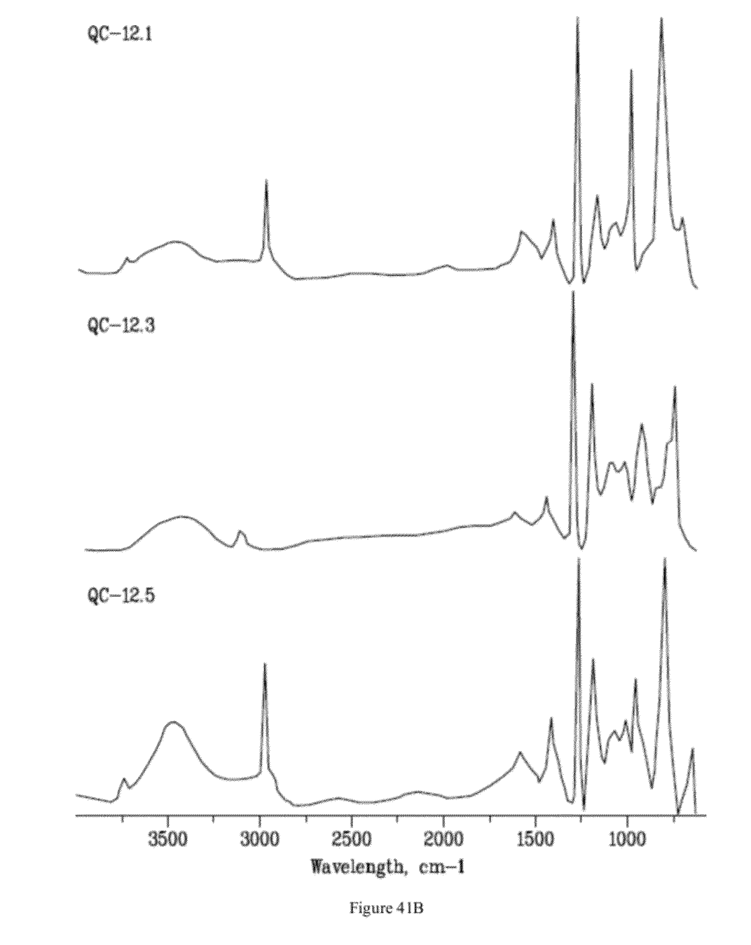

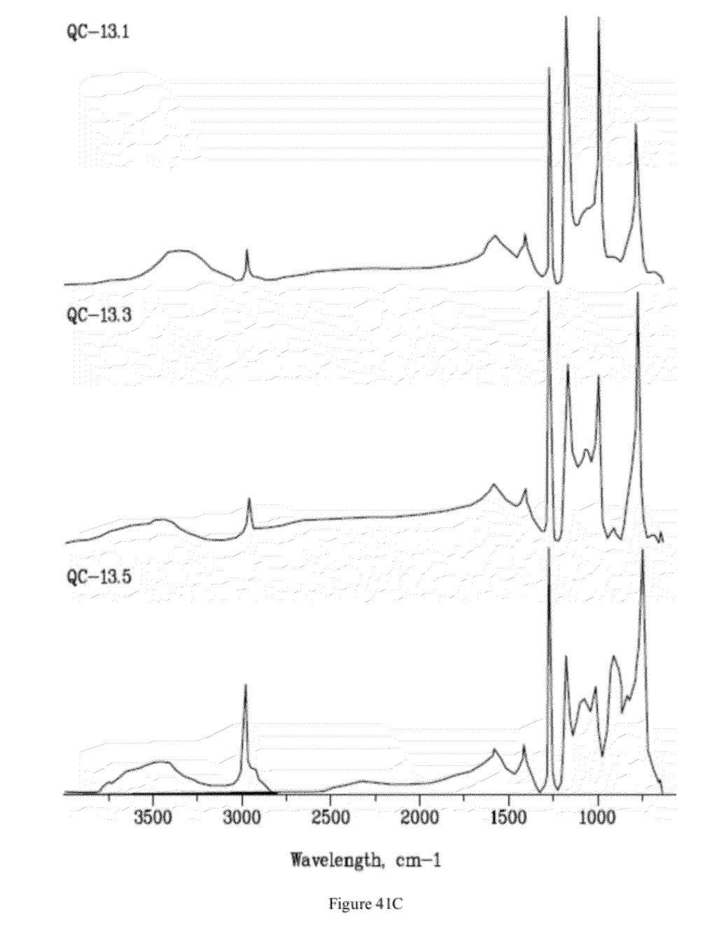

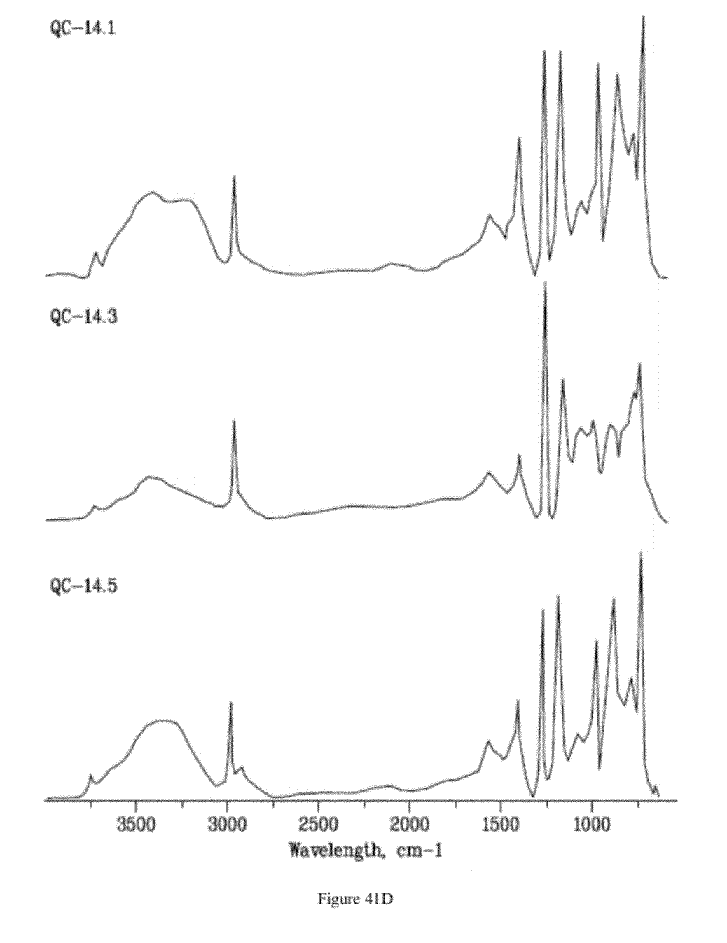

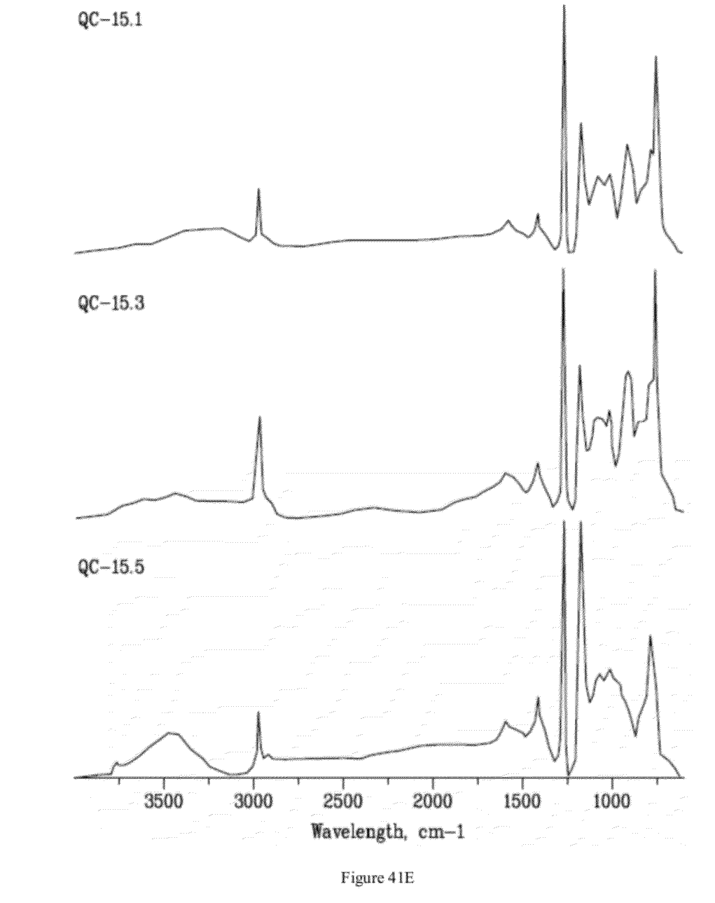

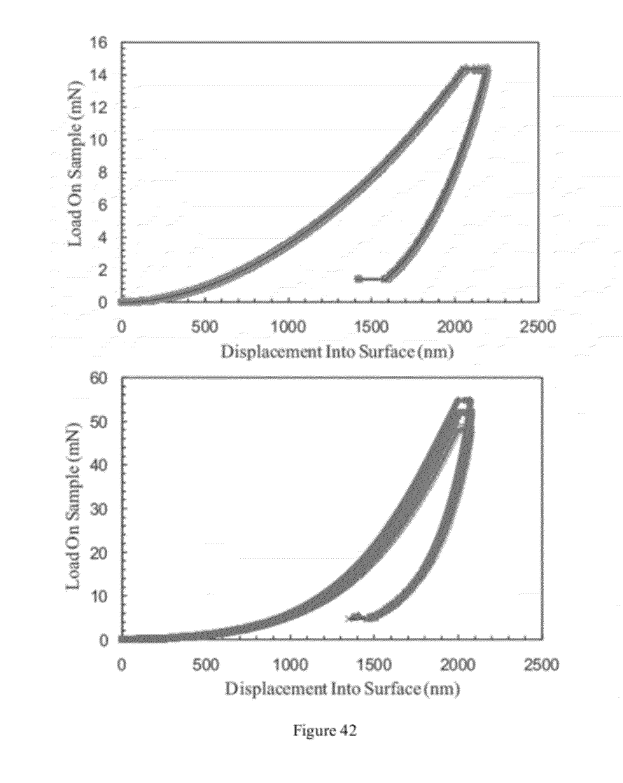

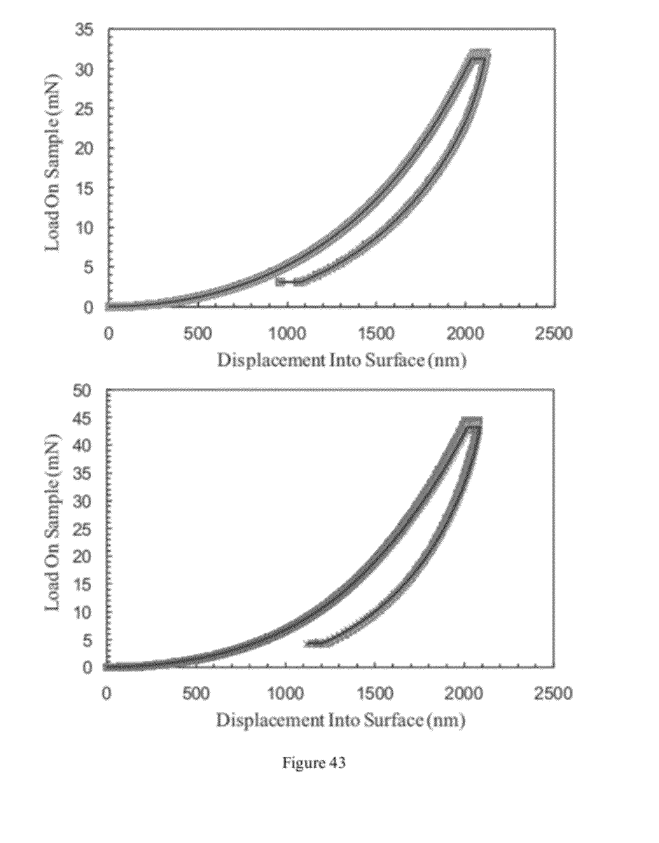

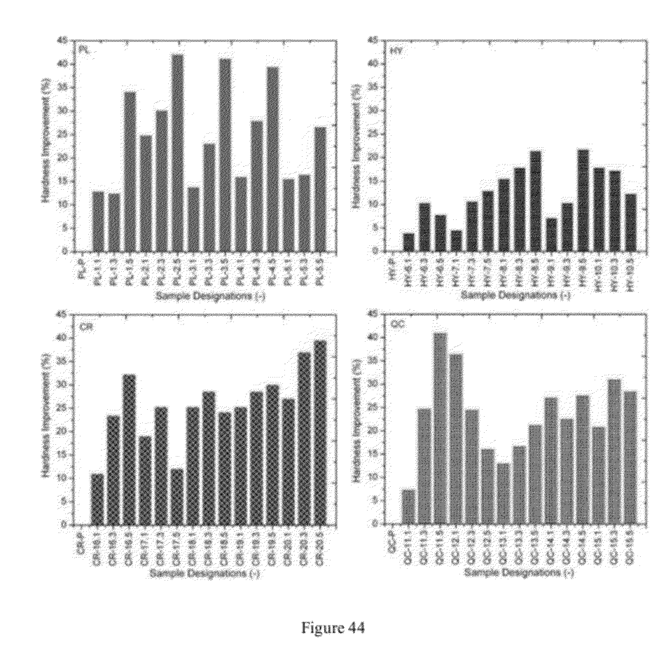

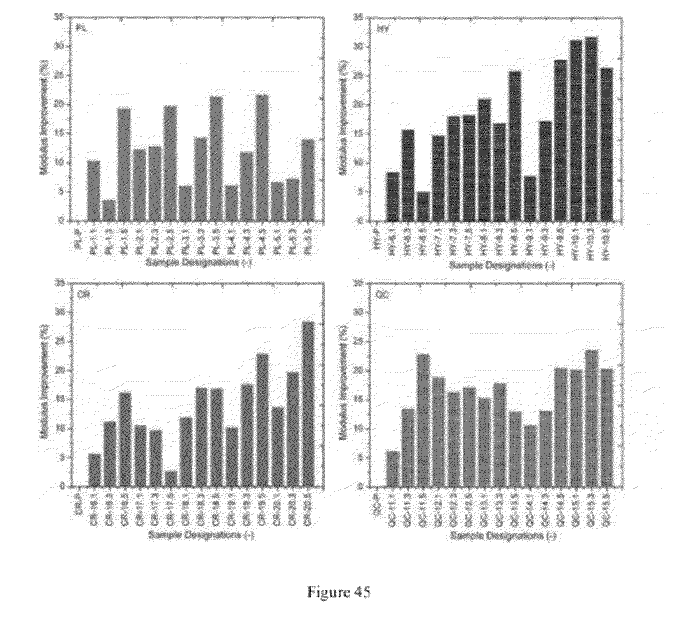

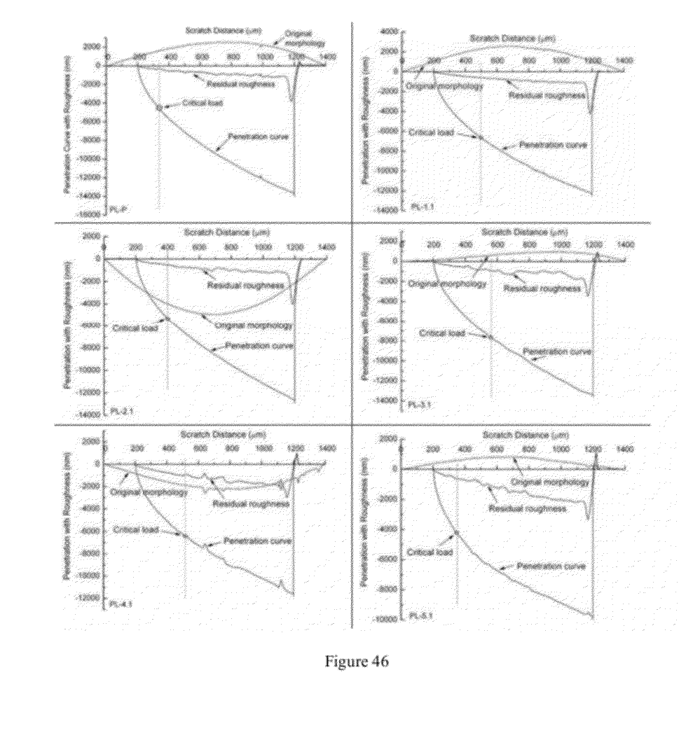

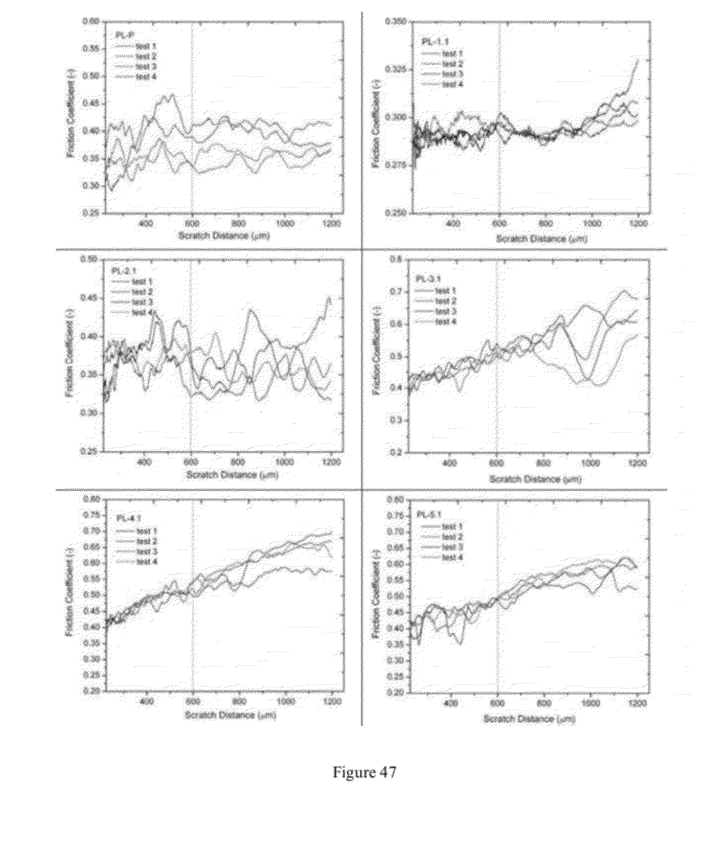

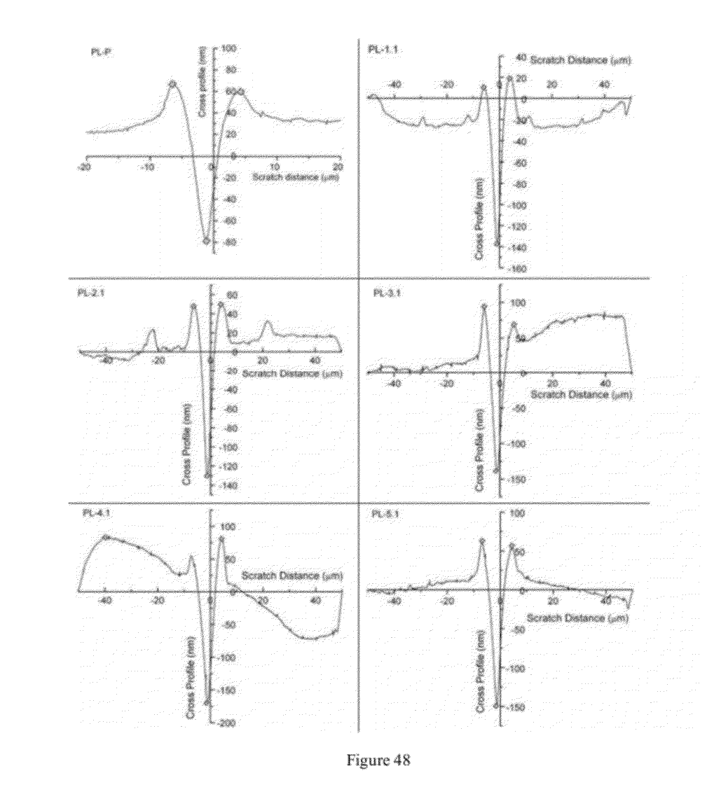

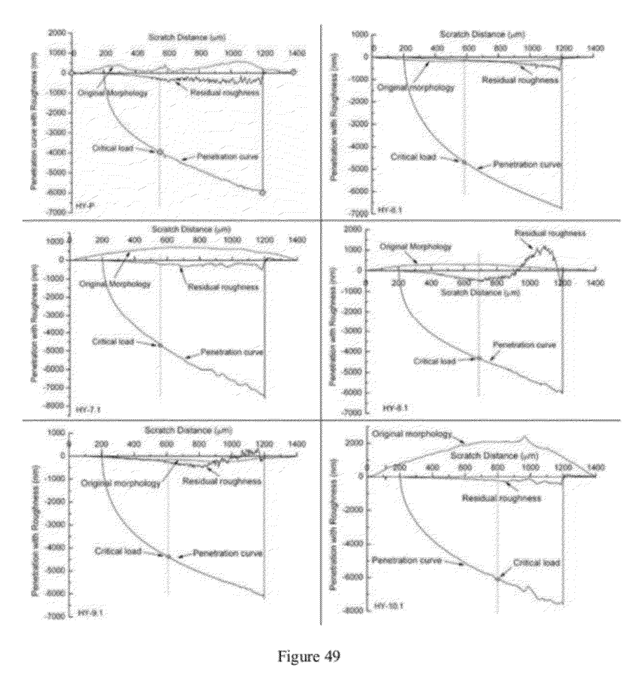

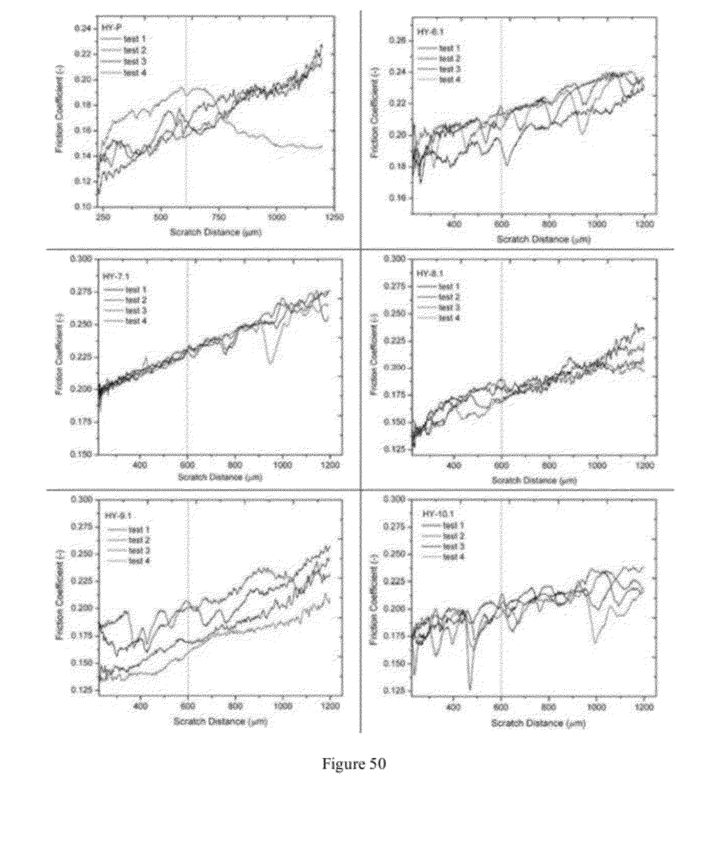

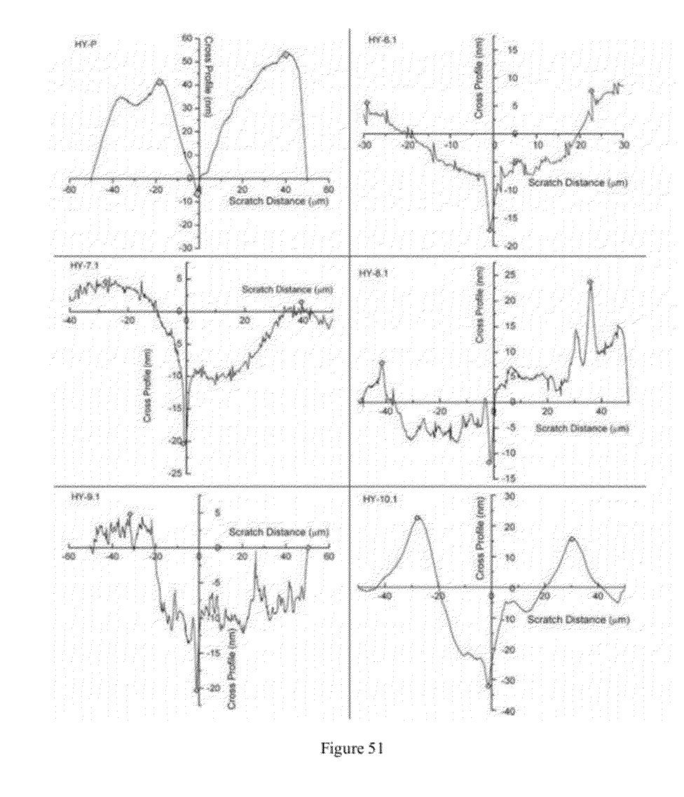

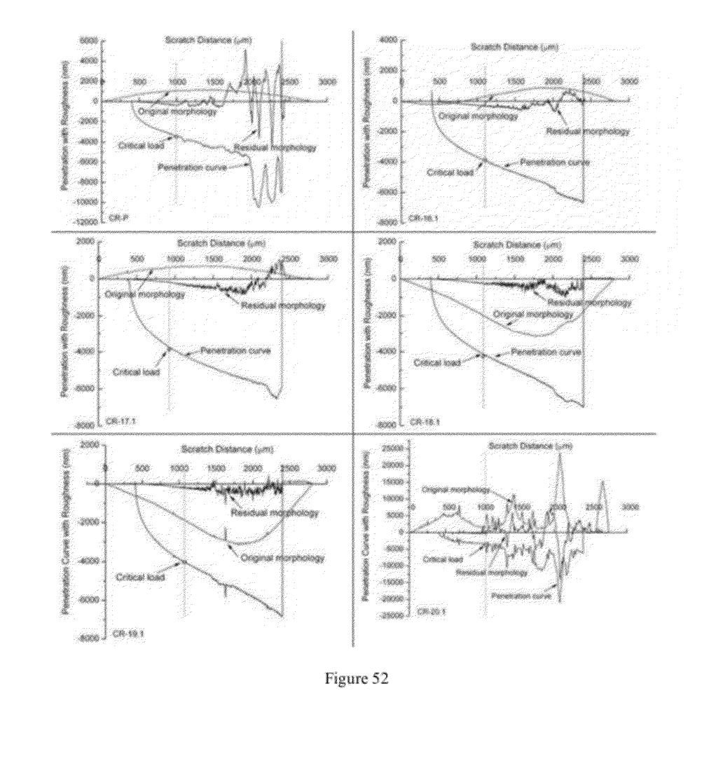

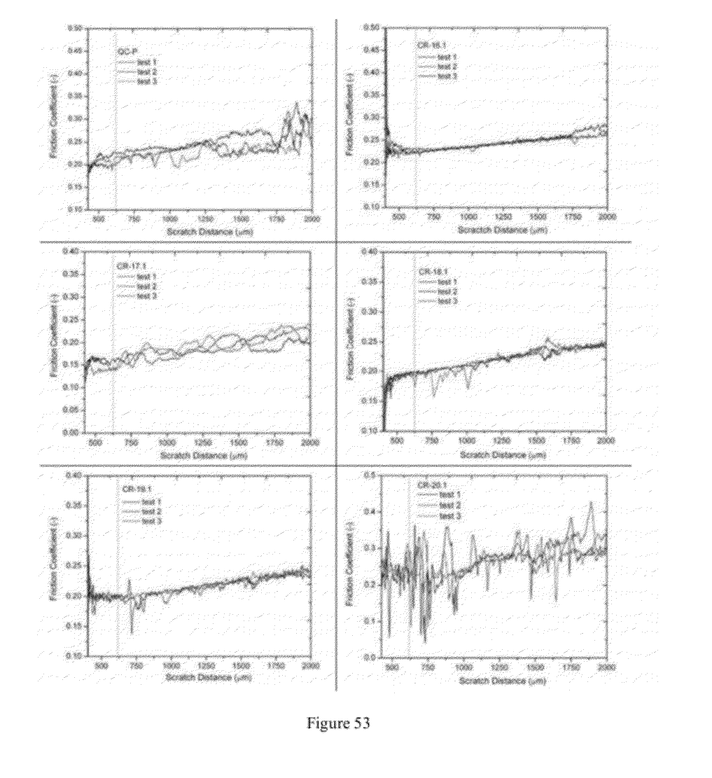

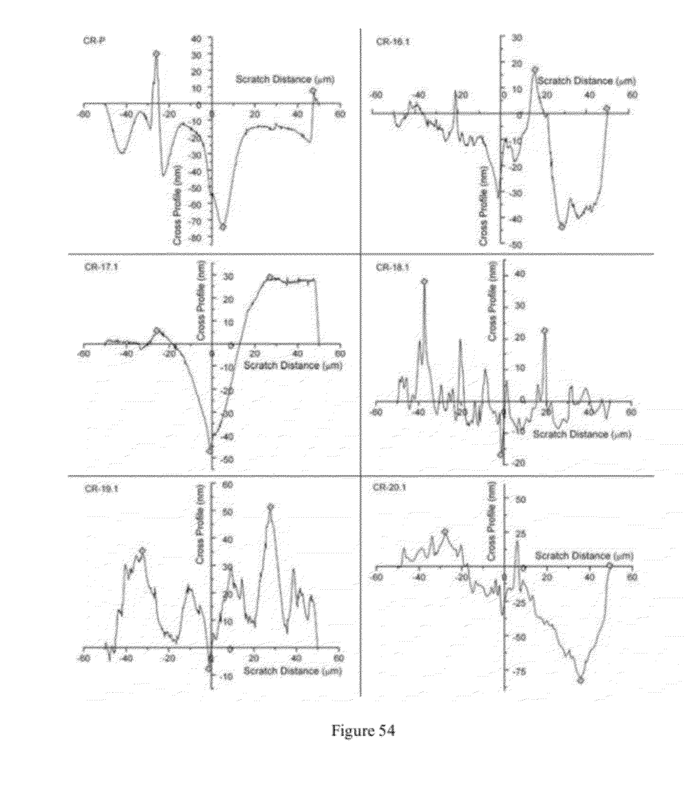

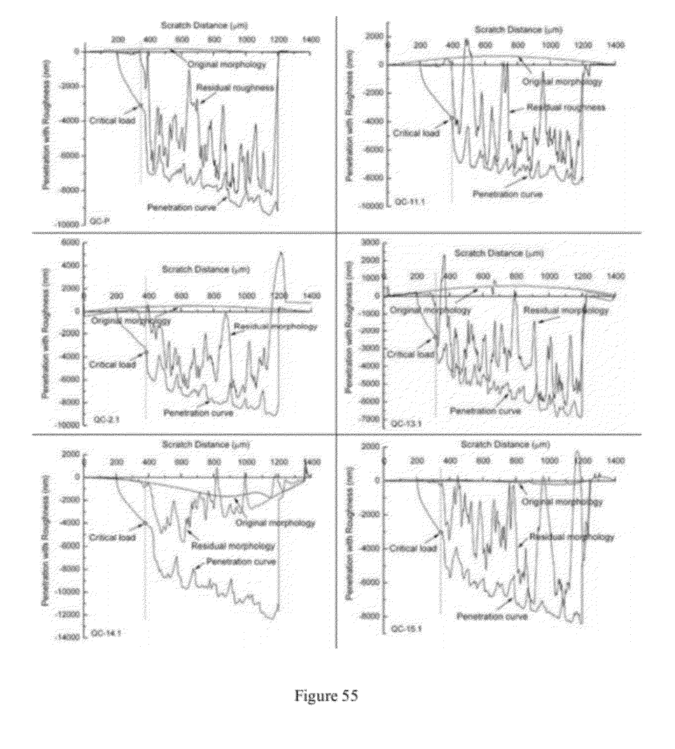

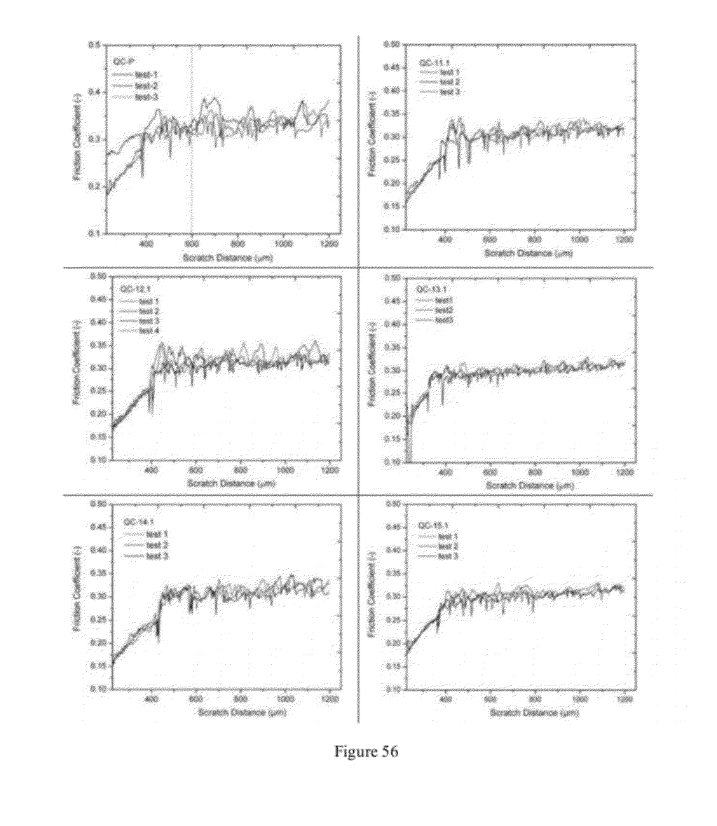

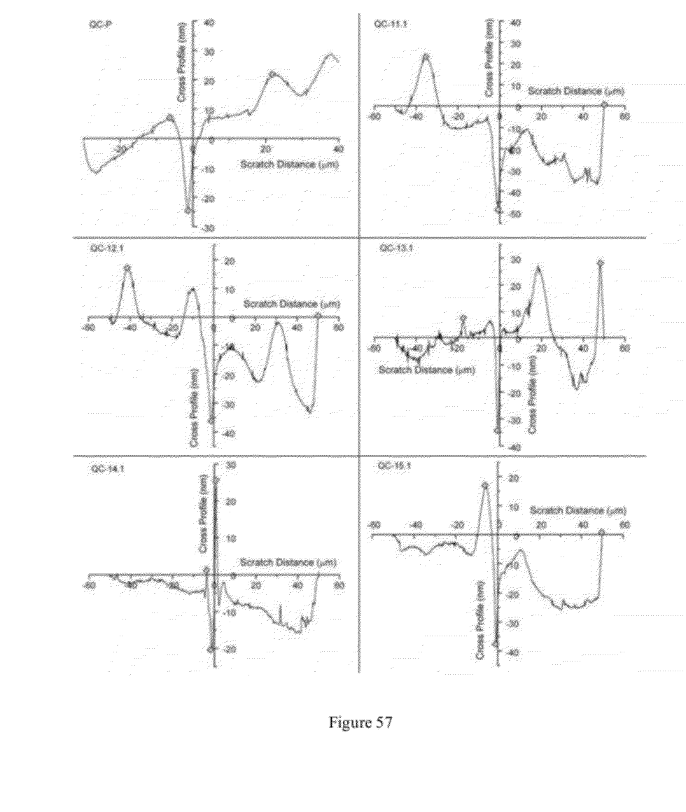

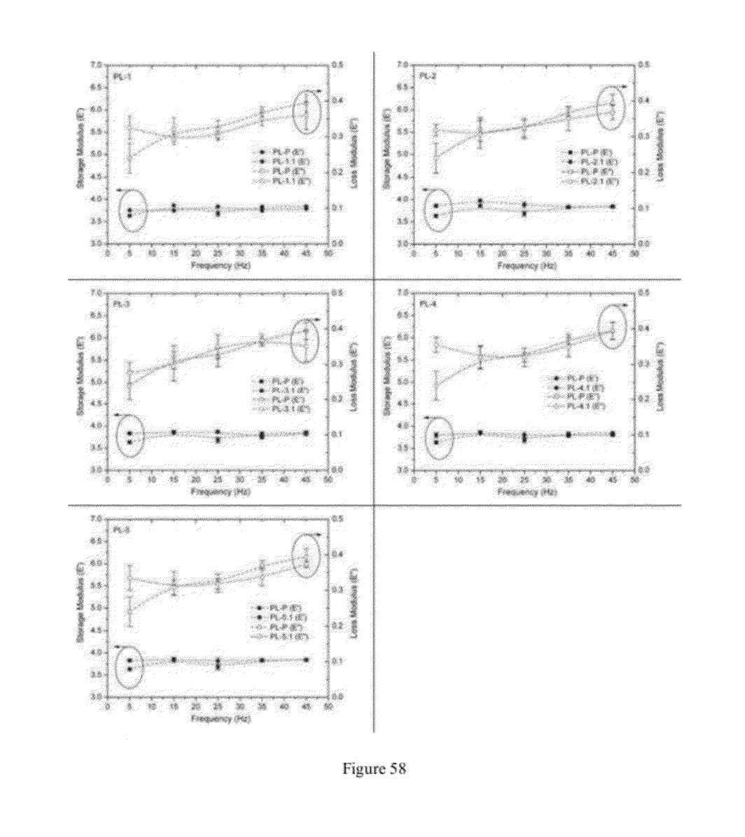

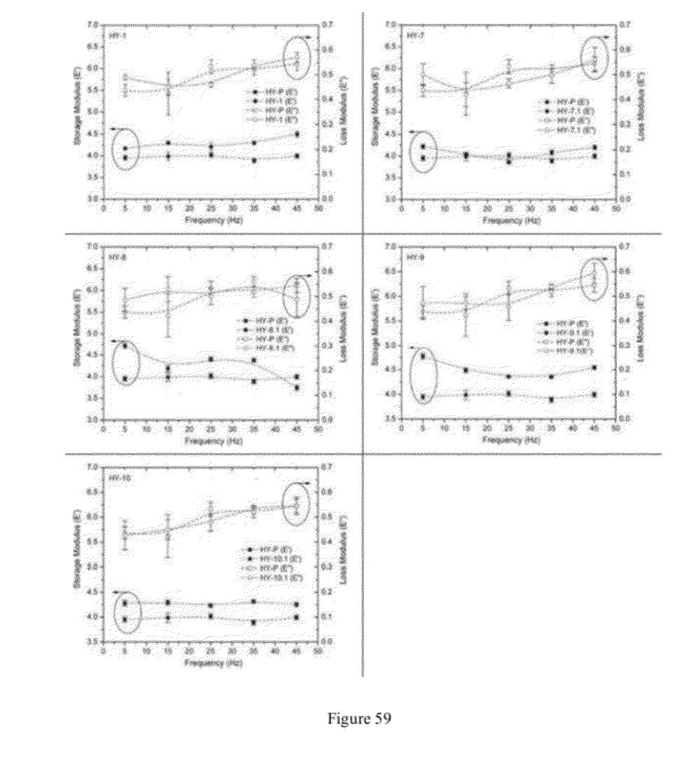

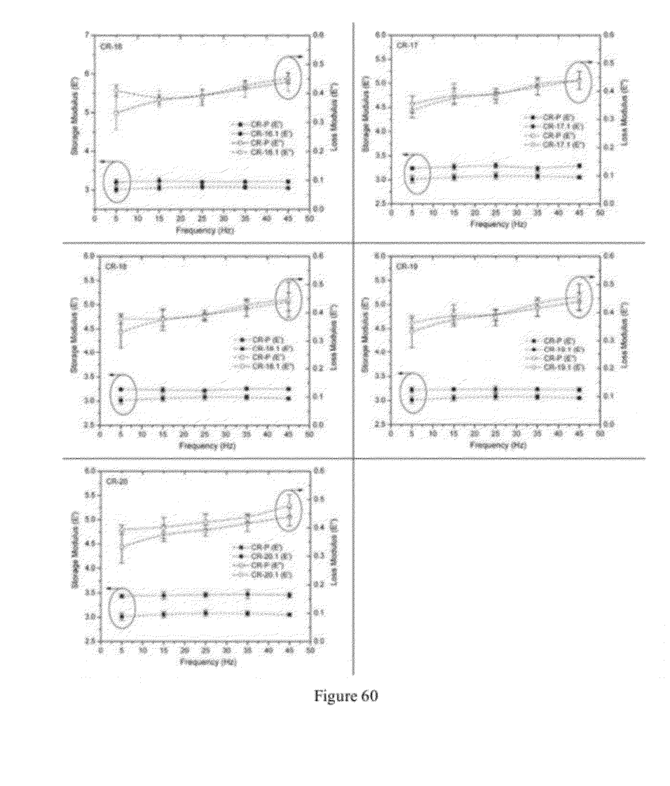

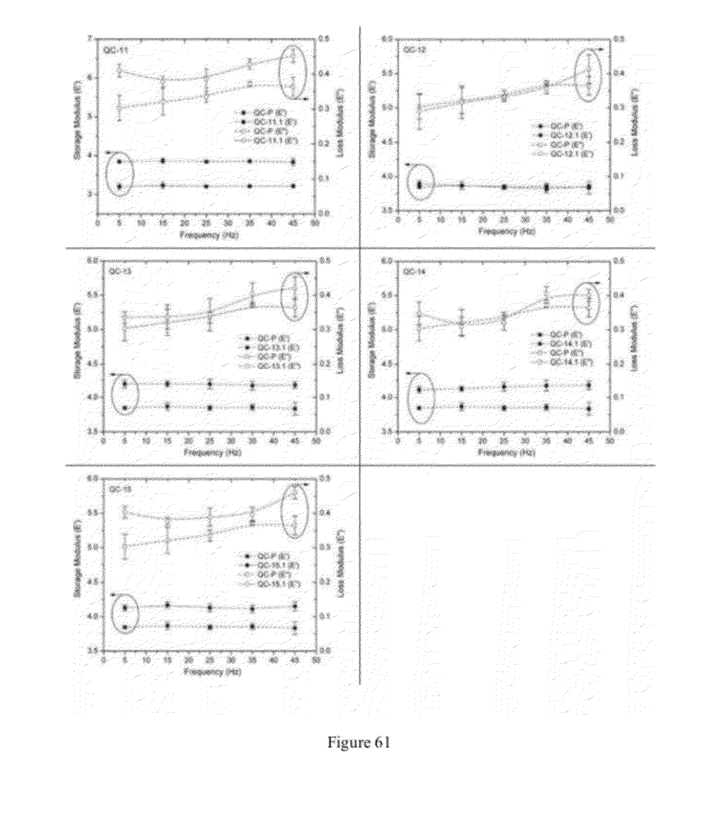

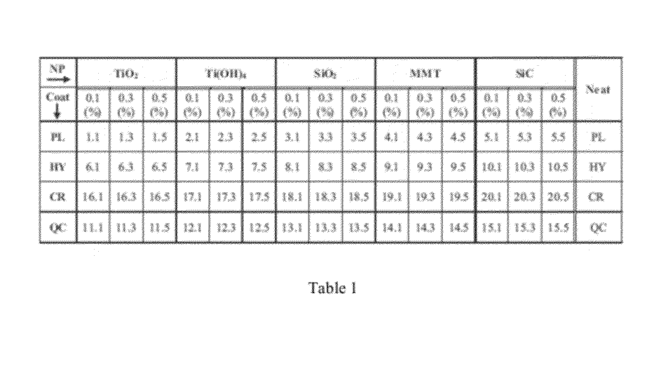

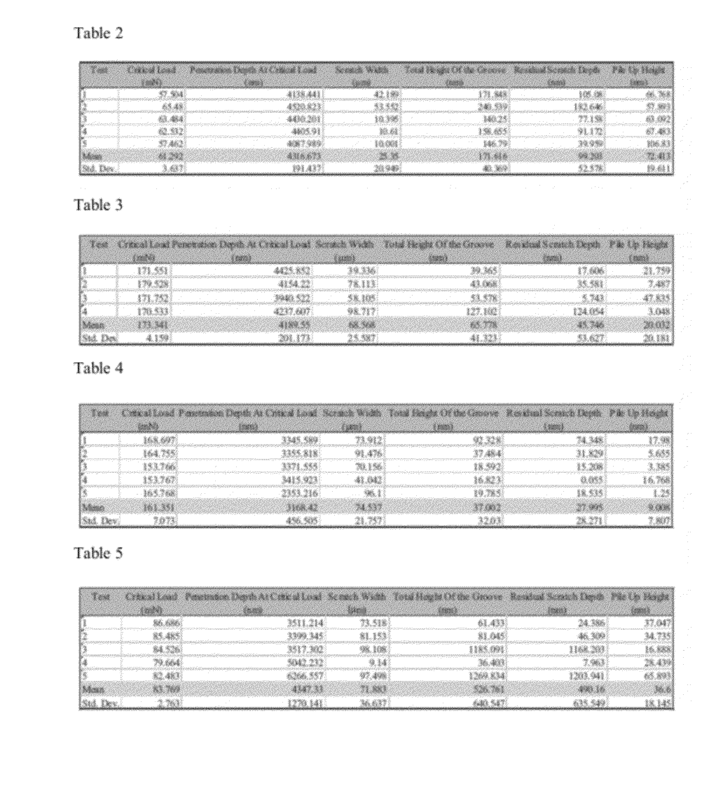

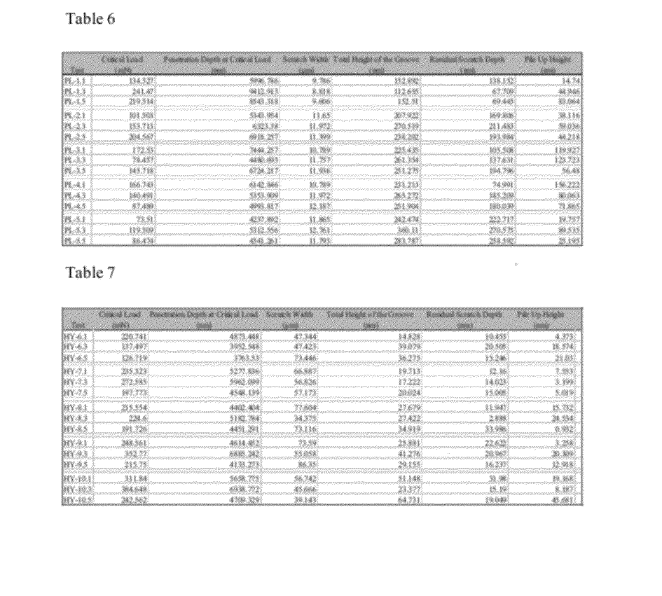

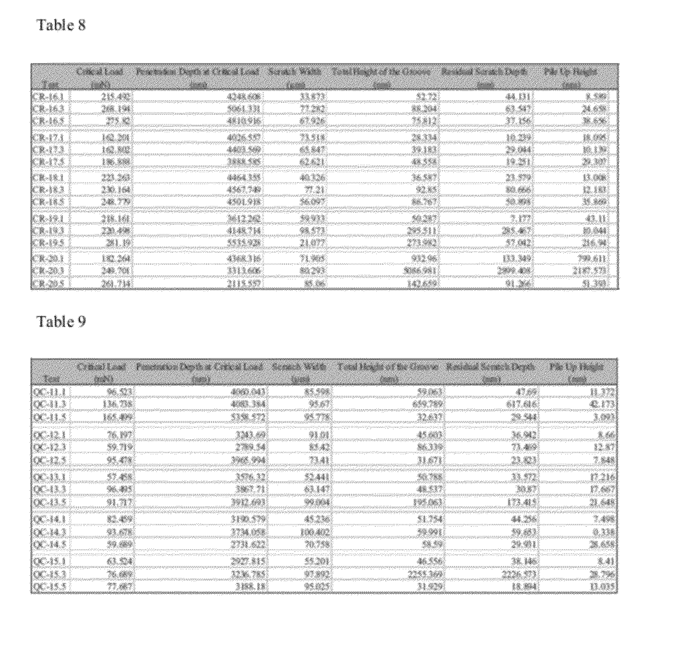

Here is presented results concerning increasing the amounts of nanoparticles in nanocoatings change their visco-elastic properties [59, 60]. E′ and E″ curves for different nanocoating concentrations as a function of test frequencies are shown in FIG. 34-37.

In the case of PL nanocoatings, increasing the nanoparticles concentration had only a negligible effect on the E value on except in the case of Ti(OH)₄ containing nanocoating. The E′ value remained unaffected by test frequency in all the nanocoatings except Ti(OH)₄ containing nanocoating and in this case the value fluctuated with the change in test frequency. Similarly, E″ values fluctuated with the increase in nanoparticles concentration and test frequency.

In the case of HY nanocoatings, the E′ value showed variation with nanocoating compositions. The E′ value in the case of TiO₂ nanocoating was highest at 5 Hz test frequency for 0.3 wt % nanoparticles. Similarly, E′ value was highest at 5 Hz for 0.1 wt % MMT nanoclay nanocoating. The highest E′ value was recorded for nanosilica containing nanocoating. On the other hand, there was no significant change observed in E″ values for most of the nanocoatings except in composition containing SiC nanowhiskers in which case the value fluctuated at 15 Hz test frequency.

In the case of CR nanocoatings, the E′ values were constant and independent of nanoparticles concentrations and test frequencies for TiO₂, Ti(OH)₄ and MMT containing nanocoatings. The E′ value increased slightly with increasing nanoparticles concentration for nanosilica and nanowhisker containing nanocoatings. On the other hand, E″ values varied significantly according to the type of nanoparticles. The E″ values enhanced for nanosilica and nano-whiskers containing nanocoatings, while the lowest value was recorded for MMT containing nanocoating.

In the case of QC nanocoatings, the E′ value remained unaffected by the concentration of nanoparticles and test frequency. A low E value was recorded for TiO₂ and Ti(OH)₄ containing nanocoatings. The E′ values were similar for the other three nanocoatings. The E″ values, on the other hand, were random and varied with the test frequency. There was no significant variation observed in the E″ value with the change in the concentration of nanoparticles.

Results Summary

Four different coatings were investigated, the coatings comprising varying amounts of hydrocarbon and silicone content. The resultant coatings were described as polymer, hybrid, ceramer and quasi-ceramic according to their chemical structures. The coatings were modified with five different nanoparticles that were chosen based on their shapes and properties. It was discovered that the incorporation of nanoparticles significantly modified the properties of the resulting nanocoatings. The dispersion of nanoparticles and their interfacial interactions with the surrounding matrix played a critical role in controlling the nano-mechanical properties of the resulting nanocoatings.

The five nanoparticles investigated were TiO₂, in-situ generated titanium nanoparticles using titanium ethoxide, functionalized SiO₂, montmorilonite nanoclay and SiC nano-whiskers. The nanocoatings containing 0.1, 0.3 and 0.5 wt % of each nanoparticle were used in different coating compositions. Each coating and nanocoating was characterized using FTIR spectroscopic technique, which confirmed the presence of nanoparticles in the nanocoatings. It was discovered that nanoparticles were held in the coatings through hydrogen bonding except in the case of titanium ethoxide and functionalized nanosilica containing nanocoating in which chemical bonding was seen between the nanoparticles and backbone of the coatings.

The atomic force microscopy was used to scan the scratched coated surface. It was found that epoxy based polymer coating (PL) consisted of a smooth surface that was compressed when scratched using a nanoindenter. The hybrid coating (HY) showed a rough surface and a damaged recovery after the scratch test. The ceramer coating (CR) showed roughness in a nanometer dimension that originated from the roughness on the polished aluminum surface. The scratch on the CR coated surface was brittle but smooth with little to no elastic recovery. The quasi-ceramic coating (QC) showed fine surface morphology with roughness associated with the polished aluminum substrate. The scratch on the QC coated surface was brittle without elastic recovery.

The pristine coatings were tested for their nano-mechanical properties using the nanoindentation technique (IIT). The HY coating showed hardness (H) value that was 37% higher compared to PL coating. Similarly, the H value shown on CR coating was 21% higher compared to that of PL coating. The H value in the case of QC coating was 104% higher compared to that of PL coating. The modulus value (E) was either a little lower or similar to that in the PL coating. These results suggest that HY coating was stronger than pristine PL and CR coating. Also, QC coatings consisted of densely packed crosslinked network compared to other coatings discussed here.

The scratch tests were performed on pristine coatings using a Berkowich indenter. No clear fracture was observed in PL coating that was damaged at the critical load of 61 mN. This coating suffered major plastic deformation. HY coating was initially compressed during the scratch followed by a brittle fracture at 170 mN critical load. The scanning electron microscope (SEM) images of the damaged surface confirmed the brittle failure in the coating as a result of the penetration of the nanoindenter tip. Some delamination was observed in the coating around the region of the scratch, suggesting the presence of residual stresses in the coating network. Similarly, CR coating damaged through brittle fracture at a critical load of 160 mN and delamination followed the fracture. The failure in QC coating was brittle at a critical load of 84 mN. Moreover, the SEM micrographs suggest that the coated substrate chipped off at the end of the scratch test. The scratch test suggests that hybrid coating may resist damage as compared to the other three coatings. The presence of hydrocarbon in the hybrid coating compositions may impart better resilience capability to the coating, enhancing its fracture toughness.

SEM micrographs were acquired for the initiation, propagation and termination steps in coating during the scratch test that helped elucidate the modes of failure. The coefficient of friction (COF) values were recorded as a function of the scratch distance. The high COF values were obtained for PL and QC coatings. The presence of hydrocarbon bearing silicone was attributed for the low COF value in HY coating. The cross profile topography (CPT) of the scratched surface suggests that hybrid coating has better scratch resistance compared to that of pristine polymer and creamer coatings. The moderate depth of penetration seen in QC coating suggests hardness and elastic nature.

Upon adding 0.1% nanoparticles, the nano-mechanical properties of the resultant nanocoatings increased. For PL nanocoatings, the H value increased after adding Ti(OH)₄, while E increased with the addition of SiO₂. For HY and CR nanocoatings, the H value increased upon adding SiC. The critical load bearing of nanocoatings increased upon adding nanoparticles when tested through nanoscratch. The addition of 0.1 wt % SiO₂, the CL value increased in PL and CR nanocoatings, while SiC increased in HY nanocoating. The critical load value decreased abruptly in QC nanocoating upon adding nanoparticles. The COF value increased in PL nanocoatings upon adding SiO₂ or MMT. The addition of Ti(OH)4 increased the COF value in HY nanocoating but decreased it in CR nanocoating. In the case of QC nanocoatings, the COF value remained constant and unaffected by nanoparticles additions.

The addition of higher concentration of nanoparticles (up to 0.5 wt. %) increased the H value in nanocoatings. A high H value improvement up to 42% for PL and 21% for HY (compared to pristine) was achieved in nanocoatings upon adding SiO₂ nanoparticles. The addition of a higher concentration of SiC in CR coating increased the H value up to 39% in nanocoatings. Similarly, the addition of TiO₂ increased the H value up to 41% in QC nanocoatings. The highest H value in QC nanocoating was approximately 188% higher than that of pristine PL coating. The scratch resistance increased in nanocoatings with the increase in nanoparticle concentrations. The CL value increased in PL nanocoatings upon adding 0.5 wt % TiO₂, but the coating turned brittle and delaminated. Similarly, the critical load value increased in HY nanocoatings upon adding 0.3 wt. % SiO₂ nanoparticles. The addition of 0.5 wt % TiO₂ in increased the critical load value in both CR and QC nanocoatings.

The visco-elastic behavior of coating and nanocoatings was tested at 5 different frequencies using nanoindentation technique. For pristine coatings, the storage modulus (E′) remained independent of test frequency while loss modulus (E″) increased slightly with the increase in test frequencies. The CR coating showed highest and HY coating showed lowest E′ values. The E″ was high for HY coating and nearly uniform for all other coatings.

Upon adding nanoparticles, the visco-elastic behavior of resultant nanocoatings changed. The E′ value increased with the addition of nanoparticles. E″ values fluctuated with the change in nanoparticles and test frequencies. With further increase in nanoparticle concentration, the E′ increased for TiO2 containing PL nanocoating and in each case of HY nanocoatings, SiO₂ containing CR nanocoatings. No change in the E′ value was seen for QC nanocoatings. The E″ values, however, changed for all the nanocoating compositions. These results suggest that incorporating of nanoparticles in the coating compositions modifies the network structures of the final coatings.

Further Summary

a) The development and characterization of four coating compositions containing three different concentrations of five different nanoparticles has been accomplished.

b) A total of 64 coating and nanocoatings were tested for the variation in nanomechanical properties. The nanoindentation, nanoscratch and visco-elastic properties of the coatings and nanocoatings were investigated as a function of change in chemical structures of the material.

What is claimed:

1. A coating, comprising:
a polymeric matrix material,
a population of nanoscale bodies dispersed within the matrix material,
the nanoscale bodies being present in a range of from about 0.001 wt % to about 10 wt %.

2. The coating of claim 1, wherein the polymeric matrix comprises an epoxide group, an epoxy group, a silicone group, or any combination thereof.

3. The coating of claim 1, wherein the coating comprises one or more covalent, ionic, or both bonds between the polymeric matrix material and a nanoscale body.

4. The coating of claim 1, further comprising one or more chemical bonds between the polymeric matrix material and at least one of the nanoscale bodies.

5. The coating of claim 1, wherein the coating has a thickness in the range of from about 0.1 micrometer to about 100,000 micrometers.

6. The coating of claim 1, wherein the coating has a thickness in the range of from about 5 micrometers to about 100 micrometers.

7. The coating of claim 6, wherein the coating has a thickness in the range of from about 10 micrometers to about 50 micrometers.

8. The coating of claim 1, wherein the polymeric matrix material comprises an epoxy group, an epoxide group, or any combination thereof.

9. The coating of claim 1, wherein the polymeric matrix material comprises a silicone group.

10. The coating of claim 1, wherein the population of nanoscale bodies includes at least one body having a cross-sectional dimension in the range of from about 0.1 nm to about 100 nm.

11. The coating of claim 10, wherein the population of nanoscale bodies includes at least one body having a cross-sectional dimension in the range of from about 5 nm to about 20 nm.

12. The coating of claim 1, wherein the polymeric matrix material further comprises a thermoplastic, a thermoset, or any combination thereof,

13. The coating of claim 1, wherein the coating presents an increase in at least one of hardness, Young's modulus, on critical load

14. The coating of claim 1, wherein the coating presents an increase in hardness of at least about 5% as compared to a corresponding polymeric matrix material.

15. The coating of claim 1, wherein the coating presents an increase in Young's modulus of at least about 5% as compared to a corresponding polymeric matrix material.

16. The coating of claim 1, wherein the nanoscale bodies are present in a range of from about 0.01 wt % to about 0.5 wt %.

17. A method, comprising:
dispersing a population of nanoscale bodies into a polymeric matrix material so as to give rise to a coating composition comprising the polymeric matrix material with the population of nanoscale bodies dispersed within at from about 0.001 wt % to about 10 wt %.

18. The method of claim 17, further comprising curing the coating composition.

19. The method of claim 17, wherein the polymeric matrix material comprises an epoxide group, an epoxy group, a silicone group, or any combination thereof.

20. A method, comprising:
preparing a polymer that comprises an epoxide group, an epoxy group, a silicone group, or any combination thereof; and
dispersing a population of nanoscale bodies within the polymer to between about 0.001 wt % to about 10 wt % so as to form a coating composition.
